(19) United States
(12) Patent Application Publication
(10) Pub. No.: US 2023/0025899 A1
(43) Pub. Date: Jan. 26, 2023

(54) PROCESSING-IN-MEMORY(PIM) DEVICE

(71) Applicant: SK hynix Inc., Icheon-si Gyeonggi-do (KR)

(72) Inventor: Choung Ki SONG, Yongin-si Gyeonggi-do (KR)

(73) Assignee: SK hynix Inc., Icheon-si Gyeonggi-do (KR)

(21) Appl. No.: 17/953,151

(22) Filed: Sep. 26, 2022

Related U.S. Application Data
(63) Continuation-in-part of application No. 17/090,462, filed on Nov. 5, 2020.
(60) Provisional application No. 62/958,223, filed on Jan. 7, 2020.

(30) Foreign Application Priority Data
Jan. 17, 2020 (KR) 10-2020-0006902

(51) Int. Cl. G06F 7/544; G06F 7/487; G06F 7/501

(52) U.S. Cl. CPC G06F 7/5443; G06F 7/4876; G06F 7/501

(57) ABSTRACT

A PIM device includes a memory/arithmetic region including a plurality of memory banks and a plurality of MAC operators, the plurality of MAC operators including a first MAC operator, a peripheral region including a data input/output circuit, and a global data input/output (GIO) line capable of providing a data transmission path between the peripheral region and the memory/arithmetic region. The first MAC operator is configured to perform an EWM operation by performing a multiplication operation on first input data and second input data that are transmitted from first and second memory banks of the plurality of memory banks, respectively, to generate multiplication result data and transmitting the multiplication result data to a third memory bank. While the EWM operation is being performed, data transmission through the GIO line between the peripheral region and the memory/arithmetic region is blocked.

### CROSS-REFERENCE TO RELATED APPLICATIONS

This application is a continuation-in-part of U.S. patent application Ser. No. 17/090,462, filed Nov. 5, 2020, which claims the benefit of U.S. Provisional Application No. 62/958,223, filed on Jan. 7, 2020, and claims priority to Korean Patent Application No. 10-2020-0006902, filed on Jan. 17, 2020, in the Korean Intellectual Property Office, which are incorporated herein by reference in their entirety.

### BACKGROUND

### 1. Technical Field

Various embodiments of the present disclosure relate to processing-in-memory (PIM) devices and, more particularly, to PIM devices performing a deterministic arithmetic operation.

### 2. Related Art

Recently, interest in artificial intelligence (AI) has been increasing not only in the information technology industry but also in the financial and medical industries. Accordingly, in various fields, artificial intelligence, more precisely, the introduction of deep learning, is considered and prototyped. One cause of this widespread interest may be due to the improved performance of processors performing arithmetic operations. To improve the performance of artificial intelligence, it may be necessary to increase the number of layers constituting a neural network of the artificial intelligence to educate the artificial intelligence. This trend has continued in recent years, which has led to an exponential increase in the amount of computations required for hardware actually performing the computations. Moreover, if artificial intelligence employs a general hardware system including a memory and a processor which are separated from each other, the performance of the artificial intelligence may be degraded due to a limitation of the amount of data communication between the memory and the processor. In order to solve this problem, a PIM device in which a processor and memory are integrated in one semiconductor chip has been used as a neural network computing device. Because the PIM device directly performs arithmetic operations in the PIM device, a data processing speed in the neural network may be improved.

### SUMMARY

A processing-in-memory (PIM) device according to an embodiment of the present disclosure may include a memory/arithmetic region including a plurality of memory banks and a plurality of multiplication-and-accumulation (MAC) operators, the plurality of MAC operators including the first MAC operator, a peripheral region including a data input/output (I/O) circuit, and a global data input/output (GIO) line capable of providing a data transmission path between the peripheral region and the memory/arithmetic region. The first MAC operator may be configured to perform an element-wise multiplication (EWM) operation by performing a multiplication operation on the first input data and the second input data that are transmitted from the first and second memory banks of the plurality of memory banks to generate multiplication result data and transmitting the multiplication result data to the third memory bank of the plurality of memory banks. While the EWM operation is being performed, data transmission through the GIO line between the peripheral region and the memory/arithmetic region may be blocked.

A processing-in-memory (PIM) device according to another embodiment of the present disclosure may include a memory/arithmetic region including a plurality of memory banks and a plurality of multiplication-and-accumulation (MAC) operators, the plurality of MAC operators including the first MAC operator, a peripheral region including data input/output (I/O) circuit, a write global data input/output (GIO) line capable of providing a data transmission path from the data input/output (I/O) circuit to the plurality of memory banks and the plurality of MAC operators, and a read GIO line capable of providing a data transmission path from the plurality of memory banks and the plurality of MAC operators to the data input/output (I/O) circuit. The first MAC operator may be configured to perform an element-wise multiplication (EWM) operation by performing a multiplication operation on the first input data and the second input data that are transmitted from the first and second memory banks of the plurality of memory banks, respectively, to generate multiplication result data, and transmitting the multiplication result data to the third memory bank of the plurality of memory banks. While the EWM operation is being performed, data transmission through the read and write GIO lines between the peripheral region and the memory/arithmetic region may be blocked.

### BRIEF DESCRIPTION OF THE DRAWINGS

Certain features of the disclosed technology are illustrated by various embodiments with reference to the attached drawings.

FIG. 1 is a block diagram illustrating a PIM device according to an embodiment of the present disclosure.

FIG. 2 is a schematic diagram illustrating an arrangement of memory banks and multiplication/accumulation (MAC) operators included in a PIM device according to a first embodiment of the present disclosure.

FIG. 3 is a block diagram illustrating a configuration of a PIM device according to the first embodiment of the present disclosure.

FIG. 4 illustrates internal command signals outputted from a command decoder and MAC command signals outputted from a MAC command generator in the PIM device of FIG. 3.

FIG. 5 illustrates an example of a configuration of a MAC command generator included in the PIM device of FIG. 3.

FIG. 6 illustrates input signals and output signals of the MAC command generator illustrated in FIG. 5 with a timeline.

FIG. 7 illustrates an example of a configuration of a MAC operator included in the PIM device of FIG. 3.

FIGS. 8 to 14 are block diagrams illustrating operations of the PIM device illustrated in FIG. 3.

FIG. 15 is a timing diagram illustrating an operation of the PIM device illustrated in FIG. 3.

FIG. 16 is a block diagram illustrating another configuration of a PIM device according to the first embodiment of the present disclosure.

FIG. 17 illustrates internal command signals outputted from a command decoder and MAC command signals outputted from a MAC command generator in the PIM device of FIG. 16.

FIG. 18 illustrates an example of a configuration of a MAC command generator included in the PIM device of FIG. 16.

FIG. 19 illustrates input signals and output signals of the MAC command generator illustrated in FIG. 18 with a timeline.

FIG. 20 illustrates an example of a configuration of a MAC operator included in the PIM device of FIG. 16.

FIGS. 21 to 25 are block diagrams illustrating operations of the PIM device illustrated in FIG. 16.

FIG. 26 is a timing diagram an operation of the PIM device illustrated in FIG. 16.

FIG. 27 is a schematic diagram illustrating an arrangement of memory banks and multiplication/accumulation (MAC) operators included in a PIM device according to a second embodiment of the present disclosure.

FIG. 28 is a block diagram illustrating a configuration of a PIM device according to the second embodiment of the present disclosure.

FIG. 29 is a block diagram illustrating an operation of the PIM device illustrated in FIG. 28.

FIG. 30 is a timing diagram illustrating an operation of the PIM device illustrated in FIG. 28.

FIG. 31 is a block diagram illustrating a PIM device according to an embodiment of the present disclosure.

FIG. 32 is a schematic diagram illustrating an example of a configuration of a memory/arithmetic region and a peripheral region of the PIM device of FIG. 31.

FIG. 33 is a block diagram illustrating an example of a configuration of the first MAC operator of FIG. 32.

FIG. 34 is a diagram illustrating an example of an operation of a command/address decoder when the PIM device of FIG. 31 performs a memory read operation.

FIG. 35 is a diagram illustrating an example of an operation of the command/address decoder when the PIM device of FIG. 31 performs a memory write operation.

FIG. 36 is a diagram illustrating an example of an operation of the command/address decoder when the PIM device of FIG. 31 performs a vector data write operation.

FIG. 37 is a diagram illustrating an example of an operation of the command/address decoder when the PIM device of FIG. 31 performs a MAC arithmetic operation.

FIG. 38 is a diagram illustrating an example of an operation of the command/address decoder when the PIM device of FIG. 31 performs a MAC result data read operation.

FIG. 39 is a diagram illustrating an example of an operation of the command/address decoder when the PIM device of FIG. 31 performs an EWM operation.

FIG. 40 is a block diagram illustrating a PIM device according to another embodiment of the present disclosure.

FIG. 41 is a diagram illustrating an example of a configuration of a memory/arithmetic region and a peripheral region of the PIM device of FIG. 40.

FIG. 42 is a diagram illustrating an example of an operation of a command/address decoder when the PIM device of FIG. 40 performs an EWM operation.

### DETAILED DESCRIPTION OF THE EMBODIMENTS

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed. A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In an embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure.

Various embodiments are directed to processing-in-memory (PIM) devices which are capable of performing a deterministic arithmetic operation at a high speed.

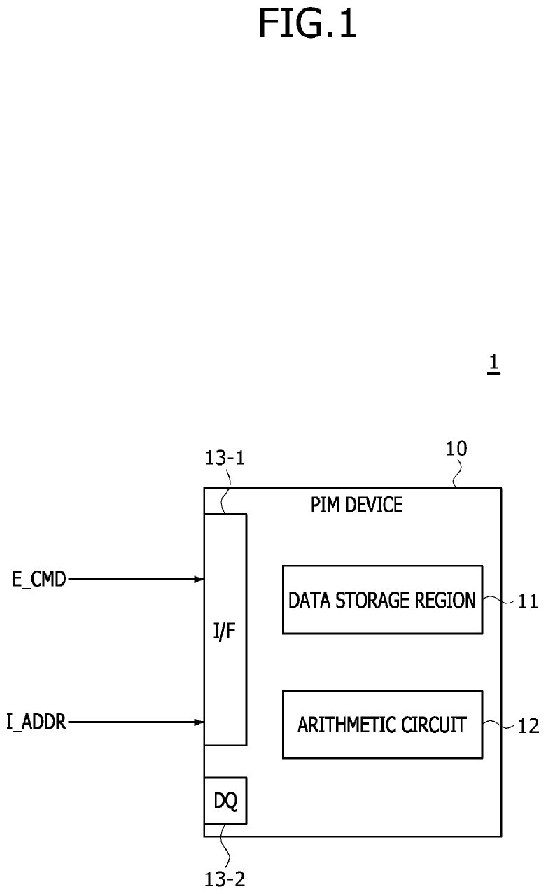

FIG. 1 is a block diagram illustrating a PIM device according to an embodiment of the present disclosure. As illustrated in FIG. 1, the PIM device 10 may include a data storage region 11, an arithmetic circuit 12, an interface (I/F) 13-1, and a data (DQ) input/output (I/O) pad 13-2. The data storage region 11 may include a first storage region and a second storage region. In an embodiment, the first storage region and the second storage region may be a first memory bank and a second memory bank, respectively. In another embodiment, the first data storage region and the second storage region may be a memory bank and buffer memory, respectively. The data storage region 11 may include a volatile memory element or a non-volatile memory element. For an embodiment, the data storage region 11 may include both a volatile memory element and a non-volatile memory element.

The arithmetic circuit 12 may perform an arithmetic operation on the data transferred from the data storage region 11. In an embodiment, the arithmetic circuit 12 may include a multiplying-and-accumulating (MAC) operator. The MAC operator may perform a multiplying calculation on the data transferred from the data storage region 11 and perform an accumulating calculation on the multiplication result data. After MAC operations, the MAC operator may output MAC result data. The MAC result data may be stored in the data storage region 11 or output from the PIM device 10 through the data I/O pad 13-2. In an embodiment, the arithmetic circuit 12 may perform additional operations, for example a bias addition operation and an active function operation, for a neural network calculation, for example, an arithmetic operation in a deep learning process. In another embodiment, the PIM device 10 may include a bias addition circuit and active function circuit separated from the arithmetic circuit 12.

The interface 13-1 of the PIM device 10 may receive an external command E_CMD and an input address I_ADDR from an external device. The external device may denote a host or a PIM controller coupled to the PIM device 10. Hereinafter, it may be assumed that the external command E_CMD transmitted to the PIM device 10 is a command requesting the MAC arithmetic operation. That is, the PIM device 10 may perform a MAC arithmetic operation in response to the external command E_CMD. The data I/O pad 13-2 of the PIM device 10 may function as a data communication terminal between a device external to the PIM device 10, for example the PIM controller or a host located outside the PIM system 1. Accordingly, data outputted from the host or the PIM controller may be inputted into the PIM device 10 through the data I/O pad 13-2. Also, data outputted from the PIM device 10 may be inputted to the host or the PIM controller through the data I/O pad 13-2.

In an embodiment, the PIM device 10 may operate in a memory mode or a MAC arithmetic mode. In the event that the PIM device 10 operates in the memory mode, the PIM device 10 may perform a data read operation or a data write operation for the data storage region 11. In the event that the PIM device 10 operates in the MAC arithmetic mode, the arithmetic circuit 12 of the PIM device 10 may receive first data and second data from the data storage region 11 to perform the MAC arithmetic operation. In the event that PIM device 10 operates in the MAC arithmetic mode, the PIM device 10 may also perform the data write operation for the data storage region 11 to execute the MAC arithmetic operation. The MAC arithmetic operation may be a deterministic arithmetic operation performed during a predetermined fixed time. The word “predetermined” as used herein with respect to a parameter, such as a predetermined fixed time or time period, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

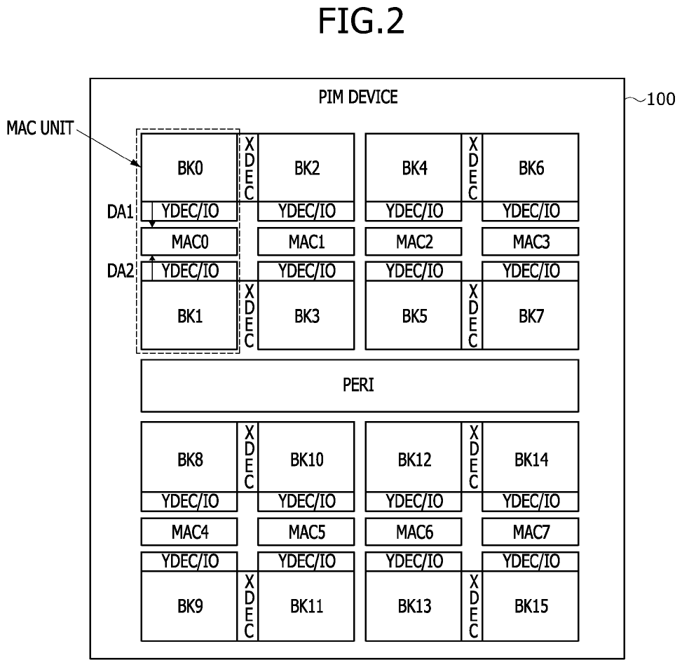

FIG. 2 illustrates a disposal structure indicating placement of memory banks BK0, . . . , and BK15 and MAC operators MAC0, . . . , and MAC7 included in a PIM device 100 according to an embodiment of the present disclosure. In an embodiment, the memory banks BK0, . . . , and BK15 and the MAC operators MAC0, . . . , and MAC7 may be included in the data storage region and the arithmetic circuit of the PIM device 10 of FIG. 1, respectively. Referring to FIG. 2, the PIM device 100 may include a data storage region and an arithmetic circuit. In an embodiment, the data storage region may include the memory banks BK0, . . . , and BK15. Although the present embodiment illustrates an example in which the data storage region includes the memory banks BK0, . . . , and BK15, the memory banks BK0, . . . , and BK15 are merely examples which are suitable for the data storage region. In some embodiments, the memory banks BK0, . . . , and BK15 may be a memory region corresponding to a volatile memory device, for example, a DRAM device. In an embodiment, each of the memory banks BK0, . . . , and BK15 may be a component unit which is independently activated and may be configured to have the same data bus width as data I/O lines in the PIM device 100. In an embodiment, the memory banks BK0, . . . , and BK15 may operate through interleaving such that an active operation of any one of the memory banks is performed in parallel while another memory bank is selected. Although the present embodiment illustrates an example in which the PIM device 100 includes the memory banks BK0, . . . , and BK15, the number of the memory banks is not limited to 16 and may be different in different embodiments. Each of the memory banks BK0, . . . , and BK15 may include at least one cell array which includes memory unit cells located at cross points of a plurality of rows and a plurality of columns. The memory banks BK0, . . . , and BK15 may include a first group of memory banks (e.g., odd-numbered memory banks BK0, BK2, . . . , and BK14) and a second group of memory banks (e.g., even-numbered memory banks BK1, BK3, . . . , and BK15).

A core circuit may be disposed to be adjacent to the memory banks BK0, . . . , and BK15. The core circuit may include X-decoders XDECs and Y-decoders/IO circuits YDEC/IOs. An X-decoder XDEC may also be referred to as a word line decoder or a row decoder. In an embodiment, two odd-numbered memory banks arrayed to be adjacent to each other in one row among the odd-numbered memory banks BK0, BK2, . . . , and BK14 may share one of the X-decoders XDECs with each other. For example, the first memory bank BK0 and the third memory bank BK2 adjacent to each other in a first row may share one of the X-decoders XDECs, and the fifth memory bank BK4 and the seventh memory bank BK6 adjacent to each other in the first row may also share one of the X-decoders XDECs. Similarly, two even-numbered memory banks arrayed to be adjacent to each other in one row among the even-numbered memory banks BK1, BK3, . . . , and BK15 may share one of the X-decoders XDECs with each other. For example, the second memory bank BK1 and the fourth memory bank BK3 adjacent to each other in a second row may share one of the X-decoders XDECs, and the sixth memory bank BK5 and the eighth memory bank BK7 adjacent to each other in the second row may also share one of the X-decoders XDECs. The X-decoder XDEC may receive a row address from an address latch included in a peripheral circuit PERI and may decode the row address to select and enable one of rows (i.e., word lines) coupled to the memory banks adjacent to the X-decoder XDEC.

The Y-decoders/IO circuits YDEC/IOs may be disposed to be allocated to the memory banks BK0, . . . , and BK15, respectively. For example, the first memory bank BK0 may be allocated to one of the Y-decoders/IO circuits YDEC/IOs, and the second memory bank BK1 may be allocated to another one of the Y-decoders/IO circuits YDEC/IOs. Each of the Y-decoders/IO circuits YDEC/IOs may include a Y-decoder YDEC and an I/O circuit IO. The Y-decoder YDEC may also be referred to as a bit line decoder or a column decoder. The Y-decoder YDEC may receive a column address from an address latch included in the peripheral circuit PERI and may decode the column address to select and enable at least one of columns (i.e., bit lines) coupled to the selected memory bank. Each of the I/O circuits may include an I/O sense amplifier for sensing and amplifying a level of a read datum outputted from the corresponding memory bank during a read operation and a write driver for driving a write datum during a write operation for the corresponding memory bank.

In an embodiment, the arithmetic circuit may include MAC operators MAC0, . . . , and MAC7. Although the present embodiment illustrates an example in which the MAC operators MAC0, . . . , and MAC7 are employed as the arithmetic circuit, the present embodiment may be merely an example of the present disclosure. For example, in some other embodiments, processors other than the MAC operators MAC0, . . . , and MAC7 may be employed as the arithmetic circuit. The MAC operators MAC0, . . . , and MAC7 may be disposed such that one of the odd-numbered memory banks BK0, BK2, . . . , and BK14 and one of the even-numbered memory banks BK1, BK3, . . . , and BK15 share any one of the MAC operators MAC0, . . . , and MAC7 with each other. Specifically, one odd-numbered memory bank and one even-numbered memory bank arrayed in one column to be adjacent to each other may constitute a pair of memory banks sharing one of the MAC operators MAC0, . . . , and MAC7 with each other. One of the MAC operators MAC0, . . . , and MAC7 and a pair of memory banks sharing the one MAC operator with each other will be referred to as ‘a MAC unit’ hereinafter.

In an embodiment, the number of the MAC operators MAC0, . . . , and MAC7 may be equal to the number of the odd-numbered memory banks BK0, BK2, . . . , and BK14 or the number of the even-numbered memory banks BK1, BK3, . . . , and BK15. The first memory bank BK0, the second memory bank BK1, and the first MAC operator MAC0 between the first memory bank BK0 and the second memory bank BK1 may constitute a first MAC unit. In addition, the third memory bank BK2, the fourth memory bank BK3, and the second MAC operator MAC1 between the third memory bank BK2 and the fourth memory bank BK3 may constitute a second MAC unit. The first MAC operator MAC0 included in the first MAC unit may receive first data DA1 outputted from the first memory bank BK0 included in the first MAC unit and second data DA2 outputted from the second memory bank BK1 included in the first MAC unit. In addition, the first MAC operator MAC0 may perform a MAC arithmetic operation of the first data DA1 and the second data DA2. In the event that the PIM device 100 performs a neural network calculation, for example, an arithmetic operation in a deep learning process, one of the first data DA1 and the second data DA2 may be weight data and the other may be vector data. A configuration of any one of the MAC operators MAC0˜MAC7 will be described in more detail hereinafter.

In the PIM device 100, the peripheral circuit PERI may be disposed in a region other than an area in which the memory banks BK0, BK1, . . . , and BK15, the MAC operators MAC0, . . . , and MAC7, and the core circuit are disposed. The peripheral circuit PERI may include a control circuit and a transmission path for a command/address signal, a control circuit and a transmission path for input/output of data, and a power supply circuit. The control circuit for the command/address signal may include a command decoder for decoding a command included in the command/address signal to generate an internal command signal, an address latch for converting an input address into a row address and a column address, a control circuit for controlling various functions of row/column operations, and a control circuit for controlling a delay locked loop (DLL) circuit. The control circuit for the input/output of data in the peripheral circuit PERI may include a control circuit for controlling a read/write operation, a read/write buffer, and an output driver. The power supply circuit in the peripheral circuit PERI may include a reference power voltage generation circuit for generating an internal reference power voltage and an internal power voltage generation circuit for generating an internal power voltage from an external power voltage.

The PIM device 100 according to the present embodiment may operate in any one mode of a memory mode and a MAC arithmetic mode. In the memory mode, the PIM device 100 may operate to perform the same operations as general memory devices. The memory mode may include a memory read operation mode and a memory write operation mode. In the memory read operation mode, the PIM device 100 may perform a read operation for reading out data from the memory banks BK0, BK1, . . . , and BK15 to output the read data, in response to an external request. In the memory write operation mode, the PIM device 100 may perform a write operation for storing data provided by an external device into the memory banks BK0, BK1, . . . , and BK15, in response to an external request.

In the MAC arithmetic mode, the PIM device 100 may perform the MAC arithmetic operation using the MAC operators MAC0, . . . , and MAC7. Specifically, the PIM device 100 may perform the read operation of the first data DA1 for each of the odd-numbered memory banks BK0, BK2, . . . , and BK14 and the read operation of the second data DA2 for each of the even-numbered memory banks BK1, BK3, . . . , and BK15, for the MAC arithmetic operation in the MAC arithmetic mode. In addition, each of the MAC operators MAC0, . . . , and MAC7 may perform the MAC arithmetic operation of the first data DA1 and the second data DA2 which are read out of the memory banks to store a result of the MAC arithmetic operation into the memory bank or to output the result of the MAC arithmetic operation. In some cases, the PIM device 100 may perform a data write operation for storing data to be used for the MAC arithmetic operation into the memory banks before the data read operation for the MAC arithmetic operation is performed in the MAC arithmetic mode.

The operation mode of the PIM device 100 according to the present embodiment may be determined by a command which is transmitted from a host or a controller to the PIM device 100. In an embodiment, if a first external command requesting a read operation or a write operation for the memory banks BK0, BK1, . . . , and BK15 is inputted to the PIM device 100, the PIM device 100 may perform the data read operation or the data write operation in the memory mode. Meanwhile, if a second external command requesting a MAC calculation corresponding to the MAC arithmetic operation is inputted to the PIM device 100, the PIM device 100 may perform the MAC arithmetic operation.

The PIM device 100 may perform a deterministic MAC arithmetic operation. The term “deterministic MAC arithmetic operation” used in the present disclosure may be defined as the MAC arithmetic operation performed in the PIM device 100 during a predetermined fixed time. Thus, the host or the controller may always predict a point in time (or a clock) when the MAC arithmetic operation terminates in the PIM device 100 at a point in time when an external command requesting the MAC arithmetic operation is transmitted from the host or the controller to the PIM device 100. No operation for informing the host or the controller of a status of the MAC arithmetic operation is required while the PIM device 100 performs the deterministic MAC arithmetic operation. In an embodiment, a latency during which the MAC arithmetic operation is performed in the PIM device 100 may be fixed for the deterministic MAC arithmetic operation.

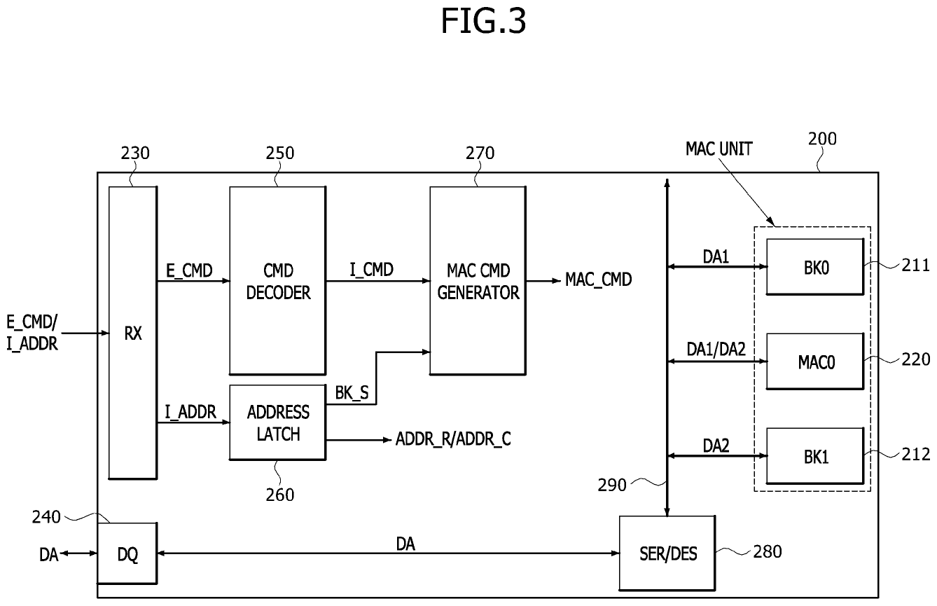

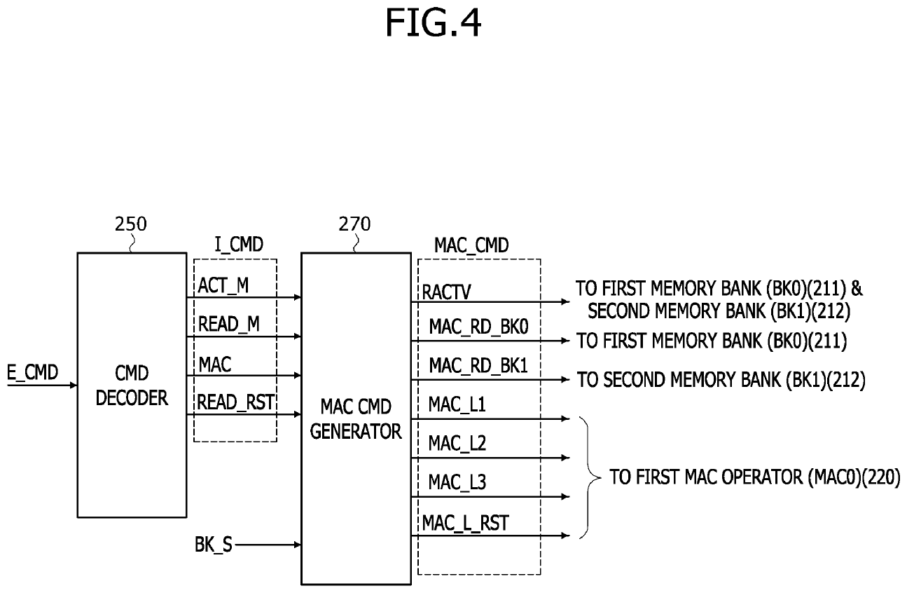

FIG. 3 is a block diagram illustrating a configuration of a PIM device 200 corresponding to the PIM device 100 illustrated in FIG. 3, and FIG. 4 illustrates an internal command signal I_CMD outputted from a command decoder 250 and a MAC command signal MAC_CMD outputted from a MAC command generator 270 included in the PIM device 200 of FIG. 3. FIG. 3 illustrates only the first memory bank (BK0) 211, the second memory bank (BK1) 212, and the first MAC operator (MAC0) 220 constituting the first MAC unit among the plurality of MAC units. However, FIG. 3 illustrates merely an example for simplification of the drawing. Accordingly, the following description for the first MAC unit may be equally applicable to the remaining MAC units. Referring to FIG. 3, the PIM device 200 may include a global I/O line (hereinafter, referred to as a ‘GIO line’) 290. The first memory bank (BK0) 211, the second memory bank (BK1) 212, and the first MAC operator (MAC0) 220 may communicate with each other through the GIO line 290. In an embodiment, the GIO line 290 may be disposed in the peripheral circuit PERI of FIG. 2.

The PIM device 200 may include a receiving driver (RX) 230, a data I/O circuit (DQ) 240, a command decoder 250, an address latch 260, a MAC command generator 270, and a serializer/deserializer (SER/DES) 280. The command decoder 250, the address latch 260, the MAC command generator 270, and the serializer/deserializer 280 may be disposed in the peripheral circuit PERI of the PIM device 100 illustrated in FIG. 2. The receiving driver 230 may receive an external command E_CMD and an input address I_ADDR from an external device. The external device may denote a host or a controller coupled to the PIM device 200. Hereinafter, it may be assumed that the external command E_CMD transmitted to the PIM device 200 is a command requesting the MAC arithmetic operation. That is, the PIM device 200 may perform the deterministic MAC arithmetic operation in response to the external command E_CMD. The data I/O circuit 240 may include an I/O pad. The data I/O circuit 240 may be coupled to data I/O line. The PIM device 200 may communicate with the external device through the data I/O circuit 240. The receiving driver 230 may separately output the external command E_CMD and the input address I_ADDR received from the external device. Data DA inputted to the PIM device 200 through the data I/O circuit 240 may be processed by the serializer/deserializer 280 and may be transmitted to the first memory bank (BK0) 211 and the second memory bank (BK1) 212 through the GIO line 290 of the PIM device 200. The data DA outputted from the first memory bank (BK0) 211, the second memory bank (BK1) 212, and the first MAC operator (MAC0) 220 through the GIO line 290 may be processed by the serializer/deserializer 280 and may be outputted to the external device through the data I/O circuit 240. The serializer/deserializer 280 may convert the data DA into parallel data if the data DA are serial data or may convert the data DA into serial data if the data DA are parallel data. For the data conversion, the serializer/deserializer 280 may include a serializer converting parallel data into serial data and a deserializer converting serial data into parallel data.

The command decoder 250 may decode the external command E_CMD outputted from the receiving driver 230 to generate and output the internal command signal I_CMD. As illustrated in FIG. 4, the internal command signal I_CMD outputted from the command decoder 250 may include first to fourth internal command signals. In an embodiment, the first internal command signal may be a memory active signal ACT_M, the second internal command signal may be a memory read signal READ_M, the third internal command signal may be a MAC arithmetic signal MAC, and the fourth internal command signal may be a result read signal READ_RST. The first to fourth internal command signals outputted from the command decoder 250 may be sequentially inputted to the MAC command generator 270.

In order to perform the deterministic MAC arithmetic operation of the PIM device 200, the memory active signal ACT_M, the memory read signal READ_M, the MAC arithmetic signal MAC, and the result read signal READ_RST outputted from the command decoder 250 may be sequentially generated at predetermined points in time (or clocks). In an embodiment, the memory active signal ACT_M, the memory read signal READ_M, the MAC arithmetic signal MAC, and the result read signal READ_RST may have predetermined latencies, respectively. For example, the memory read signal READ_M may be generated after a first latency elapses from a point in time when the memory active signal ACT_M is generated, the MAC arithmetic signal MAC may be generated after a second latency elapses from a point in time when the memory read signal READ_M is generated, and the result read signal READ_RST may be generated after a third latency elapses from a point in time when the MAC arithmetic signal MAC is generated. No signal is generated by the command decoder 250 until a fourth latency elapses from a point in time when the result read signal READ_RST is generated. The first to fourth latencies may be predetermined and fixed. Thus, the host or the controller outputting the external command E_CMD may predict the points in time when the first to fourth internal command signals constituting the internal command signal I_CMD are generated by the command decoder 250 in advance at a point in time when the external command E_CMD is outputted from the host or the controller.

The address latch 260 may convert the input address I_ADDR outputted from the receiving driver 230 into a bank selection signal BK_S and a row/column address ADDR_R/ADDR_C to output the bank selection signal BK_S and the row/column address ADDR_R/ADDR_C. The bank selection signal BK_S may be inputted to the MAC command generator 270. The row/column address ADDR_R/ADDR_C may be transmitted to the first and second memory banks 211 and 212. One of the first and second memory banks 211 and 212 may be selected by the bank selection signal BK_S. One of rows included in the selected memory bank and one of columns included in the selected memory bank may be selected by the row/column address ADDR_R/ADDR_C. In an embodiment, a point in time when the bank selection signal BK_S is inputted to the MAC command generator 270 may be the same moment as a point in time when the row/column address ADDR_R/ADDR_C is inputted to the first and second memory banks 211 and 212. In an embodiment, the point in time when the bank selection signal BK_S is inputted to the MAC command generator 270 and the point in time when the row/column address ADDR_R/ADDR_C is inputted to the first and second memory banks 211 and 212 may be a point in time when the MAC command is generated to read out data from the first and second memory banks 211 and 212 for the MAC arithmetic operation.

The MAC command generator 270 may output the MAC command signal MAC_CMD in response to the internal command signal I_CMD outputted from the command decoder 250 and the bank selection signal BK_S outputted from the address latch 260. As illustrated in FIG. 4, the MAC command signal MAC_CMD outputted from the MAC command generator 270 may include first to seventh MAC command signals. In an embodiment, the first MAC command signal may be a MAC active signal RACTV, the second MAC command signal may be a first MAC read signal MAC_RD_BK0, the third MAC command signal may be a second MAC read signal MAC_RD_BK1, the fourth MAC command signal may be a first MAC input latch signal MAC_L1, the fifth MAC command signal may be a second MAC input latch signal MAC_L2, the sixth MAC command signal may be a MAC output latch signal MAC_L3, and the seventh MAC command signal may be a MAC result latch signal MAC_L_RST.

The MAC active signal RACTV may be generated based on the memory active signal ACT_M outputted from the command decoder 250. The first MAC read signal MAC_RD_BK0 may be generated in response to the memory read signal READ_M outputted from the command decoder 250 and the bank selection signal BK_S having a first level (e.g., a logic “low” level) outputted from the address latch 260. The first MAC input latch signal MAC_L1 may be generated at a point in time when a certain time elapses from a point in time when the first MAC read signal MAC_RD_BK0 is generated. For various embodiments, a certain time means a fixed time duration. The second MAC read signal MAC_RD_BK1 may be generated in response to the memory read signal READ_M outputted from the command decoder 250 and the bank selection signal BK_S having a second level (e.g., a logic “high” level) outputted from the address latch 260. The second MAC input latch signal MAC_L2 may be generated at a point in time when a certain time elapses from a point in time when the second MAC read signal MAC_RD_BK1 is generated. The MAC output latch signal MAC_L3 may be generated in response to the MAC arithmetic signal MAC outputted from the command decoder 250. Finally, the MAC result latch signal MAC_L_RST may be generated in response to the result read signal READ_RST outputted from the command decoder 250.

The MAC active signal RACTV outputted from the MAC command generator 270 may control an activation operation for the first and second memory banks 211 and 212. The first MAC read signal MAC_RD_BK0 outputted from the MAC command generator 270 may control a data read operation for the first memory bank 211. The second MAC read signal MAC_RD_BK1 outputted from the MAC command generator 270 may control a data read operation for the second memory bank 212. The first MAC input latch signal MAC_L1 and the second MAC input latch signal MAC_L2 outputted from the MAC command generator 270 may control an input data latch operation of the first MAC operator (MAC0) 220. The MAC output latch signal MAC_L3 outputted from the MAC command generator 270 may control an output data latch operation of the first MAC operator (MAC0) 220. The MAC result latch signal MAC_L_RST outputted from the MAC command generator 270 may control a reset operation of the first MAC operator (MAC0) 220.

As described above, in order to perform the deterministic MAC arithmetic operation of the PIM device 200, the memory active signal ACT_M, the memory read signal READ_M, the MAC arithmetic signal MAC, and the result read signal READ_RST outputted from the command decoder 250 may be sequentially generated at predetermined points in time (or clocks), respectively. Thus, the MAC active signal RACTV, the first MAC read signal MAC_RD_BK0, the second MAC read signal MAC_RD_BK1, the first MAC input latch signal MAC_L1, the second MAC input latch signal MAC_L2, the MAC output latch signal MAC_L3, and the MAC result latch signal MAC_L_RST may also be generated and outputted from the MAC command generator 270 at predetermined points in time after the external command E_CMD is inputted to the PIM device 200, respectively. That is, a time period from a point in time when the first and second memory banks 211 and 212 are activated by the MAC active signal RACTV until a point in time when the first MAC operator (MAC0) 220 is reset by the MAC result latch signal MAC_L_RST may be predetermined, and thus the PIM device 200 may perform the deterministic MAC arithmetic operation.

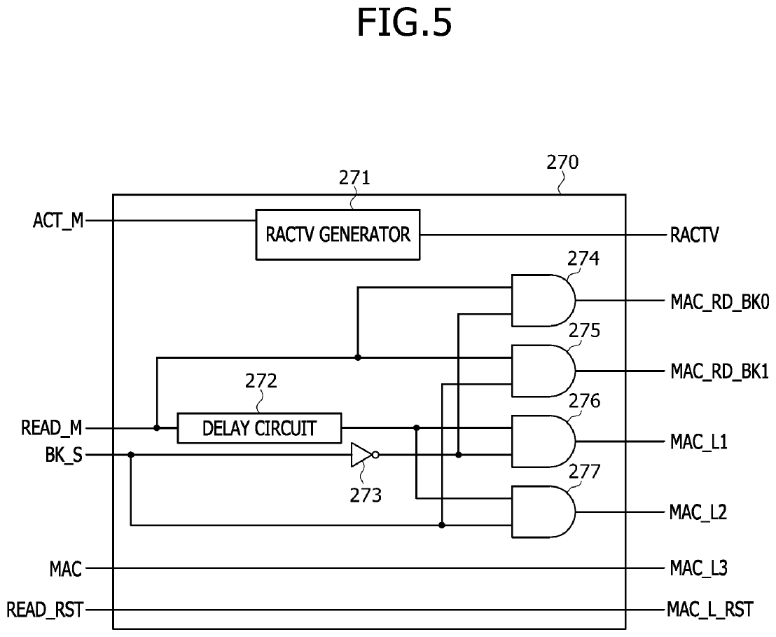

FIG. 5 illustrates an example of a configuration of the MAC command generator 270 included in the PIM device 200 illustrated in FIG. 3. Referring to FIG. 5, the MAC command generator 270 may sequentially receive the memory active signal ACT_M, the memory read signal READ_M, the MAC arithmetic signal MAC, and the result read signal READ_RST from the command decoder 250. In addition, the MAC command generator 270 may also receive the bank selection signal BK_S from the address latch 260. The MAC command generator 270 may output the MAC active signal RACTV, the first MAC read signal MAC_RD_BK0, the second MAC read signal MAC_RD_BK1, the first MAC input latch signal MAC_L1, the second MAC input latch signal MAC_L2, the MAC output latch signal MAC_L3, and the MAC result latch signal MAC_L_RST in series with certain time intervals. For an embodiment, a certain time interval is a time interval having a fixed duration.

In an embodiment, the MAC command generator 270 may be configured to include an active signal generator 271, a delay circuit 272, an inverter 273, and first to fourth AND gates 274, 275, 276, and 277. The active signal generator 271 may receive the memory active signal ACT_M to generate and output the MAC active signal RACTV. The MAC active signal RACTV outputted from the active signal generator 271 may be transmitted to the first and second memory banks 211 and 212 to activate the first and second memory banks 211 and 212. The delay circuit 272 may receive the memory read signal READ_M and may delay the memory read signal READ_M by a delay time DELAY_T to output the delayed signal of the memory read signal READ_M. The inverter 273 may receive the bank selection signal BK_S and may invert a logic level of the bank selection signal BK_S to output the inverted signal of the bank selection signal BK_S.

The first AND gate 274 may receive the memory read signal READ_M and an output signal of the inverter 273 and may perform a logical AND operation of the memory read signal READ_M and an output signal of the inverter 273 to generate and output the first MAC read signal MAC_RD_BK0. The second AND gate 275 may receive the memory read signal READ_M and the bank selection signal BK_S and may perform a logical AND operation of the memory read signal READ_M and the bank selection signal BK_S to generate and output the second MAC read signal MAC_RD_BK1. The third AND gate 276 may receive an output signal of the delay circuit 272 and an output signal of the inverter 273 and may perform a logical AND operation of the output signals of the delay circuit 272 and the inverter 273 to generate and output the first MAC input latch signal MAC_L1. The fourth AND gate 277 may receive an output signal of the delay circuit 272 and the bank selection signal BK_S and may perform a logical AND operation of the output signal of the delay circuit 272 and the bank selection signal BK_S to generate and output the second MAC input latch signal MAC_L2.

It may be assumed that the memory read signal READ_M inputted to the MAC command generator 270 has a logic “high” level and the bank selection signal BK_S inputted to the MAC command generator 270 has a logic “low” level. A level of the bank selection signal BK_S may change from a logic “low” level into a logic “high” level after a certain time elapses. When the memory read signal READ_M has a logic “high” level and the bank selection signal BK_S has a logic “low” level, the first AND gate 274 may output the first MAC read signal MAC_RD_BK0 having a logic “high” level and the second AND gate 275 may output the second MAC read signal MAC_RD_BK1 having a logic “low” level. The first memory bank 211 may transmit the first data DA1 to the first MAC operator 220 according to a control operation based on the first MAC read signal MAC_RD_BK0 having a logic “high” level. If a level transition of the bank selection signal BK_S occurs so that both of the memory read signal READ_M and the bank selection signal BK_S have a logic “high” level, the first AND gate 274 may output the first MAC read signal MAC_RD_BK0 having a logic “low” level and the second AND gate 275 may output the second MAC read signal MAC_RD_BK1 having a logic “high” level. The second memory bank 212 may transmit the second data DA2 to the first MAC operator 220 according to a control operation based on the second MAC read signal MAC_RD_BK1 having a logic “high” level.

Due to the delay time of the delay circuit 272, the output signals of the third and fourth AND gates 276 and 277 may be generated after the first and second MAC read signals MAC_RD_BK0 and MAC_RD_BK1 are generated. Thus, after the second MAC read signal MAC_RD_BK1 is generated, the third AND gate 276 may output the first MAC input latch signal MAC_L1 having a logic “high” level. The first MAC operator 220 may latch the first data DA1 in response to the first MAC input latch signal MAC_L1 having a logic “high” level. After a certain time elapses from a point in time when the first data DA1 are latched by the first MAC operator 220, the fourth AND gate 277 may output the second MAC input latch signal MAC_L2 having a logic “high” level. The first MAC operator 220 may latch the second data DA2 in response to the second MAC input latch signal MAC_L2 having a logic “high” level. The first MAC operator 220 may start to perform the MAC arithmetic operation after the first and second data DA1 and DA2 are latched.

The MAC command generator 270 may generate the MAC output latch signal MAC_L3 in response to the MAC arithmetic signal MAC outputted from the command decoder 250. The MAC output latch signal MAC_L3 may have the same logic level as the MAC arithmetic signal MAC. For example, if the MAC arithmetic signal MAC having a logic “high” level is inputted to the MAC command generator 270, the MAC command generator 270 may generate the MAC output latch signal MAC_L3 having a logic “high” level. The MAC command generator 270 may generate the MAC result latch signal MAC_L_RST in response to the result read signal READ_RST outputted from the command decoder 250. The MAC result latch signal MAC_L_RST may have the same logic level as the result read signal READ_RST. For example, if the result read signal READ_RST having a logic “high” level is inputted to the MAC command generator 270, the MAC command generator 270 may generate the MAC result latch signal MAC_L_RST having a logic “high” level.

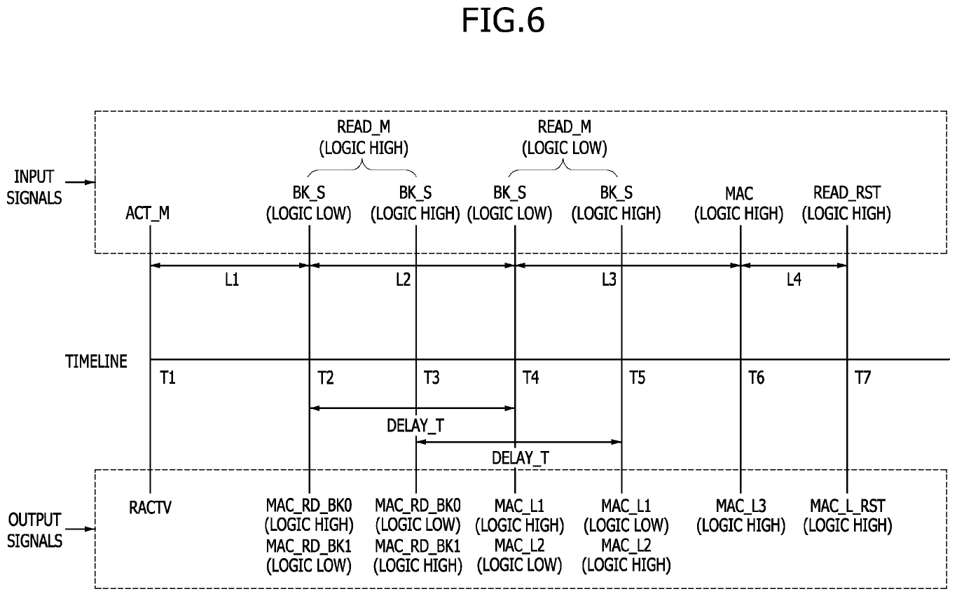

FIG. 6 illustrates input signals and output signals of the MAC command generator 270 illustrated in FIG. 5 along a timeline. In FIG. 6, signals transmitted from the command decoder 250 to the MAC command generator 270 are illustrated in an upper dotted line box, and signals outputted from the MAC command generator 270 are illustrated in a lower dotted line box. Referring to FIGS. 5 and 6 at a first point in time “T1” of the timeline, the memory active signal ACT_M may be inputted to the MAC command generator 270 and the MAC command generator 270 may output the MAC active signal RACTV. At a second point in time “T2” when a certain time, for example, a first latency L1 elapses from the first point in time “T1”, the memory read signal READ_M having a logic “high” level and the bank selection signal BK_S having a logic “low” level may be inputted to the MAC command generator 270. In response to the memory read signal READ_M having a logic “high” level and the bank selection signal BK_S having a logic “low” level, the MAC command generator 270 may output the first MAC read signal MAC_RD_BK0 having a logic “high” level and the second MAC read signal MAC_RD_BK1 having a logic “low” level in response to the memory read signal READ_M having a logic “high” level and the bank selection signal BK_S having a logic “low” level, as described with reference to FIG. 5. At a third point in time “T3” when a certain time elapses from the second point in time “T2”, a logic level of the bank selection signal BK_S may change from a logic “low” level into a logic “high” level. In such a case, the MAC command generator 270 may output the first MAC read signal MAC_RD_BK0 having a logic “low” level and the second MAC read signal MAC_RD_BK1 having a logic “high” level, as described with reference to FIG. 5.

At a fourth point in time “T4” when the delay time DELAY_T elapses from the second point in time “T2”, the MAC command generator 270 may output the first MAC input latch signal MAC_L1 having a logic “high” level and the second MAC input latch signal MAC_L2 having a logic “low” level. The delay time DELAY_T may be set by the delay circuit 272. The delay time DELAY_T may bet to be different according a logic design scheme of the delay circuit 272 and may be fixed once the logic design scheme of the delay circuit 272 is determined. In an embodiment, the delay time DELAY_T may be set to be equal to or greater than a second latency L2. At a fifth point in time “T5” when a certain time elapses from the fourth point in time “T4”, the MAC command generator 270 may output the first MAC input latch signal MAC_L1 having a logic “low” level and the second MAC input latch signal MAC_L2 having a logic “high” level. The fifth point in time “T5” may be a moment when the delay time DELAY_T elapses from the third point in time “T3”.

At a sixth point in time “T6” when a certain time, for example, a third latency L3 elapses from the fourth point in time “T4”, the MAC arithmetic signal MAC having a logic “high” level may be inputted to the MAC command generator 270. In response to the MAC arithmetic signal MAC having a logic “high” level, the MAC command generator 270 may output the MAC output latch signal MAC_L3 having a logic “high” level, as described with reference to FIG. 5. Subsequently, at a seventh point in time “T7” when a certain time, for example, a fourth latency L4 elapses from the sixth point in time “T6”, the result read signal READ_RST having a logic “high” level may be inputted to the MAC command generator 270. In response to the result read signal READ_RST having a logic “high” level, the MAC command generator 270 may output the MAC result latch signal MAC_L_RST having a logic “high” level, as described with reference to FIG. 5.

In order to perform the deterministic MAC arithmetic operation, moments when the internal command signals ACT_M, READ_M, MAC, and READ_RST generated by the command decoder 250 are inputted to the MAC command generator 270 may be fixed and moments when the MAC command signals RACTV, MAC_RD_BK0, MAC_RD_BK1, MAC_L1, MAC_L2, MAC_L3, and MAC_L_RST are outputted from the MAC command generator 270 in response to the internal command signals ACT_M, READ_M, MAC, and READ_RST may also be fixed. Thus, all of the first latency L1 between the first point in time “T1” and the second point in time “T2”, the second latency L2 between the second point in time “T2” and the fourth point in time “T4”, the third latency L3 between the fourth point in time “T4” and the sixth point in time “T6”, and the fourth latency L4 between the sixth point in time “T6” and the seventh point in time “T7” may have fixed values.

In an embodiment, the first latency L1 may be defined as a time it takes to activate both of the first and second memory banks based on the MAC active signal RACTV. The second latency L2 may be defined as a time it takes to read the first and second data out of the first and second memory banks BK0 and BK1 based on the first and second MAC read signals MAC_RD_BK0 and MAC_RD_BK1 and to input the first and second data DA1 and DA2 into the first MAC operator (MAC0) 220. The third latency L3 may be defined as a time it takes to latch the first and second data DA1 and DA2 in the first MAC operator (MAC0) 220 based on the first and second MAC input latch signals MAC_L1 and MAC_L2 and it takes the first MAC operator (MAC0) 220 to perform the MAC arithmetic operation of the first and second data. The fourth latency L4 may be defined as a time it takes to latch the output data in the first MAC operator (MAC0) 220 based on the MAC output latch signal MAC_L3.

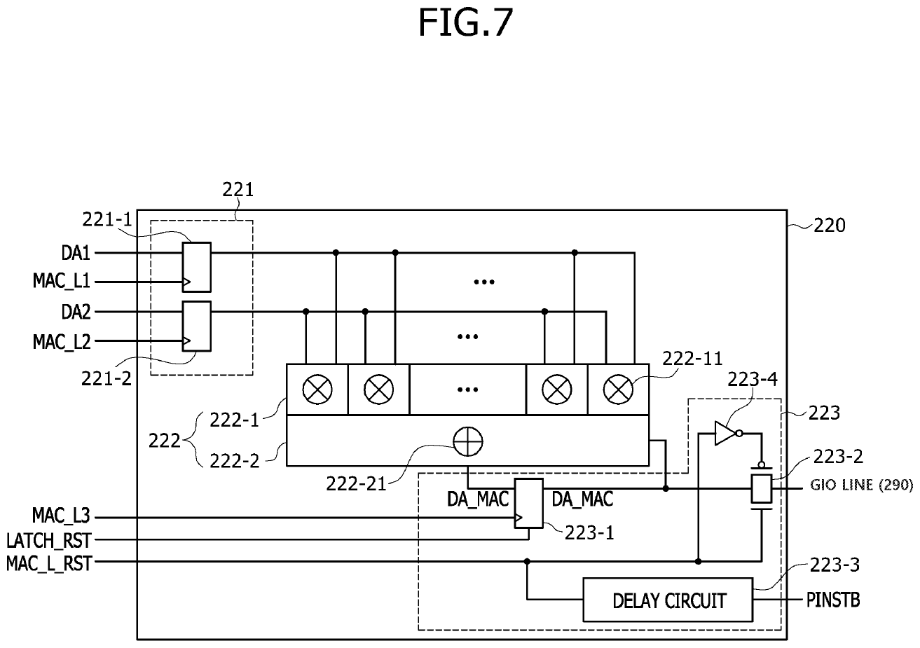

FIG. 7 illustrates an example of a configuration of the first MAC operator (MAC0) 220 included in the PIM device 200 illustrated in FIG. 3. Referring to FIG. 7, the first MAC operator (MAC0) 220 may be configured to include a data input circuit 221, a MAC circuit 222, and a data output circuit 223. The data input circuit 221 may be configured to include a first input latch 221-1 and a second input latch 221-2. The MAC circuit 222 may be configured to include a multiplication logic circuit 222-1 and an addition logic circuit 222-2. The data output circuit 223 may be configured to include an output latch 223-1, a transfer gate 223-2, a delay circuit 223-3, and an inverter 223-4. In an embodiment, the first input latch 221-1, the second input latch 221-2, and the output latch 223-1 may be realized using flip-flops.

The data input circuit 221 of the first MAC operator (MAC0) 220 may be synchronized with the first and second MAC input latch signals MAC_L1 and MAC_L2 to receive and output the first and second data DA1 and DA2 inputted through the GIO line 290 to the MAC circuit 222. Specifically, the first data DA1 may be transmitted from the first memory bank BK0 (211 of FIG. 3) to the first input latch 221-1 of the data input circuit 221 through the GIO line 290, in response to the first MAC read signal MAC_RD_BK0 having a logic “high” level outputted from the MAC command generator (270 of FIG. 3). The second data DA2 may be transmitted from the second memory bank BK1 (212 of FIG. 2) to the second input latch 221-2 of the data input circuit 221 through the GIO line 290, in response to the second MAC read signal MAC_RD_BK1 having a logic “high” level outputted from the MAC command generator 270. The first input latch 221-1 may output the first data DA1 to the MAC circuit 222 in synchronization with the first MAC input latch signal MAC_L1 having a logic “high” level outputted from the MAC command generator 270 (270 of FIG. 3). The second input latch 221-2 may output the second data DA2 to the MAC circuit 222 in synchronization with the second MAC input latch signal MAC_L2 having a logic “high” level outputted from the MAC command generator (270 of FIG. 3). As described with reference to FIG. 5, the second MAC input latch signal MAC_L2 may be generated at a moment (corresponding to the fifth point in time “T5” of FIG. 6) when a certain time elapses from a moment (corresponding to the fourth point in time “T4” of FIG. 6) when the first MAC input latch signal MAC_L1 is generated. Thus, after the first data DA1 is inputted to the MAC circuit 222, the second data DA2 may then be inputted to the MAC circuit 222.

The MAC circuit 222 may perform a multiplying calculation and an accumulative adding calculation for the first and second data DA1 and DA2. The multiplication logic circuit 222-1 of the MAC circuit 222 may include a plurality of multipliers 222-11. Each of the plurality of multipliers 222-11 may perform a multiplying calculation of the first data DA1 outputted from the first input latch 221-1 and the second data DA2 outputted from the second input latch 221-2 and may output the result of the multiplying calculation. Bit values constituting the first data DA1 may be separately inputted to the multipliers 222-11. Similarly, bit values constituting the second data DA2 may also be separately inputted to the multipliers 222-11. For example, if each of the first and second data DA1 and DA2 is comprised of an ‘N’-bit binary stream and the number of the multipliers 222-11 is ‘M’, the first data DA1 having ‘N/M’ bits and the second data DA2 having ‘N/M’ bits may be inputted to each of the multipliers 222-11. That is, each of the multipliers 222-11 may be configured to perform a multiplying calculation of first ‘N/M’-bit data and second ‘N/M’-bit data. Multiplication result data outputted from each of the multipliers 222-11 may have ‘2N/M’ bits.

The addition logic circuit 222-2 of the MAC circuit 222 may include a plurality of adders 222-21. Although not shown in the drawings, the plurality of adders 222-21 may be disposed to provide a tree structure including a plurality of stages. Each of the adders 222-21 disposed at a first stage may receive two sets of multiplication result data from two of the multipliers 222-11 included in the multiplication logic circuit 222-1 and may perform an adding calculation of the two sets of multiplication result data to output addition result data. Each of the adders 222-21 disposed at a second stage may receive two sets of addition result data from two of the adders 222-21 disposed at the first stage and may perform an adding calculation of the two sets of addition result data to output addition result data. The adders 222-21 disposed at a last stage may receive two sets of addition result data from two adders 222-21 disposed at the previous stage and may perform an adding calculation of the two sets of addition result data to output the addition result data. The adders 222-21 constituting the addition logic circuit 222-2 may include an adder for performing an accumulative adding calculation of the addition result data outputted from the adder 222-21 disposed at the last stage and previous MAC result data stored in the output latch 223-1 of the data output circuit 223.

The data output circuit 223 may output MAC result data DA_MAC outputted from the MAC circuit 222 to the GIO line 290. Specifically, the output latch 223-1 of the data output circuit 223 may latch the MAC result data DA_MAC outputted from the MAC circuit 222 and may output the latched data of the MAC result data DA_MAC in synchronization with the MAC output latch signal MAC_L3 having a logic “high” level outputted from the MAC command generator (270 of FIG. 3). The MAC result data DA_MAC outputted from the output latch 223-1 may be fed back to the MAC circuit 222 for the accumulative adding calculation. In addition, the MAC result data DA_MAC may be inputted to the transfer gate 223-2, and the transfer gate 223-2 may output the MAC result data DA_MAC to the GIO line 290. The output latch 223-1 may be initialized if a latch reset signal LATCH_RST is inputted to the output latch 223-1. In such a case, all of data latched by the output latch 223-1 may be removed. In an embodiment, the latch reset signal LATCH_RST may be activated by generation of the MAC result latch signal MAC_L_RST having a logic “high” level and may be inputted to the output latch 223-1.

The MAC result latch signal MAC_L_RST outputted from the MAC command generator 270 may be inputted to the transfer gate 223-2, the delay circuit 223-3, and the inverter 223-4. The inverter 223-4 may inversely buffer the MAC result latch signal MAC_L_RST to output the inversely buffered signal of the MAC result latch signal MAC_L_RST to the transfer gate 223-2. The transfer gate 223-2 may transfer the MAC result data DA_MAC from the output latch 223-1 to the GIO line 290 in response to the MAC result latch signal MAC_L_RST having a logic “high” level. The delay circuit 223-3 may delay the MAC result latch signal MAC_L_RST by a certain time to generate and output a latch control signal PINSTB.

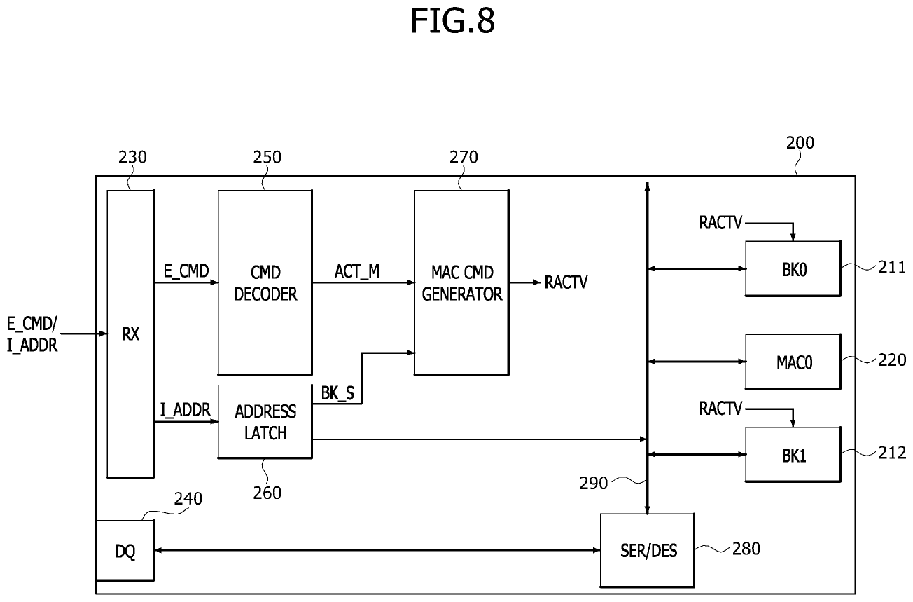

FIGS. 8 to 14 are block diagrams illustrating operations of the PIM device 200 illustrated in FIG. 3. In FIGS. 8 to 14, the same reference numerals or the same reference symbols as used in FIG. 3 denote the same elements. First, referring to FIG. 8, if the external command E_CMD requesting the MAC arithmetic operation and the input address I_ADDR are transmitted from an external device to the receiving driver 230, the receiving driver 230 may output the external command E_CMD and the input address I_ADDR to the command decoder 250 and the address latch 260, respectively. The command decoder 250 may decode the external command E_CMD to generate and transmit the memory active signal ACT_M to the MAC command generator 270. The address latch 260 receiving the input address I_ADDR may generate and transmit the bank selection signal BK_S to the MAC command generator 270. The MAC command generator 270 may generate and output the MAC active signal RACTV in response to the memory active signal ACT_M and the bank selection signal BK_S. The MAC active signal RACTV may be transmitted to the first memory bank (BK0) 211 and the second memory bank (BK1) 212. The first memory bank (BK0) 211 and the second memory bank (BK1) 212 may be activated by the MAC active signal RACTV.

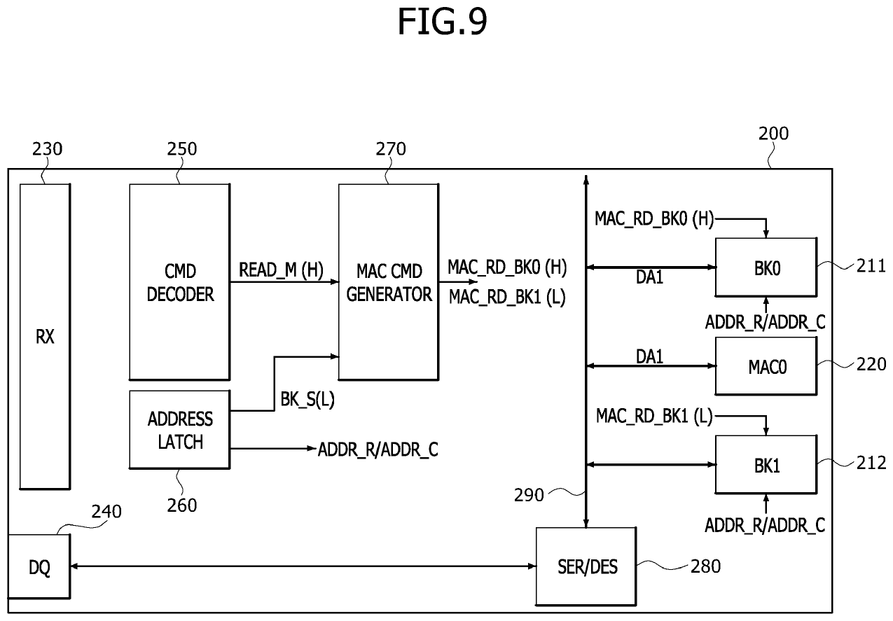

Next, referring to FIG. 9, the command decoder 250 may generate and output the memory read signal READ_M having a logic “high(H)” level to the MAC command generator 270. In addition, the address latch 260 may generate and output the bank selection signal BK_S having a logic “low(L)” level to the MAC command generator 270. In response to the memory read signal READ_M having a logic “high(H)” level and the bank selection signal BK_S having a logic “low(L)” level, the MAC command generator 270 may generate and output the first MAC read signal MAC_RD_BK0 having a logic “high(H)” level and the second MAC read signal MAC_RD_BK1 having a logic “low(L)” level, as described with reference to FIG. 4. The first MAC read signal MAC_RD_BK0 having a logic “high(H)” level, together with the row/column address ADDR_R/ADDR_C, may be transmitted to the first memory bank (BK0) 211. The second MAC read signal MAC_RD_BK1 having a logic “low(L)” level, together with the row/column address ADDR_R/ADDR_C, may be transmitted to the second memory bank (BK1) 212. The first data DA1 may be read out of the first memory bank (BK0) 211 by the first MAC read signal MAC_RD_BK0 having a logic “high(H)” level and may be transmitted to the first MAC operator (MAC0) 220 through the GIO line 290.

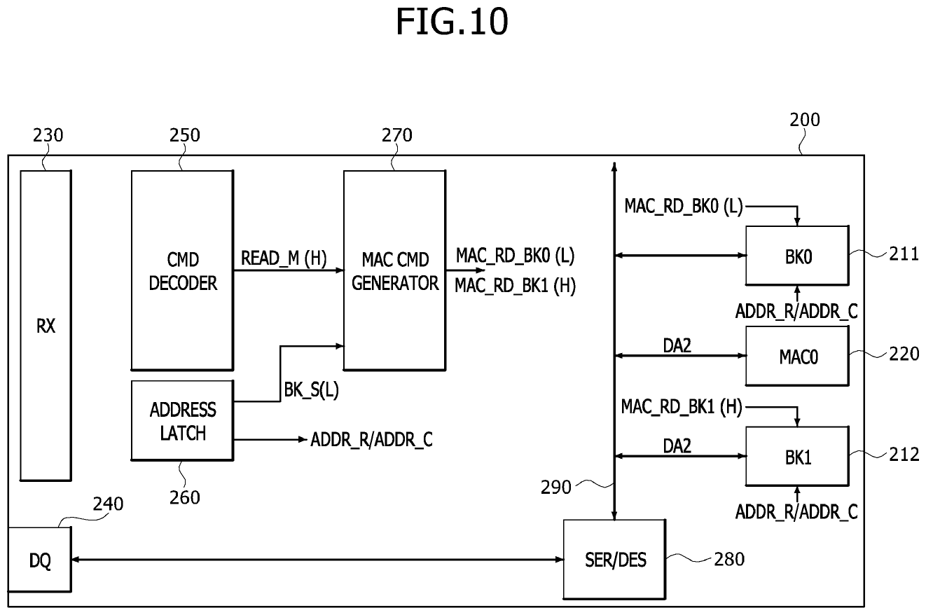

Next, referring to FIG. 10, a logic level of the bank selection signal BK_S may change from a logic “low(L)” level into a logic “high(H)” level while the memory read signal READ_M maintains a logic “high(H)” level. In such a case, as described with reference to FIG. 5, the MAC command generator 270 may generate and output the first MAC read signal MAC_RD_BK0 having a logic “low(L)” level and the second MAC read signal MAC_RD_BK1 having a logic “high(H)” level. The first MAC read signal MAC_RD_BK0 having a logic “low(L)” level, together with the row/column address ADDR_R/ADDR_C, may be transmitted to the first memory bank (BK0) 211. The second MAC read signal MAC_RD_BK1 having a logic “high(H)” level, together with the row/column address ADDR_R/ADDR_C, may be transmitted to the second memory bank (BK1) 212. The second data DA2 may be read out of the second memory bank (BK1) 212 by the second MAC read signal MAC_RD_BK1 having a logic “high(H)” level and may be transmitted to the first MAC operator (MAC0) 220 through the GIO line 290.

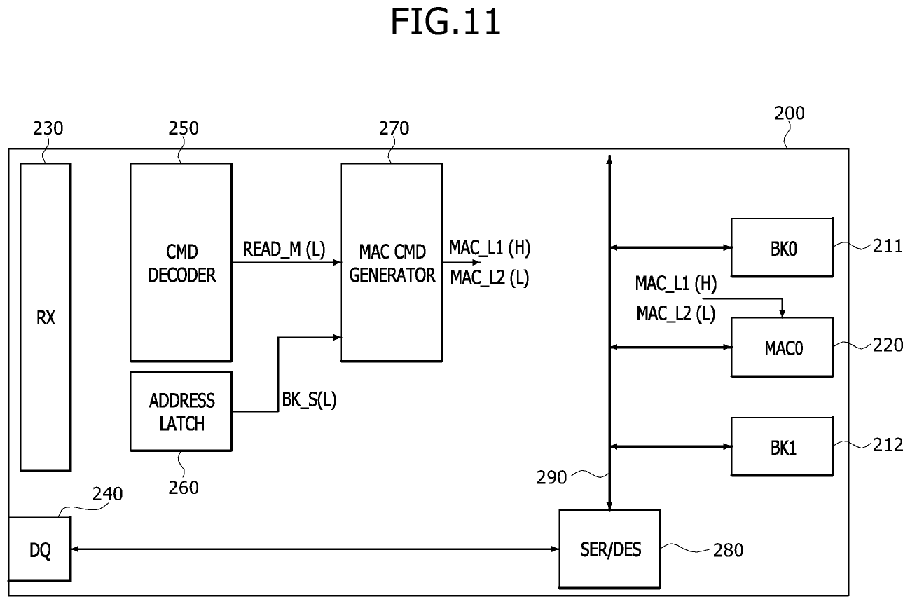

Next, referring to FIG. 11, a logic level of the memory read signal READ_M transmitted from the command decoder 250 to the MAC command generator 270 may change from a logic “high(H)” level into a logic “low(L)” level. In addition, a logic level of the bank selection signal BK_S transmitted from the address latch 260 to the MAC command generator 270 may change from a logic “high(H)” level into a logic “low(L)” level. In such a case, the MAC command generator 270 may generate and output the first MAC input latch signal MAC_L1 having a logic “high(H)” level and the second MAC input latch signal MAC_L2 having a logic “low(L)” level. A point in time when the first MAC input latch signal MAC_L1 having a logic “high(H)” level and the second MAC input latch signal MAC_L2 having a logic “low(L)” level are outputted from the MAC command generator 270 may be determined by a delay time of the delay circuit (271 of FIG. 4), as described with reference to FIG. 5. The first MAC input latch signal MAC_L1 having a logic “high(H)” level and the second MAC input latch signal MAC_L2 having a logic “low(L)” level outputted from the MAC command generator 270 may be transmitted to the first MAC operator (MAC0) 220. As described with reference to FIG. 7, the first MAC operator (MAC0) 220 may perform a latch operation of the first data DA1.

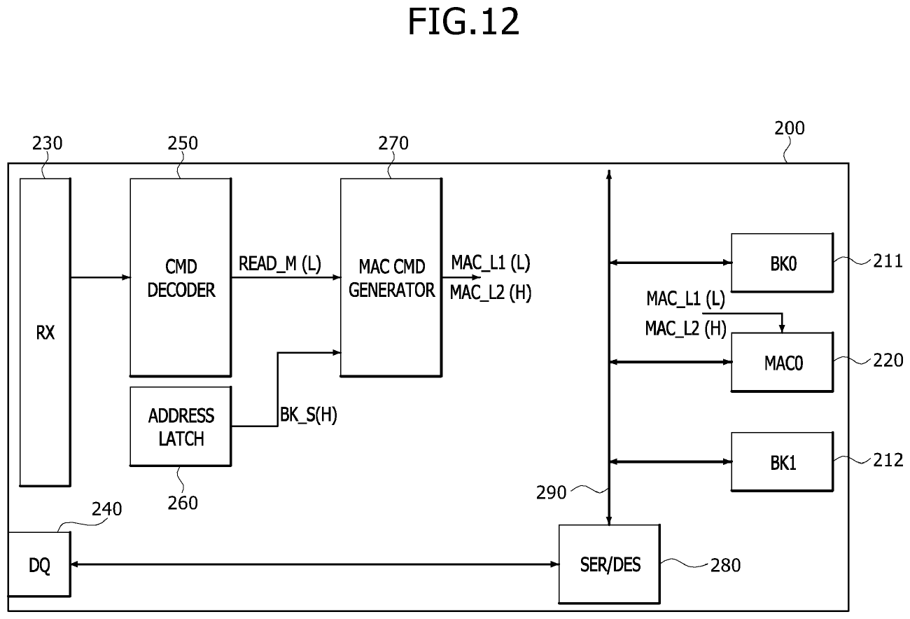

Next, referring to FIG. 12, a logic level of the bank selection signal BK_S transmitted from the address latch 260 to the MAC command generator 270 may change from a logic “low(L)” level into a logic “high(H)” level while the memory read signal READ_M maintains a logic “low(L)” level. In such a case, the MAC command generator 270 may generate and output the first MAC input latch signal MAC_L1 having a logic “low(L)” level and the second MAC input latch signal MAC_L2 having a logic “high(H)” level. A point in time when the first MAC input latch signal MAC_L1 having a logic “low(L)” level and the second MAC input latch signal MAC_L2 having a logic “high(H)” level are outputted from the MAC command generator 270 may be determined by a delay time of the delay circuit (271 of FIG. 5), as described with reference to FIG. 5. The first MAC input latch signal MAC_L1 having a logic “low(L)” level and the second MAC input latch signal MAC_L2 having a logic “high(H)” level outputted from the MAC command generator 270 may be transmitted to the first MAC operator (MAC0) 220. As described with reference to FIG. 7, the first MAC operator (MAC0) 220 may perform a latch operation of the second data DA2. After the latch operations of the first and second data DA1 and DA2 terminate, the first MAC operator (MAC0) 220 may perform the MAC arithmetic operation and may generate the MAC result data DA_MAC. The MAC result data DA_MAC generated by the first MAC operator (MAC0) 220 may be inputted to the output latch 223-1 included in the first MAC operator (MAC0) 220.

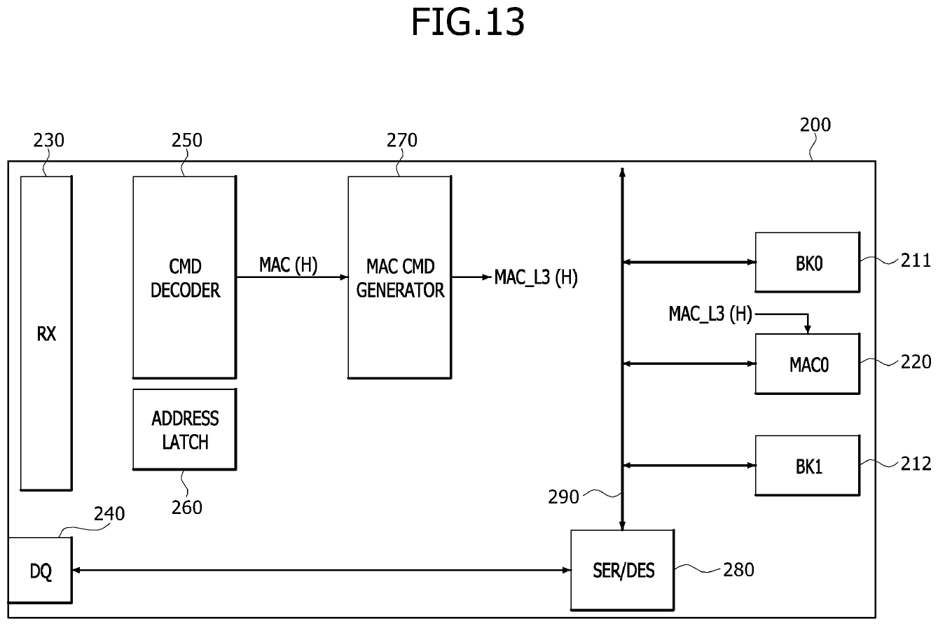

Next, referring to FIG. 13, the command decoder 250 may output and transmit the MAC arithmetic signal MAC having a logic “high(H)” level to the MAC command generator 270. The MAC command generator 270 may generate and output the MAC output latch signal MAC_L3 having a logic “high” level in response to the MAC arithmetic signal MAC having a logic “high(H)” level. The MAC output latch signal MAC_L3 having a logic “high” level may be transmitted to the first MAC operator (MAC0) 220. As described with reference to FIG. 7, the output latch (223-1 of FIG. 7) of the first MAC operator (MAC0) 220 may be synchronized with the MAC output latch signal MAC_L3 having a logic “high” level to transfer the MAC result data DA_MAC outputted from the MAC circuit 222 of the first MAC operator (MAC0) 220 to the transfer gate (233-2 of FIG. 7) of the first MAC operator (MAC0) 220. The MAC result data DA_MAC outputted from the output latch (223-1 of FIG. 7) may be fed back to the addition logic circuit (222-2 of FIG. 7) for the accumulative adding calculation.

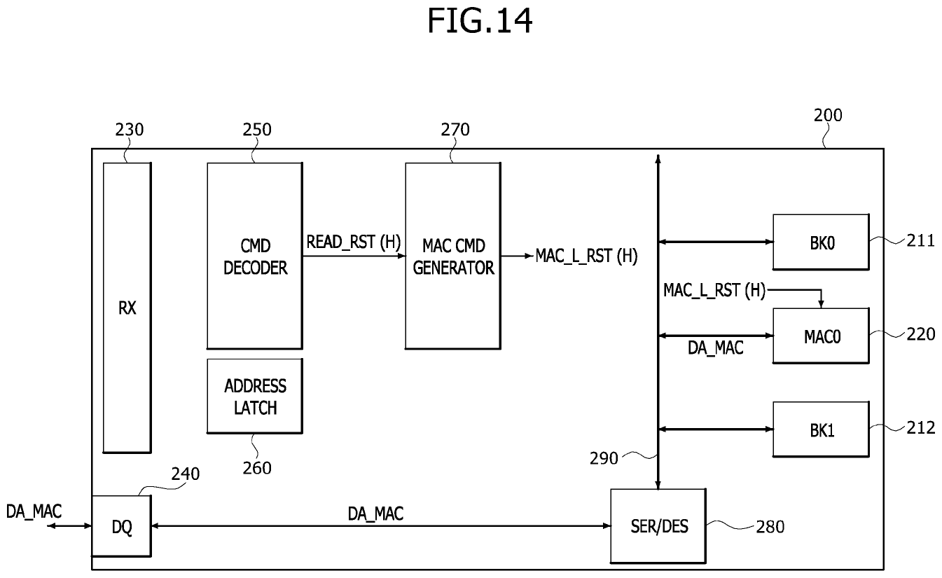

Next, referring to FIG. 14, the command decoder 250 may output and transmit the result read signal READ_RST having a logic “high(H)” level to the MAC command generator 270. The MAC command generator 270 may generate and output the MAC result latch signal MAC_L_RST having a logic “high” level in response to the result read signal READ_RST having a logic “high(H)” level. The MAC result latch signal MAC_L_RST having a logic “high” level may be transmitted to the first MAC operator (MAC0) 220. As described with reference to FIG. 7, the first MAC operator (MAC0) 220 may output the MAC result data DA_MAC to the GIO line 290 in response to the MAC result latch signal MAC_L_RST having a logic “high” level and may also reset the output latch (223-1 of FIG. 6) included in the first MAC operator (MAC0) 220 in response to the MAC result latch signal MAC_L_RST having a logic “high” level. The MAC result data DA_MAC transmitted to the GIO line 290 may be outputted to an external device through the serializer/deserializer 280 and the data I/O circuit 240.

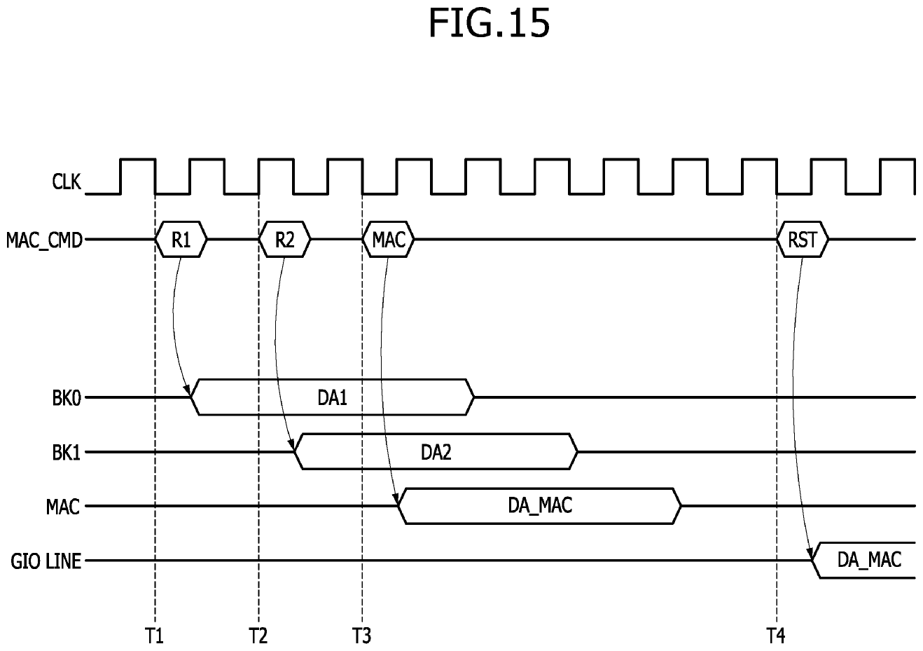

FIG. 15 is a timing diagram illustrating an operation of the PIM device 200 illustrate in FIG. 3. Referring to FIG. 15, at a first point in time “T1”, the MAC command generator 270 may be synchronized with a falling edge of a clock signal CLK to generate and output the first MAC read signal MAC_RD_BK0 (R1) having a logic “high(H)” level. The first memory bank (BK0) 211 may be selected by the first MAC read signal MAC_RD_BK0 (R1) having a logic “high(H)” level so that the first data DA1 are read out of the first memory bank (BK0) 211. At a second point in time “T2”, the MAC command generator 270 may be synchronized with a falling edge of the clock signal CLK to generate and output the second MAC read signal MAC_RD_BK1 (R2) having a logic “high(H)” level. The second memory bank (BK1) 212 may be selected by the second MAC read signal MAC_RD_BK1 (R2) having a logic “high(H)” level so that the second data DA2 are read out of the second memory bank (BK1) 212. At a third point in time “T3”, the MAC command generator 270 may be synchronized with a falling edge of the clock signal CLK to generate and output the MAC arithmetic signal MAC having a logic “high(H)” level. The first MAC operator (MAC0) 220 may perform the multiplying calculations and the adding calculations of the first and second data DA1 and DA2 to generate the MAC result data DA_MAC, in response to the MAC arithmetic signal MAC having a logic “high(H)” level. At a fourth point in time “T4”, the MAC command generator 270 may be synchronized with a falling edge of the clock signal CLK to generate and output the MAC result latch signal MAC_L_RST (RST) having a logic “high” level. The MAC result data DA_MAC generated by the first MAC operator (MAC0) 220 may be transmitted to the GIO line 290 by the MAC result latch signal MAC_L_RST (RST) having a logic “high” level.

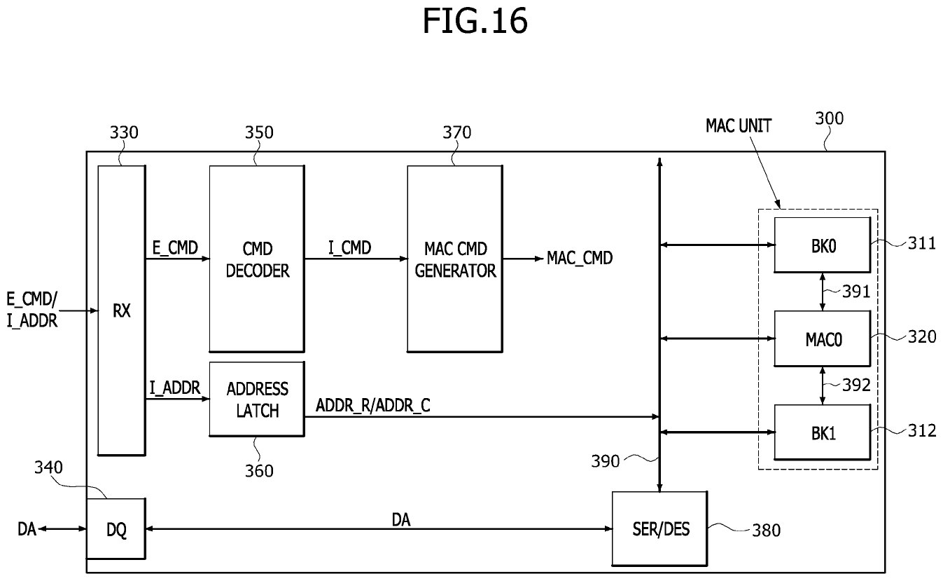

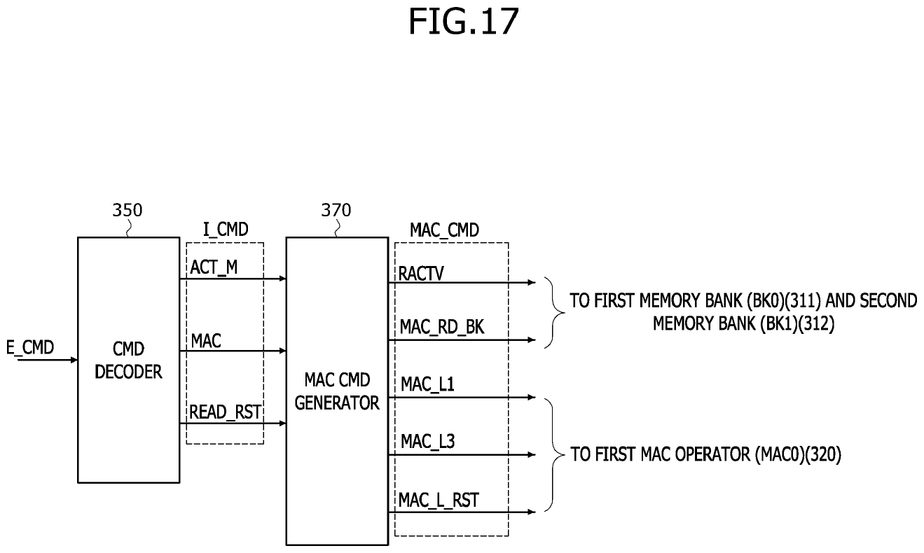

FIG. 16 is a block diagram illustrating another configuration of a PIM device 300 according to an embodiment of the present disclosure, and FIG. 17 illustrates an internal command signal I_CMD outputted from a command decoder 350 of the PIM device 300 and a MAC command signal MAC_CMD outputted from a MAC command generator 370 of the PIM device 300. FIG. 16 illustrates only a first memory bank (BK0) 311, a second memory bank (BK1) 312, and a first MAC operator (MAC0) 320 constituting a first MAC unit among the plurality of MAC units. However, FIG. 16 illustrates merely an example for simplification of the drawing. Accordingly, the following description for the first MAC unit may be equally applicable to the remaining MAC units.

Referring to FIG. 16, the PIM device 300 may be configured to include the first memory bank (BK0) 311, the second memory bank (BK1) 312, and the first MAC operator (MAC0) 320. The PIM device 300 according to the present embodiment may include a GIO line 390, a first bank input/output (BIO) line 391, and a second BIO line 392 acting as data transmission lines. Data communication of the first memory bank (BK0) 311, the second memory bank (BK1) 312, and the first MAC operator (MAC0) 320 may be achieved through the GIO line 390. Only the data transmission between the first memory bank (BK0) 311 and the first MAC operator (MAC0) 320 may be achieved through the first BIO line 391, and only the data transmission between the second memory bank (BK1) 312 and the first MAC operator (MAC0) 320 may be achieved through the second BIO line 392. Thus, the first MAC operator (MAC0) 320 may directly receive first data and second data from the first and second memory banks (BK0 and BK1) 311 and 312 through the first BIO line 391 and the second BIO line 392 without using the GIO line 390.

The PIM device 300 may further include a receiving driver (RX) 330, a data I/O circuit (DQ) 340, the command decoder 350, an address latch 360, the MAC command generator 370, and a serializer/deserializer (SER/DES) 380. The command decoder 350, the address latch 360, the MAC command generator 370, and the serializer/deserializer 380 may be disposed in the peripheral circuit PERI of the PIM device 100 illustrated in FIG. 2. The receiving driver 330 may receive an external command E_CMD and an input address I_ADDR from an external device. The external device may denote a host or a controller coupled to the PIM device 300. Hereinafter, it may be assumed that the external command E_CMD transmitted to the PIM device 300 is a command requesting the MAC arithmetic operation. That is, the PIM device 300 may perform the deterministic MAC arithmetic operation in response to the external command E_CMD. The data I/O circuit 340 may include a data I/O pad. The data I/O pad may be coupled with an data I/O line. The PIM device 300 communicates with the external device through the data I/O circuit 340.

The receiving driver 330 may separately output the external command E_CMD and the input address I_ADDR received from the external device. Data DA inputted to the PIM device 300 through the data I/O circuit 340 may be processed by the serializer/deserializer 380 and may be transmitted to the first memory bank (BK0) 311 and the second memory bank (BK1) 312 through the GIO line 390 of the PIM device 300. The data DA outputted from the first memory bank (BK0) 311, the second memory bank (BK1) 312, and the first MAC operator (MAC0) 320 through the GIO line 390 may be processed by the serializer/deserializer 380 and may be outputted to the external device through the data I/O circuit 340. The serializer/deserializer 380 may convert the data DA into parallel data if the data DA are serial data or may convert the data DA into serial data if the data DA are parallel data. For the data conversion, the serializer/deserializer 380 may include a serializer for converting parallel data into serial data and a deserializer for converting serial data into parallel data.

The command decoder 350 may decode the external command E_CMD outputted from the receiving driver 330 to generate and output the internal command signal I_CMD. As illustrated in FIG. 17, the internal command signal I_CMD outputted from the command decoder 350 may include first to third internal command signals. In an embodiment, the first internal command signal may be a memory active signal ACT_M, the second internal command signal may be a MAC arithmetic signal MAC, and the third internal command signal may be a result read signal READ_RST. The first to third internal command signals outputted from the command decoder 350 may be sequentially inputted to the MAC command generator 370.

In order to perform the deterministic MAC arithmetic operation of the PIM device 300, the memory active signal ACT_M, the MAC arithmetic signal MAC, and the result read signal READ_RST outputted from the command decoder 350 may be sequentially generated at predetermined points in time (or clocks). In an embodiment, the memory active signal ACT_M, the MAC arithmetic signal MAC, and the result read signal READ_RST may have predetermined latencies, respectively. For example, the MAC arithmetic signal MAC may be generated after a first latency elapses from a point in time when the memory active signal ACT_M is generated, and the result read signal READ_RST may be generated after a third latency elapses from a point in time when the MAC arithmetic signal MAC is generated. No signal is generated by the command decoder 350 until a fourth latency elapses from a point in time when the result read signal READ_RST is generated. The first to fourth latencies may be predetermined and fixed. Thus, the host or the controller outputting the external command E_CMD may predict the points in time when the first to third internal command signals constituting the internal command signal I_CMD are generated by the command decoder 350 in advance at a point in time when the external command E_CMD is outputted from the host or the controller. That is, the host or the controller may predict a point in time (or a clock) when the MAC arithmetic operation terminates in the PIM device 300 after the external command E_CMD requesting the MAC arithmetic operation is transmitted from the host or the controller to the PIM device 300, even without receiving any signals from the PIM device 300.

The address latch 360 may convert the input address I_ADDR outputted from the receiving driver 330 into a row/column address ADDR_R/ADDR_C to output the row/column address ADDR_R/ADDR_C. The row/column address ADDR_R/ADDR_C outputted from the address latch 360 may be transmitted to the first and second memory banks 311 and 312. According to the present embodiment, the first data and the second data to be used for the MAC arithmetic operation may be simultaneously read out of the first and second memory banks (BK0 and BK1) 311 and 312, respectively. Thus, it may be unnecessary to generate a bank selection signal for selecting any one of the first and second memory banks 311 and 312. In an embodiment, a point in time when the row/column address ADDR_R/ADDR_C is inputted to the first and second memory banks 311 and 312 may be a point in time when a MAC command (i.e., the MAC arithmetic signal MAC) requesting a data read operation for the first and second memory banks 311 and 312 for the MAC arithmetic operation is generated.

The MAC command generator 370 may output the MAC command signal MAC_CMD in response to the internal command signal I_CMD outputted from the command decoder 350. As illustrated in FIG. 16, the MAC command signal MAC_CMD outputted from the MAC command generator 370 may include first to fifth MAC command signals. In an embodiment, the first MAC command signal may be a MAC active signal RACTV, the second MAC command signal may be a MAC read signal MAC_RD_BK, the third MAC command signal may be a MAC input latch signal MAC_L1, the fourth MAC command signal may be a MAC output latch signal MAC_L3, and the fifth MAC command signal may be a MAC result latch signal MAC_L_RST.

The MAC active signal RACTV may be generated based on the memory active signal ACT_M outputted from the command decoder 350. The MAC read signal MAC_RD_BK, the MAC input latch signal MAC_L1, the MAC output latch signal MAC_L3, and the MAC result latch signal MAC_L_RST may be sequentially generated based on the MAC arithmetic signal MAC outputted from the command decoder 350. That is, the MAC input latch signal MAC_L1 may be generated at a point in time when a certain time elapses from a point in time when the MAC read signal MAC_RD_BK is generated. The MAC output latch signal MAC_L3 may be generated at a point in time when a certain time elapses from a point in time when the MAC input latch signal MAC_L1 is generated. Finally, the MAC result latch signal MAC_L_RST may be generated based on the result read signal READ_RST outputted from the command decoder 350.

The MAC active signal RACTV outputted from the MAC command generator 370 may control an activation operation for the first and second memory banks 311 and 312. The MAC read signal MAC_RD_BK outputted from the MAC command generator 370 may control a data read operation for the first and second memory banks 311 and 312. The MAC input latch signal MAC_L1 outputted from the MAC command generator 370 may control an input data latch operation of the first MAC operator (MAC0) 320. The MAC output latch signal MAC_L3 outputted from the MAC command generator 370 may control an output data latch operation of the first MAC operator (MAC0) 320. The MAC result latch signal MAC_L_RST outputted from the MAC command generator 370 may control an output operation of MAC result data of the first MAC operator (MAC0) 320 and a reset operation of the first MAC operator (MAC0) 320.

As described above, in order to perform the deterministic MAC arithmetic operation of the PIM device 300, the memory active signal ACT_M, the MAC arithmetic signal MAC, and the result read signal READ_RST outputted from the command decoder 350 may be sequentially generated at predetermined points in time (or clocks), respectively. Thus, the MAC active signal RACTV, the MAC read signal MAC_RD_BK, the MAC input latch signal MAC_L1, the MAC output latch signal MAC_L3, and the MAC result latch signal MAC_L_RST may also be generated and outputted from the MAC command generator 370 at predetermined points in time after the external command E_CMD is inputted to the PIM device 300, respectively. That is, a time period from a point in time when the first and second memory banks 311 and 312 are activated by the MAC active signal RACTV until a point in time when the first MAC operator (MAC0) 320 is reset by the MAC result latch signal MAC_L_RST may be predetermined.

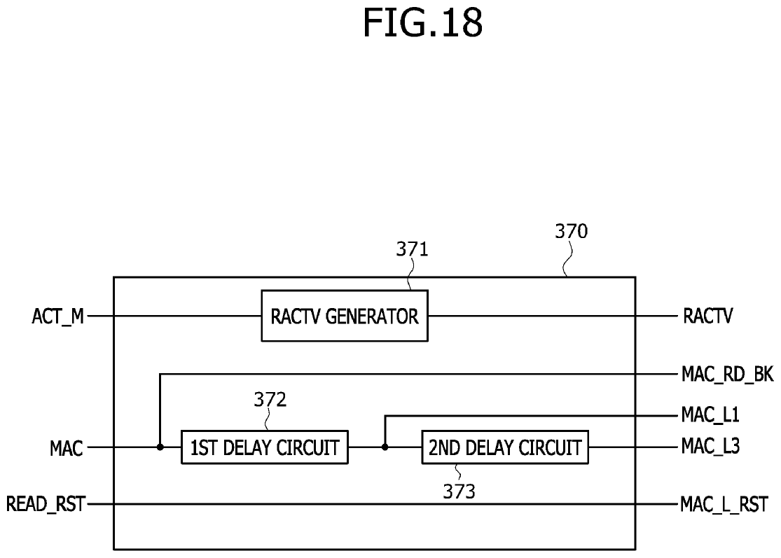

FIG. 18 illustrates an example of a configuration of the MAC command generator 370 included in the PIM device 300 illustrated in FIG. 16. Referring to FIG. 18, the MAC command generator 370 may sequentially receive the memory active signal ACT_M, the MAC arithmetic signal MAC, and the result read signal READ_RST from the command decoder 350. In addition, the MAC command generator 370 may sequentially generate and output the MAC active signal RACTV, the MAC read signal MAC_RD_BK, the MAC input latch signal MAC_L1, the MAC output latch signal MAC_L3, and the MAC result latch signal MAC_L_RST. The MAC active signal RACTV, the MAC read signal MAC_RD_BK, the MAC input latch signal MAC_L1, the MAC output latch signal MAC_L3, and the MAC result latch signal MAC_L_RST may be outputted in series with certain time intervals.

In an embodiment, the MAC command generator 370 may be configured to include an active signal generator 371, a first delay circuit 372, and a second delay circuit 373. The active signal generator 371 may receive the memory active signal ACT_M to generate and output the MAC active signal RACTV. The MAC active signal RACTV outputted from the active signal generator 371 may be transmitted to the first and second memory banks 311 and 312 to activate the first and second memory banks 311 and 312. The MAC command generator 370 may receive the MAC arithmetic signal MAC outputted from the command decoder 350 to output the MAC arithmetic signal MAC as the MAC read signal MAC_RD_BK. The first delay circuit 372 may receive the MAC arithmetic signal MAC and may delay the MAC arithmetic signal MAC by a first delay time DELAY_T1 to generate and output the MAC input latch signal MAC_L1. The second delay circuit 373 may receive an output signal of the first delay circuit 372 and may delay the output signal of the first delay circuit 372 by a second delay time DELAY_T2 to generate and output the MAC output latch signal MAC_L3. The MAC command generator 370 may generate the MAC result latch signal MAC_L_RST in response to the result read signal READ_RST outputted from the command decoder 350.

The MAC command generator 370 may generate and output the MAC active signal RACTV in response to the memory active signal ACT_M outputted from the command decoder 350. Subsequently, the MAC command generator 370 may generate and output the MAC read signal MAC_RD_BK in response to the MAC arithmetic signal MAC outputted from the command decoder 350. The MAC arithmetic signal MAC may be inputted to the first delay circuit 372. The MAC command generator 370 may delay the MAC arithmetic signal MAC by a certain time determined by the first delay circuit 372 to generate and output an output signal of the first delay circuit 372 as the MAC input latch signal MAC_L1. The output signal of the first delay circuit 372 may be inputted to the second delay circuit 373. The MAC command generator 370 may delay the MAC input latch signal MAC_L1 by a certain time determined by the second delay circuit 373 to generate and output an output signal of the second delay circuit 373 as the MAC output latch signal MAC_L3. Subsequently, the MAC command generator 370 may generate and output the MAC result latch signal MAC_L_RST in response to the result read signal READ_RST outputted from the command decoder 350.

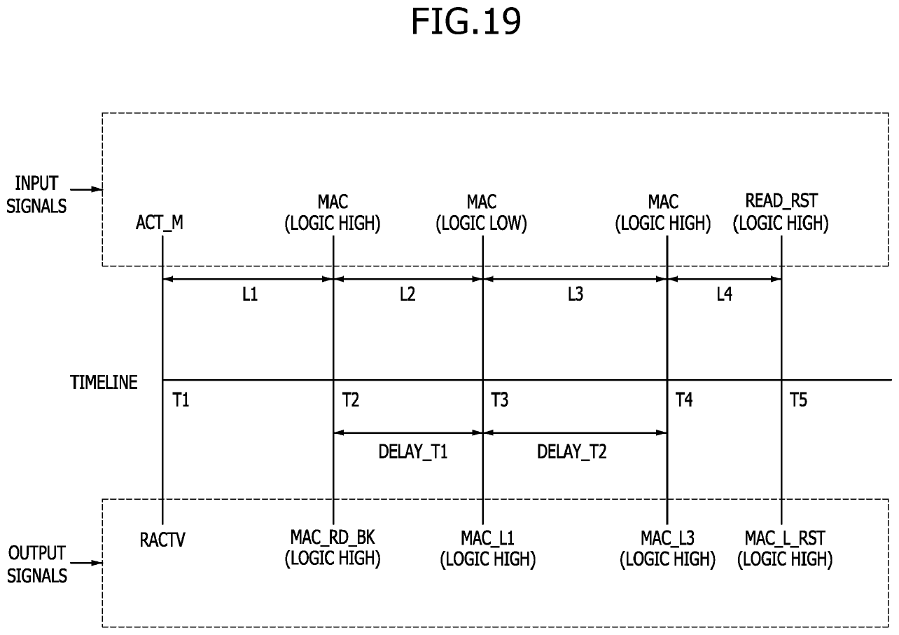

FIG. 19 illustrates input signals and output signals of the MAC command generator 370 illustrated in FIG. 18 with a timeline. In FIG. 19, signals transmitted from the command decoder 350 to the MAC command generator 370 are illustrated in an upper dotted line box, and signals outputted from the MAC command generator 370 are illustrated in a lower dotted line box. Referring to FIGS. 18 and 19, at a first point in time “T1” of the timeline, the memory active signal ACT_M may be inputted to the MAC command generator 370 and the MAC command generator 370 may output the MAC active signal RACTV. At a second point in time “T2” when a certain time, for example, a first latency L1 elapses from the first point in time “T1”, the MAC arithmetic signal MAC having a logic “high” level may be inputted to the MAC command generator 370. In response to the MAC arithmetic signal MAC having a logic “high” level, the MAC command generator 370 may output the MAC read signal MAC_RD_BK having a logic “high” level. At a third point in time “T3” when a certain time elapses from the second point in time “T2”, a logic level of the MAC arithmetic signal MAC may change from a logic “high” level into a logic “low” level.

At the third point in time “T3” when the first delay time DELAY_T1 elapses from the second point in time “T2”, the MAC command generator 370 may output the MAC input latch signal MAC_L1 having a logic “high” level. The first delay time DELAY_T1 may correspond to a delay time determined by the first delay circuit 372 illustrated in FIG. 18. The first delay time DELAY_T1 may be set to be different according to a logic design scheme of the first delay circuit 372. In an embodiment, the first delay time DELAY_T1 may be set to be equal to or greater than a second latency L2. At a fourth point in time “T4” when a certain time elapses from the third point in time “T3”, the MAC command generator 370 may output the MAC output latch signal MAC_L3 having a logic “high” level. The fourth point in time “T4” may be a moment when the second delay time DELAY_T2 elapses from the third point in time “T3”. The second delay time DELAY_T2 may correspond to a delay time determined by the second delay circuit 373 illustrated in FIG. 18. The second delay time DELAY_T2 may be set to be different according to a logic design scheme of the second delay circuit 373. In an embodiment, the second delay time DELAY_T2 may be set to be equal to or greater than a third latency L3. At a fifth point in time “T5” when a certain time, for example, a fourth L4 elapses from the fourth point in time “T4”, the result read signal READ_RST having a logic “high” level may be inputted to the MAC command generator 370. In response to the result read signal READ_RST having a logic “high” level, the MAC command generator 370 may output the MAC result latch signal MAC_L_RST having a logic “high” level, as described with reference to FIG. 18.

In order to perform the deterministic MAC arithmetic operation, moments when the internal command signals ACT_M, MAC, and READ_RST generated by the command decoder 350 are inputted to the MAC command generator 370 may be fixed and moments when the MAC command signals RACTV, MAC_RD_BK, MAC_L1, MAC_L3, and MAC_L_RST are outputted from the MAC command generator 370 in response to the internal command signals ACT_M, MAC, and READ_RST may also be fixed. Thus, all of the first latency L1 between the first point in time “T1” and the second point in time “T2”, the second latency L2 between the second point in time “T2” and the third point in time “T3”, the third latency L3 between the third point in time “T3” and the fourth point in time “T4”, and the fourth latency L4 between the fourth point in time “T4” and the fifth point in time “T5” may have fixed values.

In an embodiment, the first latency L1 may be defined as a time it takes to activate both of the first and second memory banks based on the MAC active signal RACTV. The second latency L2 may be defined as a time it takes to read the first and second data out of the first and second memory banks (BK0 and BK1) 311 and 312 based on the MAC read signals MAC_RD_BK and to input the first and second data DA1 and DA2 into the first MAC operator (MAC0) 320. The third latency L3 may be defined as a time it takes to latch the first and second data DA1 and DA2 in the first MAC operator (MAC0) 320 based on the MAC input latch signals MAC_L1 and it takes the first MAC operator (MAC0) 320 to perform the MAC arithmetic operation of the first and second data. The fourth latency L4 may be defined as a time it takes to latch the output data in the first MAC operator (MAC0) 320 based on the MAC output latch signal MAC_L3.

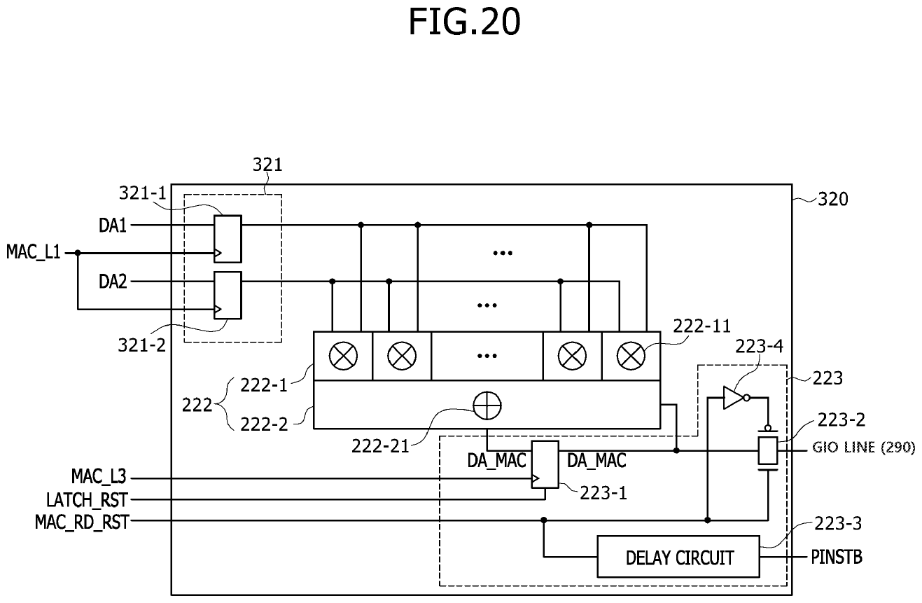

FIG. 20 illustrates an example of a configuration of the first MAC operator (MAC0) 320 included in the PIM device 300 of FIG. 16. The first MAC operator (MAC0) 320 included in the PIM device 300 may have the same configuration as the first MAC operator (MAC0) 220 described with reference to FIG. 7 except for a signal applied to clock terminals of first and second input latches 321-1 and 321-2 constituting a data input circuit 321. Thus, in FIG. 20, the same reference numerals or the same reference symbols as used in FIG. 7 denote the same elements, and descriptions of the same elements as set forth with reference to FIG. 7 will be omitted hereinafter.

Describing in detail the differences between the first MAC operator (MAC0) 220 and the first MAC operator (MAC0) 320, in case of the first MAC operator (MAC0) 220 illustrated in FIG. 7, the first input latch (221-1 of FIG. 7) and the second input latch (221-2 of FIG. 7) of the data input circuit (221 of FIG. 7) may be synchronized with the first and second MAC input latch signals MAC_L1 and MAC_L2, respectively, sequentially generated with a certain time interval to output the first data DA1 and the second data DA2. In contrast, in case of the first MAC operator (MAC0) 320, the MAC input latch signal MAC_L1 may be inputted to both of the clock terminals of the first and second input latches 321-1 and 321-2 constituting a data input circuit 321. Thus, both of the first and second input latches 321-1 and 321-2 may be synchronized with the MAC input latch signal MAC_L1 to output the first data DA1 and the second data DA2, respectively. Accordingly, the first MAC operator (MAC0) 320 may transmit the first and second data DA1 and DA2 to the MAC circuit 222 in parallel without any time interval between the first and second data DA1 and DA2. As a result, the MAC arithmetic operation of the MAC circuit 222 may be quickly performed without any delay of data input time.

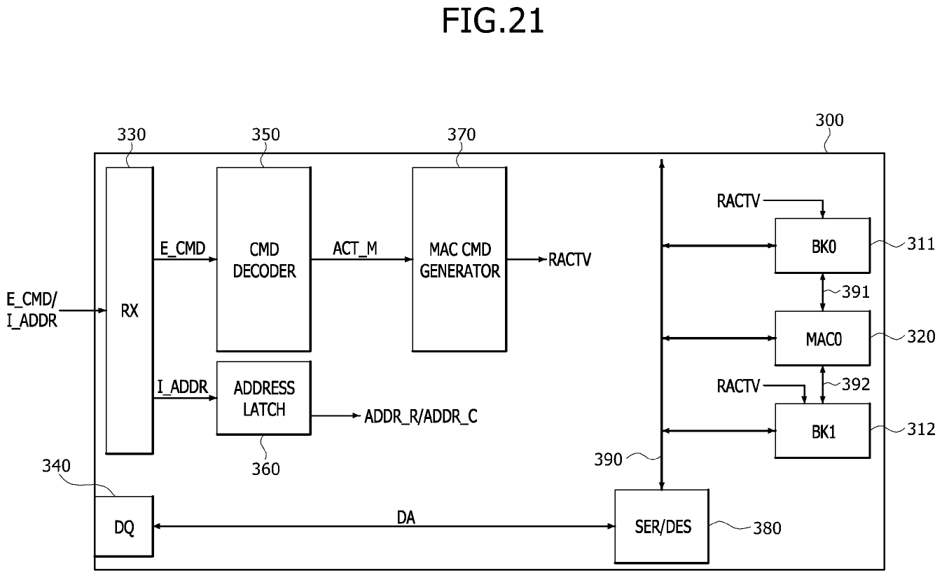

FIGS. 21 to 25 are block diagrams illustrating operations of the PIM device 300 illustrated in FIG. 16. In FIGS. 21 to 25, the same reference numerals or the same reference symbols as used in FIG. 16 denote the same elements. First, referring to FIG. 21, if the external command E_CMD requesting the MAC arithmetic operation and the input address I_ADDR are transmitted from an external device to the receiving driver 330, the receiving driver 330 may output the external command E_CMD and the input address I_ADDR to the command decoder 350 and the address latch 360, respectively. The command decoder 350 may decode the external command E_CMD to generate and transmit the memory active signal ACT_M to the MAC command generator 370. The MAC command generator 370 may generate and output the MAC active signal RACTV in response to the memory active signal ACT_M. The MAC active signal RACTV may be transmitted to the first memory bank (BK0) 311 and the second memory bank (BK1) 312. Both of the first memory bank (BK0) 311 and the second memory bank (BK1) 312 may be activated by the MAC active signal RACTV.

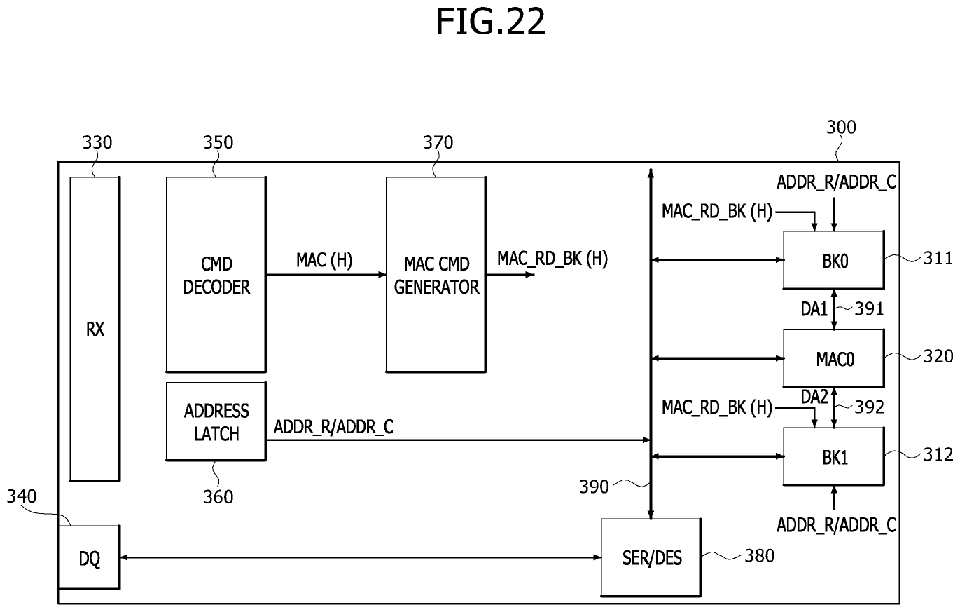

Next, referring to FIG. 22, the command decoder 350 may generate and output the MAC arithmetic signal MAC having a logic “high(H)” level to the MAC command generator 370. In response to the MAC arithmetic signal MAC having a logic “high(H)” level, the MAC command generator 370 may generate and output the MAC read signal MAC_RD_BK having a logic “high(H)” level. The MAC read signal MAC_RD_BK having a logic “high(H)” level, together with the row/column address ADDR_R/ADDR_C, may be transmitted to the first memory bank (BK0) 311 and the second memory bank (BK1) 312. The first data DA1 may be read out of the first memory bank (BK0) 311 by the MAC read signal MAC_RD_BK having a logic “high(H)” level and may be transmitted to the first MAC operator (MAC0) 320 through the first BIO line 391. In addition, the second data DA2 may be read out of the second memory bank (BK1) 312 by the MAC read signal MAC_RD_BK having a logic “high(H)” level and may be transmitted to the first MAC operator (MAC0) 320 through the second BIO line 392.

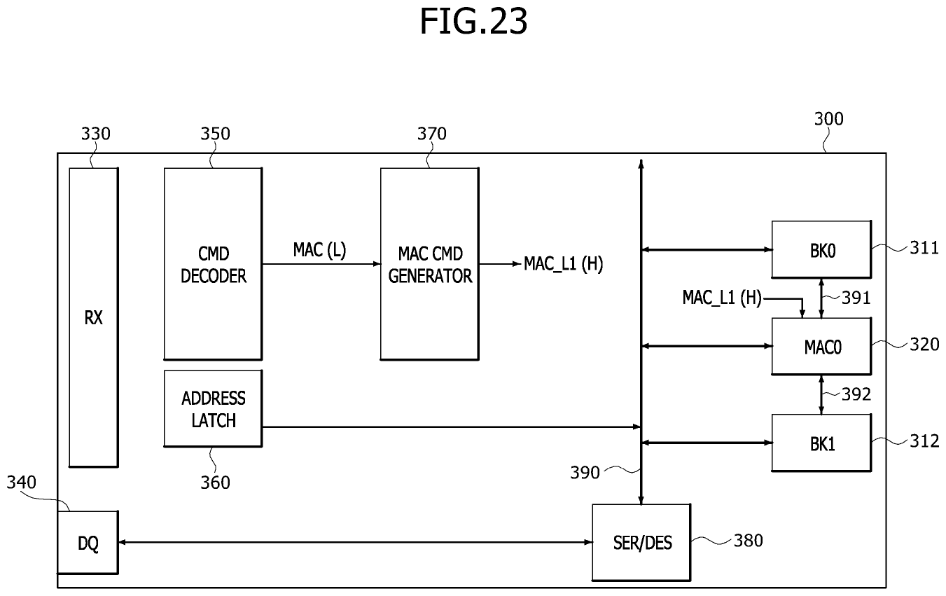

Next, referring to FIG. 23, a logic level of the MAC arithmetic signal MAC outputted from the command decoder 350 may change from a logic “high(H)” level into a logic “low(L)” level at a point in time when the first delay time DELAY_T1 determined by the first delay circuit (372 of FIG. 18) elapses from a point in time when the MAC read signal MAC_RD_BK is outputted from the MAC command generator 370. The MAC command generator 370 may generate and output the MAC input latch signal MAC_L1 having a logic “high(H)” level in response to the MAC arithmetic signal MAC having a logic “low(L)” level. The MAC input latch signal MAC_L1 having a logic “high(H)” level may be transmitted to the first MAC operator (MAC0) 320. The first MAC operator (MAC0) 320 may be synchronized with the MAC input latch signal MAC_L1 having a logic “high(H)” level to perform a latch operation of the first and second data DA1 and DA2 outputted from the first and second memory banks (BK0 and BK1) 311 and 312. If the latch operation of the first and second data DA1 and DA2 terminates, the first MAC operator (MAC0) 320 may perform the MAC arithmetic operation and may generate the MAC result data DA_MAC. The MAC result data DA_MAC generated by the first MAC operator (MAC0) 320 may be inputted to the output latch (223-1 of FIG. 20) included in the first MAC operator (MAC0) 320.

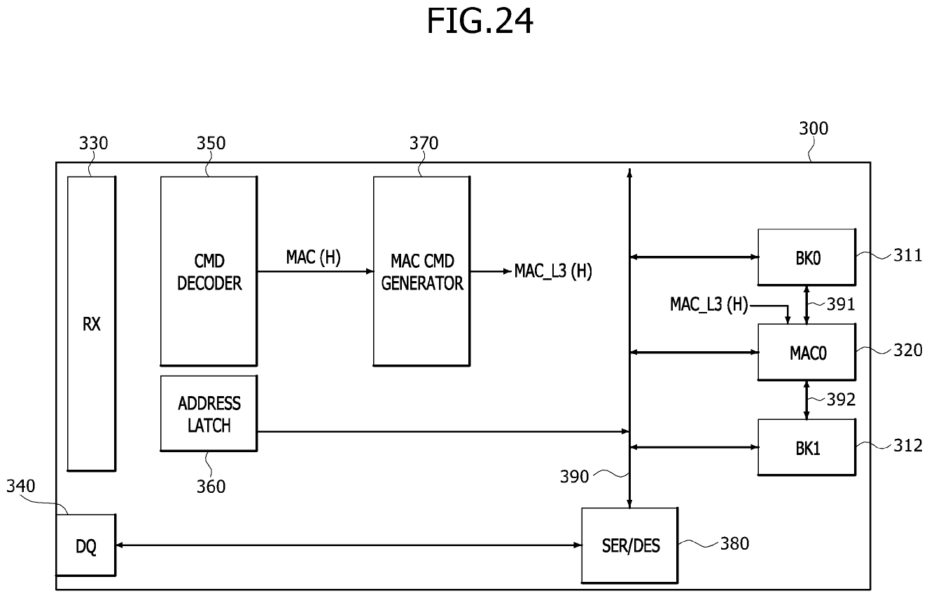

Next, referring to FIG. 24, a logic level of the MAC arithmetic signal MAC outputted from the command decoder 350 may change from a logic “low(L)” level into a logic “high(H)” level at a point in time when the second delay time DELAY_T2 determined by the second delay circuit (373 of FIG. 18) elapses from a point in time when the MAC input latch signal MAC_L1 having a logic “high(H)” level is outputted from the MAC command generator 370. The MAC command generator 370 may generate and output the MAC output latch signal MAC_L3 having a logic “high(H)” level in response to the MAC arithmetic signal MAC having a logic “high(H)” level. The MAC output latch signal MAC_L3 having a logic “high(H)” level may be transmitted to the first MAC operator (MAC0) 320. The output latch (223-1 of FIG. 20) included in the first MAC operator (MAC0) 320 may be synchronized with the MAC output latch signal MAC_L3 having a logic “high(H)” level to transfer the MAC result data DA_MAC generated by the MAC circuit (222 of FIG. 20) to the transfer gate (223-2 of FIG. 20) included in the first MAC operator (MAC0) 320. The MAC result data DA_MAC outputted from the output latch (223-1 of FIG. 20) may be fed back to the addition logic circuit (222-2 of FIG. 20) for the accumulative adding calculation executed by the MAC circuit (222 of FIG. 20).

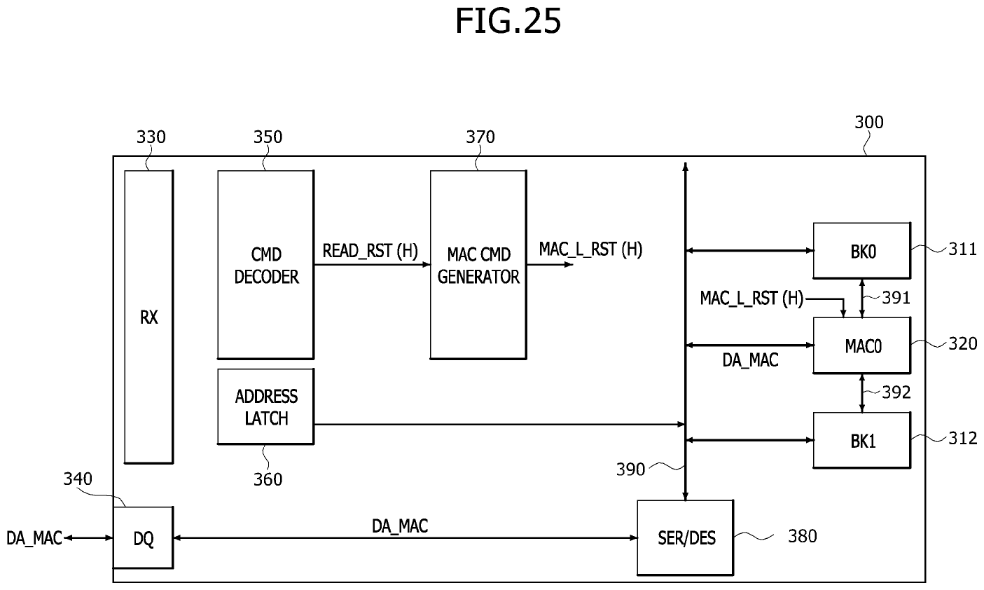

Next, referring to FIG. 25, the command decoder 350 may output and transmit the result read signal READ_RST having a logic “high(H)” level to the MAC command generator 370. The MAC command generator 370 may generate and output the MAC result latch signal MAC_L_RST having a logic “high” level in response to the result read signal READ_RST having a logic “high(H)” level. The MAC result latch signal MAC_L_RST having a logic “high” level may be transmitted to the first MAC operator (MAC0) 320. As described with reference to FIG. 20, the first MAC operator (MAC0) 320 may output the MAC result data DA_MAC to the GIO line 390 in response to the MAC result latch signal MAC_L_RST having a logic “high” level and may also reset the output latch (223-1 of FIG. 20) included in the first MAC operator (MAC0) 320 in response to the MAC result latch signal MAC_L_RST having a logic “high” level. The MAC result data DA_MAC transmitted to the GIO line 390 may be outputted to an external device through the serializer/deserializer 380 and the data I/O line 340. Although not shown in the drawings, the MAC result data DA_MAC outputted from the first MAC operator (MAC0) 320 may be written into the first memory bank (BK0) 311 through the first BIO line 391 without using the GIO line 390 or may be written into the second memory bank (BK1) 312 through the second BIO line 392 without using the GIO line 390.

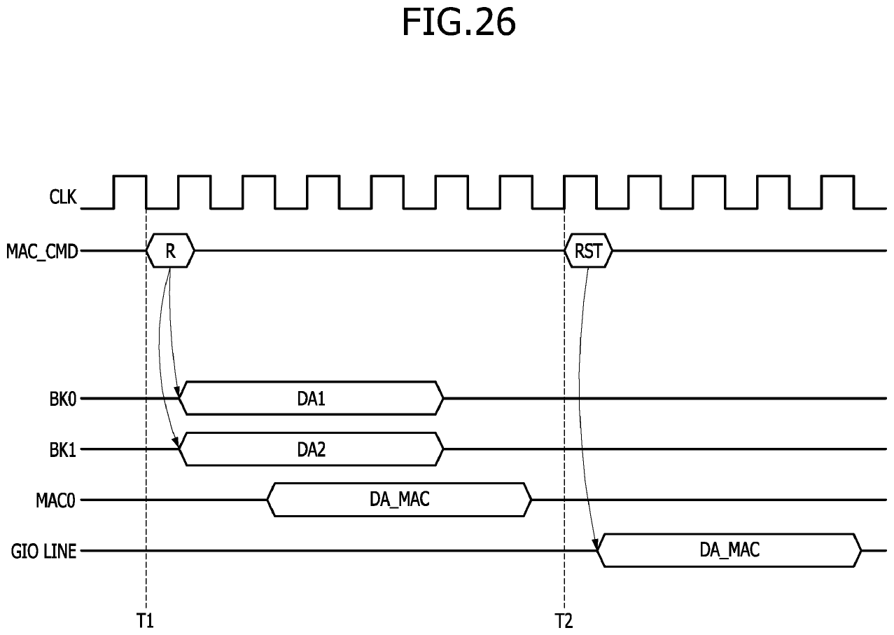

FIG. 26 is a timing diagram illustrating an operation of the PIM device 300 illustrated in FIG. 16. Referring to FIG. 26, at a first point in time “T1”, the MAC command generator 370 may be synchronized with a falling edge of a clock signal CLK to generate and output the MAC read signal MAC_RD_BK (R) having a logic “high(H)” level. The first and second memory banks (BK0 and BK1) 311 and 312 may be selected by the MAC read signal MAC_RD_BK (R) having a logic “high(H)” level so that the first data DA1 and the second data DA2 are read out of the first and second memory banks (BK0 and BK1) 311 and 312. If a certain time elapses from a point in time when first data DA1 and the second data DA2 are read out, the first MAC operator (MAC0) 320 may perform the MAC arithmetic operation of the first and second data DA1 and DA2 to generate the MAC result data DA_MAC. At a second point in time “T2”, the MAC command generator 370 may be synchronized with a falling edge of the clock signal CLK to generate and output the MAC result latch signal MAC_L_RST (RST) having a logic “high” level. The MAC result data DA_MAC may be transmitted to the GIO line 390 by the MAC result latch signal MAC_L_RST (RST) having a logic “high” level.

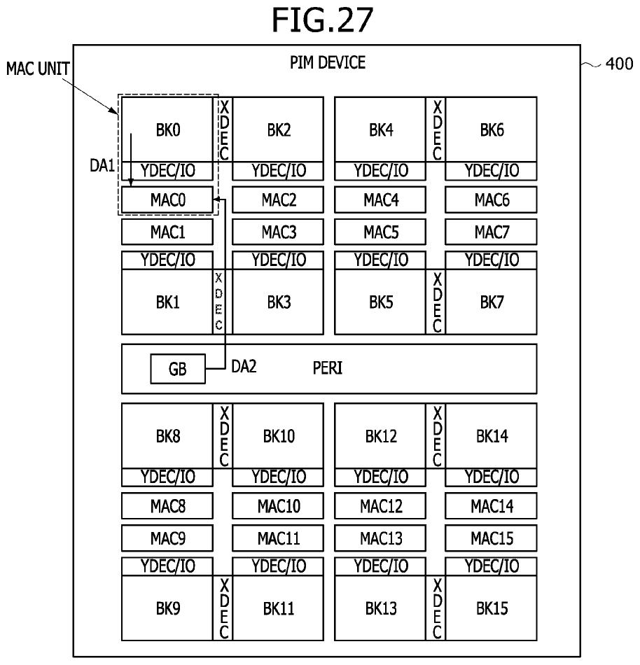

FIG. 27 illustrates a disposal structure indicating placement of memory banks and MAC operators included in a PIM device 400 according to another embodiment of the present disclosure. Referring to FIG. 27, the PIM device 400 may include memory devices such as a plurality of memory banks (e.g., first to sixteenth memory banks BK0, . . . , and BK15), processing devices such as a plurality of MAC operators (e.g., first to sixteenth MAC operators MAC0, . . . , and MAC15), and a global buffer GB. A core circuit may be disposed to be adjacent to the memory banks BK0, . . . , and BK15. The core circuit may include X-decoders XDECs and Y-decoders/IO circuits YDEC/IOs. The memory banks BK0, . . . , and BK15 and the core circuit may have the same configuration as described with reference to FIG. 2. Thus, descriptions of the memory banks BK0, . . . , and BK15 and the core circuit will be omitted hereinafter. The MAC operators MAC0, . . . , and MAC15 may be disposed to be allocated to the memory banks BK0, . . . , and BK15, respectively. That is, in the PIM device 400, two or more memory banks do not share one MAC operator with each other. Thus, the number of the MAC operators MAC0, . . . , and MAC15 included in the PIM device 400 may be equal to the number of the memory banks BK0, . . . , and BK15 included in the PIM device 400. One of the memory banks BK0, . . . , and BK15 together with one of the MAC operators MAC0, . . . , and MAC15 may constitute one MAC unit. For example, the first memory bank BK0 and the first MAC operator MAC0 may constitute a first MAC unit, and the second memory bank BK1 and the second MAC operator MAC1 may constitute a second MAC unit. Similarly, the sixteenth memory bank BK15 and the sixteenth MAC operator MAC15 may constitute a sixteenth MAC unit. In each of the first to sixteenth MAC units, the MAC operator may receive first data DA1 to be used for the MAC arithmetic operation from the respective memory bank.

The PIM device 400 may further include a peripheral circuit PERI. The peripheral circuit PERI may be disposed in a region other than an area in which the memory banks BK0, BK1, . . . , and BK15; the MAC operators MAC0, . . . , and MAC15; and the core circuit are disposed. The peripheral circuit PERI may be configured to include a control circuit relating to a command/address signal, a control circuit relating to input/output of data, and a power supply circuit. The peripheral circuit PERI of the PIM device 400 may have substantially the same configuration as the peripheral circuit PERI of the PIM device 100 illustrated in FIG. 2. A difference between the peripheral circuit PERI of the PIM device 400 and the peripheral circuit PERI of the PIM device 100 is that the global buffer GB is disposed in the peripheral circuit PERI of the PIM device 400. The global buffer GB may receive second data DA2 to be used for the MAC operation from an external device and may store the second data DA2. The global buffer GB may output the second data DA2 to each of the MAC operators MAC0, . . . , and MAC15 through a GIO line. In the event that the PIM device 400 performs neural network calculation, for example, an arithmetic operation in a deep learning process, the first data DA1 may be weight data and the second data DA2 may be vector data.

The PIM device 400 according to the present embodiment may operate in a memory mode or a MAC arithmetic mode. In the memory mode, the PIM device 400 may operate to perform the same operations as general memory devices. The memory mode may include a memory read operation mode and a memory write operation mode. In the memory read operation mode, the PIM device 400 may perform a read operation for reading out data from the memory banks BK0, BK1, . . . , and BK15 to output the read data, in response to an external request. In the memory write operation mode, the PIM device 400 may perform a write operation for storing data provided by an external device into the memory banks BK0, BK1, . . . , and BK15, in response to an external request. In the MAC arithmetic mode, the PIM device 400 may perform the MAC arithmetic operation using the MAC operators MAC0, . . . , and MAC15. In the PIM device 400, the MAC arithmetic operation may be performed in a deterministic way, and the deterministic MAC arithmetic operation of the PIM device 400 will be described more fully hereinafter. Specifically, the PIM device 400 may perform the read operation of the first data DA1 for each of the memory banks BK0, . . . , and BK15 and the read operation of the second data DA2 for the global buffer GB, for the MAC arithmetic operation in the MAC arithmetic mode. In addition, each of the MAC operators MAC0, . . . , and MAC15 may perform the MAC arithmetic operation of the first data DA1 and the second data DA2 to store a result of the MAC arithmetic operation into the memory bank or to output the result of the MAC arithmetic operation to an external device. In some cases, the PIM device 400 may perform a data write operation for storing data to be used for the MAC arithmetic operation into the memory banks before the data read operation for the MAC arithmetic operation is performed in the MAC arithmetic mode.

The operation mode of the PIM device 400 according to the present embodiment may be determined by a command which is transmitted from a host or a controller to the PIM device 400. In an embodiment, if a first external command requesting a read operation or a write operation for the memory banks BK0, BK1, . . . , and BK15 is transmitted from the host or the controller to the PIM device 400, the PIM device 400 may perform the data read operation or the data write operation in the memory mode. Alternatively, if a second external command requesting the MAC arithmetic operation is transmitted from the host or the controller to the PIM device 400, the PIM device 400 may perform the data read operation and the MAC arithmetic operation.

The PIM device 400 may perform the deterministic MAC arithmetic operation. Thus, the host or the controller may always predict a point in time (or a clock) when the MAC arithmetic operation terminates in the PIM device 400 from a point in time when an external command requesting the MAC arithmetic operation is transmitted from the host or the controller to the PIM device 400. Because the timing is predictable, no operation for informing the host or the controller of a status of the MAC arithmetic operation is required while the PIM device 400 performs the deterministic MAC arithmetic operation. In an embodiment, a latency during which the MAC arithmetic operation is performed in the PIM device 400 may be set to a fixed value for the deterministic MAC arithmetic operation.

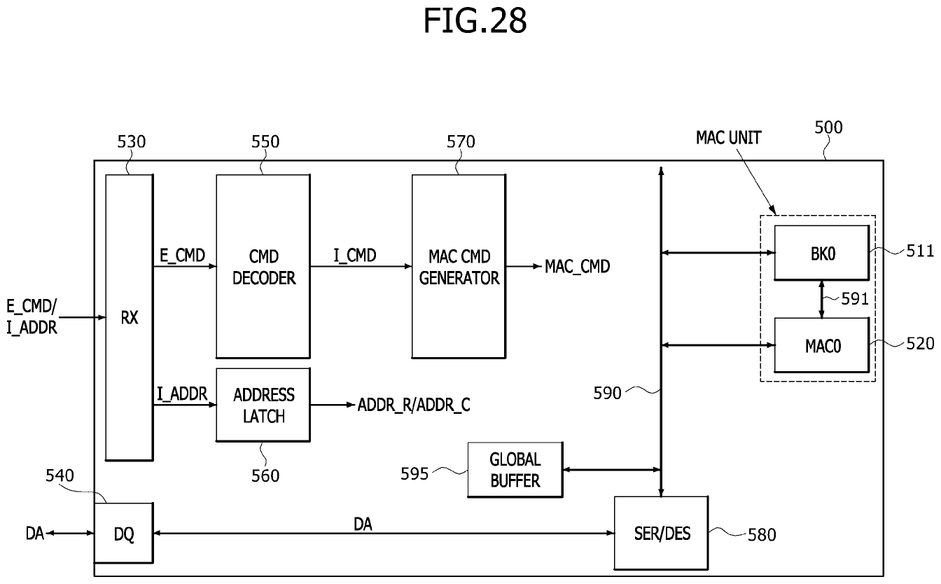

FIG. 28 is a block diagram illustrating an example of a detailed configuration of a PIM device 500 corresponding to the PIM device 400 illustrated in FIG. 27. FIG. 28 illustrates only a first memory bank (BK0) 511 and a first MAC operator (MAC0) 520 constituting a first MAC unit among a plurality of MAC units. However, FIG. 28 illustrates merely an example for simplification of the drawing. Accordingly, the following description for the first MAC unit may be equally applicable to the remaining MAC units. Referring to FIG. 28, the PIM device 500 may be configured to include the first memory bank (BK0) 511 and the first MAC operator (MAC0) 520 constituting the first MAC unit as well as a global buffer 595. The PIM device 500 may further include a GIO line 590 and a BIO line 591 used as data transmission lines. The first memory bank (BK0) 511 and the first MAC operator (MAC0) 520 may communicate with the global buffer 595 through the GIO line 590. Only the data transmission between the first memory bank (BK0) 511 and the first MAC operator (MAC0) 520 may be achieved through the BIO line 591. The BIO line 591 is dedicated specifically for data transmission between the first memory bank (BK0) 511 and the first MAC operator (MAC0) 520. Thus, the first MAC operator (MAC0) 520 may receive the first data DA1 to be used for the MAC arithmetic operation from the first memory bank (BK0) 511 through the BIO line 591 and may receive the second data DA2 to be used for the MAC arithmetic operation from the global buffer 595 through the GIO line 590.

The PIM device 500 may include a receiving driver (RX) 530, a data I/O circuit (DQ) 540, a command decoder 550, an address latch 560, a MAC command generator 570, and a serializer/deserializer (SER/DES) 580. The command decoder 550, the address latch 560, the MAC command generator 570, and the serializer/deserializer 580 may be disposed in the peripheral circuit PERI of the PIM device 400 illustrated in FIG. 27. The receiving driver 530 may receive an external command E_CMD and an input address I_ADDR from an external device. The external device may denote a host or a controller coupled to the PIM device 500. Hereinafter, it may be assumed that the external command E_CMD transmitted to the PIM device 500 is a command requesting the MAC arithmetic operation. That is, the PIM device 500 may perform the deterministic MAC arithmetic operation in response to the external command E_CMD. The data I/O circuit 540 may provide a means through which the PIM device 500 communicates with the external device.

The receiving driver 530 may separately output the external command E_CMD and the input address I_ADDR received from the external device. Data DA inputted to the PIM device 500 through the data I/O circuit 540 may be processed by the serializer/deserializer 580 and may be transmitted to the first memory bank (BK0) 511 and the global buffer 595 through the GIO line 590 of the PIM device 500. The data DA outputted from the first memory bank (BK0) 511 and the first MAC operator (MAC0) 520 through the GIO line 590 may be processed by the serializer/deserializer 580 and may be outputted to the external device through the data I/O circuit 540. The serializer/deserializer 580 may convert the data DA into parallel data if the data DA are serial data or may convert the data DA into serial data if the data DA are parallel data. For the data conversion, the serializer/deserializer 580 may include a serializer converting parallel data into serial data and a deserializer converting serial data into parallel data.

The command decoder 550 may decode the external command E_CMD outputted from the receiving driver 530 to generate and output the internal command signal I_CMD. The internal command signal I_CMD outputted from the command decoder 550 may be the same as the internal command signal I_CMD described with reference to FIG. 17. That is, the internal command signal I_CMD may include a first internal command signal corresponding to the memory active signal ACT_M, a second internal command signal corresponding to the MAC arithmetic signal MAC, and a third internal command signal corresponding to the result read signal READ_RST. The first to third internal command signals outputted from the command decoder 550 may be sequentially inputted to the MAC command generator 570. As described with reference to FIG. 17, the memory active signal ACT_M, the MAC arithmetic signal MAC, and the result read signal READ_RST outputted from the command decoder 550 may be sequentially generated at predetermined points in time (or clocks) in order to perform the deterministic MAC arithmetic operation of the PIM device 500. Thus, the host or the controller outputting the external command E_CMD may predict the points in time when the first to third internal command signals constituting the internal command signal I_CMD are generated by the command decoder 550 in advance at a point in time when the external command E_CMD is outputted from the host or the controller. That is, the host or the controller may predict a point in time (or a clock) when the MAC arithmetic operation terminates in the PIM device 500 after the external command E_CMD requesting the MAC arithmetic operation is transmitted from the host or the controller to the PIM device 500, even without receiving any signals from the PIM device 500.

The address latch 560 may convert the input address I_ADDR outputted from the receiving driver 530 into a row/column address ADDR_R/ADDR_C to output the row/column address ADDR_R/ADDR_C. The row/column address ADDR_R/ADDR_C outputted from the address latch 560 may be transmitted to the first memory bank (BK0) 511. According to the present embodiment, the first data and the second data to be used for the MAC arithmetic operation may be simultaneously read out of the first memory bank (BK0) 511 and the global buffer 595, respectively. Thus, it may be unnecessary to generate a bank selection signal for selecting the first memory bank 511. A point in time when the row/column address ADDR_R/ADDR_C is inputted to the first memory bank 511 may be a point in time when a MAC command (i.e., the MAC arithmetic signal MAC) requesting a data read operation for the first memory bank 511 for the MAC arithmetic operation is generated.

The MAC command generator 570 may output the MAC command signal MAC_CMD in response to the internal command signal I_CMD outputted from the command decoder 550. The MAC command signal MAC_CMD outputted from the MAC command generator 570 may be the same as the MAC command signal MAC_CMD described with reference to FIG. 17. That is, the MAC command signal MAC_CMD outputted from the MAC command generator 570 may include the MAC active signal RACTV corresponding to the first MAC command signal, the MAC read signal MAC_RD_BK corresponding to the second MAC command signal, the MAC input latch signal MAC_L1 corresponding to the third MAC command signal, the MAC output latch signal MAC_L3 corresponding to the fourth MAC command signal, and the MAC result latch signal MAC_L_RST corresponding to the fifth MAC command signal.

The MAC active signal RACTV may be generated based on the memory active signal ACT_M outputted from the command decoder 550. The MAC read signal MAC_RD_BK, the MAC input latch signal MAC_L1, the MAC output latch signal MAC_L3, and the MAC result latch signal MAC_L_RST may be sequentially generated based on the MAC arithmetic signal MAC outputted from the command decoder 550. That is, the MAC input latch signal MAC_L1 may be generated at a point in time when a certain time elapses from a point in time when the MAC read signal MAC_RD_BK is generated. The MAC output latch signal MAC_L3 may be generated at a point in time when a certain time elapses from a point in time when the MAC input latch signal MAC_L1 is generated. Finally, the MAC result latch signal MAC_L_RST may be generated based on the result read signal READ_RST outputted from the command decoder 550.

The MAC active signal RACTV outputted from the MAC command generator 570 may control an activation operation for the first memory bank 511. The MAC read signal MAC_RD_BK outputted from the MAC command generator 570 may control a data read operation for the first memory bank 511 and the global buffer 595. The MAC input latch signal MAC_L1 outputted from the MAC command generator 570 may control an input data latch operation of the first MAC operator (MAC0) 520. The MAC output latch signal MAC_L3 outputted from the MAC command generator 570 may control an output data latch operation of the first MAC operator (MAC0) 520. The MAC result latch signal MAC_L_RST outputted from the MAC command generator 570 may control an output operation of MAC result data of the first MAC operator (MAC0) 520 and a reset operation of the first MAC operator (MAC0) 520.

As described above, in order to perform the deterministic MAC arithmetic operation of the PIM device 500, the memory active signal ACT_M, the MAC arithmetic signal MAC, and the result read signal READ_RST outputted from the command decoder 550 may be sequentially generated at predetermined points in time (or clocks), respectively. Thus, the MAC active signal RACTV, the MAC read signal MAC_RD_BK, the MAC input latch signal MAC_L1, the MAC output latch signal MAC_L3, and the MAC result latch signal MAC_L_RST may also be generated and outputted from the MAC command generator 570 at predetermined points in time after the external command E_CMD is inputted to the PIM device 500, respectively. That is, a time period from a point in time when the first and second memory banks 511 is activated by the MAC active signal RACTV until a point in time when the first MAC operator (MAC0) 520 is reset by the MAC result latch signal MAC_L_RST may be predetermined.

The MAC command generator 570 of the PIM device 500 according to the present embodiment may have the same configuration as described with reference to FIG. 18. In addition, the input signals and the output signals of the MAC command generator 570 may be inputted to and outputted from the MAC command generator 570 at the same points in time as described with reference to FIG. 19. As described with reference to FIGS. 18 and 19, the MAC command generator 570 may sequentially receive the memory active signal ACT_M, the MAC arithmetic signal MAC, and the result read signal READ_RST from the command decoder 550. In addition, the MAC command generator 570 may sequentially generate and output the MAC active signal RACTV, the MAC read signal MAC_RD_BK, the MAC input latch signal MAC_L1, the MAC output latch signal MAC_L3, and the MAC result latch signal MAC_L_RST. The MAC active signal RACTV, the MAC read signal MAC_RD_BK, the MAC input latch signal MAC_L1, the MAC output latch signal MAC_L3, and the MAC result latch signal MAC_L_RST may be outputted from the MAC command generator 570 in series with certain time intervals.

The MAC command generator 570 may generate and output the MAC active signal RACTV in response to the memory active signal ACT_M outputted from the command decoder 550. Subsequently, the MAC command generator 570 may generate and output the MAC read signal MAC_RD_BK in response to the MAC arithmetic signal MAC outputted from the command decoder 550. The MAC command generator 570 may delay the MAC arithmetic signal MAC by a certain time determined by the first delay circuit (372 of FIG. 18) to generate and output the MAC input latch signal MAC_L1. The MAC command generator 570 may delay the MAC input latch signal MAC_L1 by a certain time determined by the second delay circuit (373 of FIG. 18) to generate and output the MAC output latch signal MAC_L3. Subsequently, the MAC command generator 570 may generate and output the MAC result latch signal MAC_L_RST in response to the result read signal READ_RST outputted from the command decoder 550.

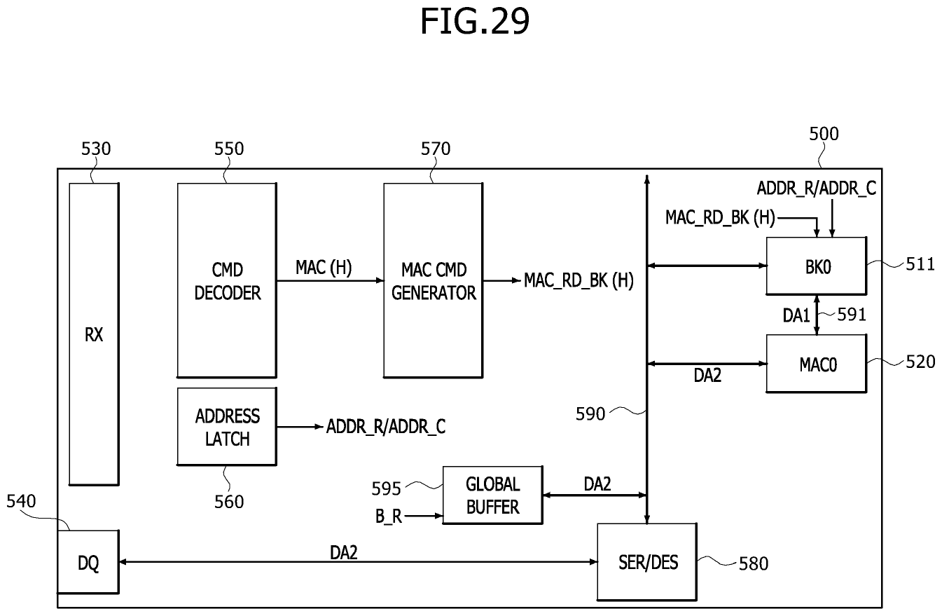

FIG. 29 is a block diagram illustrating an operation of the PIM device 500 illustrated in FIG. 28. In FIG. 29, the same reference numerals or the same reference symbols as used in FIG. 16 denote the same elements. The operation of the PIM device 500 according to the present embodiment may be similar to the operation of the PIM device 300 described with reference to FIG. 16 except a transmission process of the first and second data DA1 and DA2 inputted to the first MAC operator (MAC0) 520. Thus, the operation of the PIM device 500 executed before the first and second data DA1 and DA2 are transmitted to the first MAC operator (MAC0) 520 may be the same as the operation of the PIM device 300 described with reference to FIG. 21. As illustrated in FIG. 29, when the MAC arithmetic signal MAC having a logic “high(H)” level is transmitted from the command decoder 550 to the MAC command generator 570, the MAC command generator 570 may generate and output the MAC read signal MAC_RD_BK having a logic “high(H)” level. The MAC read signal MAC_RD_BK having a logic “high(H)” level, together with the row/column address ADDR_R/ADDR_C, may be transmitted to the first memory bank (BK0) 511. In such a case, a global buffer read signal B_R may also be transmitted to the global buffer 595. The first data DA1 may be read out of the first memory bank (BK0) 511 by the MAC read signal MAC_RD_BK having a logic “high(H)” level and may be transmitted to the first MAC operator (MAC0) 520 through the BIO line 591. In addition, the second data DA2 may be read out of the global buffer 595 by the global buffer read signal B_R and may be transmitted to the first MAC operator (MAC0) 520 through the GIO line 590. The operation of the PIM device 500 executed after the first and second data DA1 and DA2 are transmitted to the first MAC operator (MAC0) 520 may be the same as the operation of the PIM device 300 described with reference to FIGS. 23 to 25.

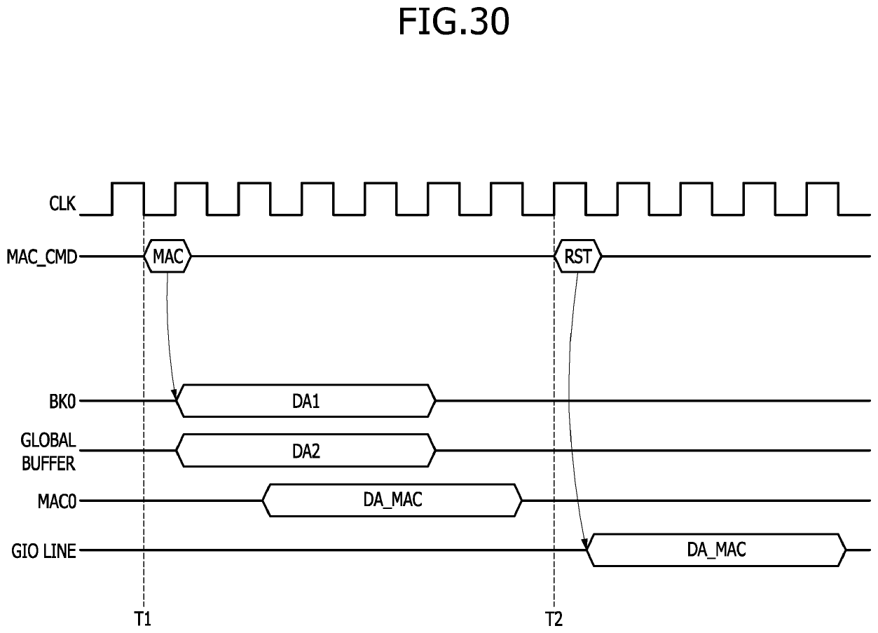

FIG. 30 is a timing diagram illustrating an operation of the PIM device 500 illustrate in FIG. 28. Referring to FIG. 30, at a first point in time “T1”, the MAC command generator 570 may be synchronized with a falling edge of a clock signal CLK to generate and output the MAC read signal MAC_RD_BK (R) having a logic “high(H)” level. The first memory bank (BK0) 511 may be selected by the MAC read signal MAC_RD_BK (R) having a logic “high(H)” level so that the first data DA1 are read out of the first memory bank (BK0) 511. In addition, the second data DA2 may be read out of the global buffer 595. If a certain time elapses from a point in time when the first and second data DA1 and DA2 are read out of the first memory bank (BK0) 511 and the global buffer 595, the first MAC operator (MAC0) 520 may perform the MAC arithmetic operation of the first and second data DA1 and DA2 to generate the MAC result data DA_MAC. At a second point in time “T2”, the MAC command generator 570 may be synchronized with a falling edge of the clock signal CLK to generate and output the MAC result latch signal MAC_L_RST (RST). The MAC result data DA_MAC may be transmitted to an external device through the GIO line 590 or to the first memory bank (BK0) 511 through the BIO line 591, by the MAC result latch signal MAC_L_RST (RST).

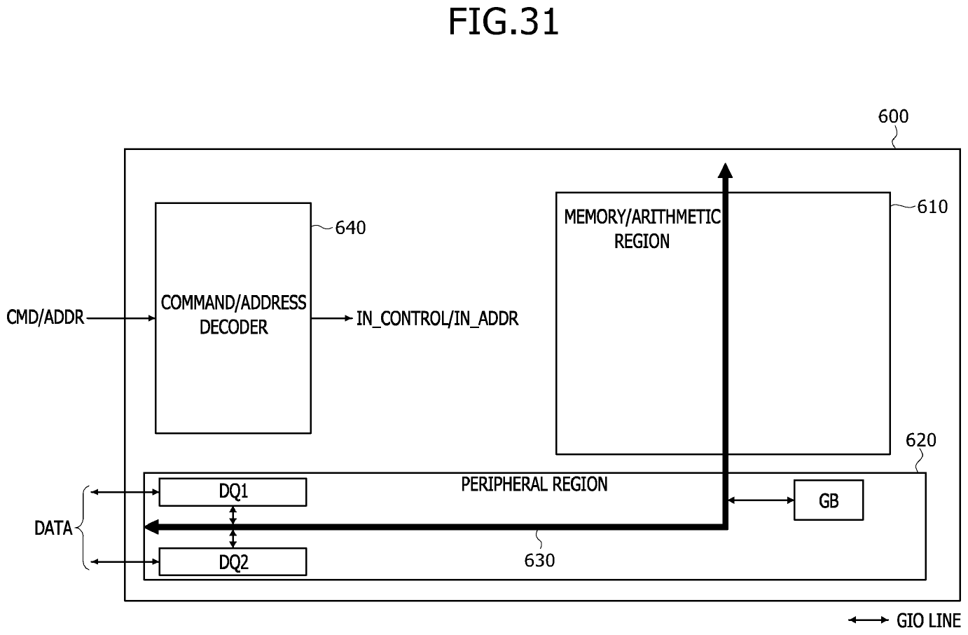

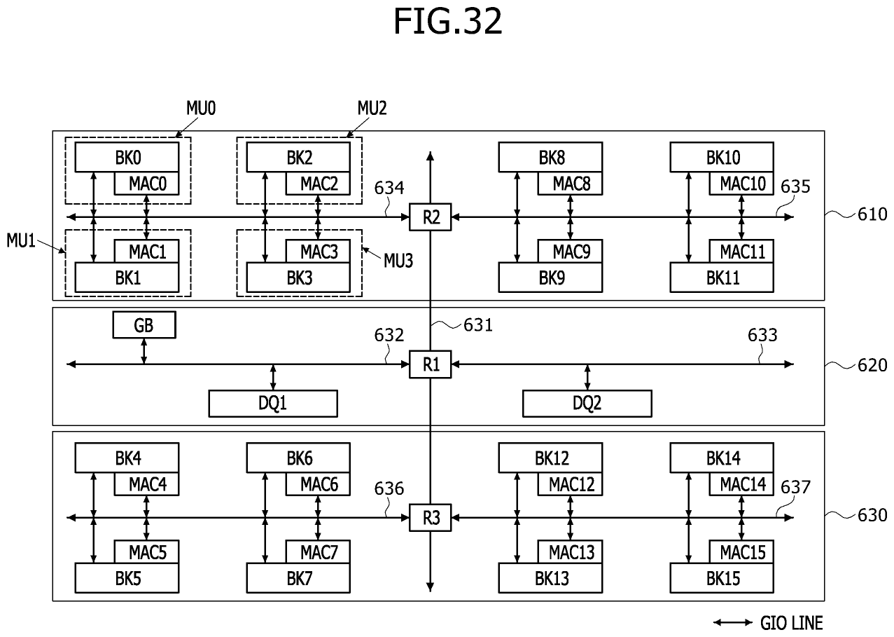

FIG. 31 is a block diagram illustrating a PIM device 600 according to an embodiment of the present disclosure. Referring to FIG. 31, the PIM device 600 may include a memory/arithmetic regions 610 and 630, a peripheral region 620, a GIO line 630, and a command/address decoder 640. Although the command/address decoder 640 is disposed independently from the peripheral region 620 in this embodiment, this is only for simplification of drawings and descriptions, and the command/address decoder 640 may be disposed in the peripheral region 620. Although not shown in FIG. 31, the memory/arithmetic regions 610 and 630 may include a plurality of memory banks and a plurality of MAC operators. The peripheral region 620 may include a global buffer GB, a first data input/output (I/O) circuit DQ1, and a second data I/O circuit DQ2. In this embodiment, the first data I/O circuit DQ1 and the second data I/O circuit DQ2 are included for convenience. However, the number of data I/O circuits may vary. For example, only one data I/O circuit may be disposed. The memory/arithmetic regions 610 and 630 and the peripheral region 620 will be described in more detail below with reference to FIG. 32.

The GIO line 630 may provide data transmission paths in the PIM device 600. In this embodiment, the GIO line 630 may be commonly used for data DATA (e.g., read data) transmission from the memory/arithmetic regions 610 and 630 to the peripheral region 620 and data DATA (e.g., write data) transmission from the peripheral region 620 to the memory/arithmetic regions 610 and 630. The command/address decoder 640 may receive a command CMD and an address ADDR from a host or a controller. The command/address decoder 640 may decode the command CMD and the address ADDR to output an internal control signal IN_CONTROL and an internal address signal IN_ADDR. The memory/arithmetic regions 610 and 630 and the peripheral region 620 may perform various operations, such as a memory read operation, a memory write operation, a MAC arithmetic operation, an element-wise multiplication (hereinafter, referred to as “EWM”) operation, and the like, according to the internal control signal IN_CONTROL and the internal address signal IN_ADDR that are output from the command/address decoder 640.

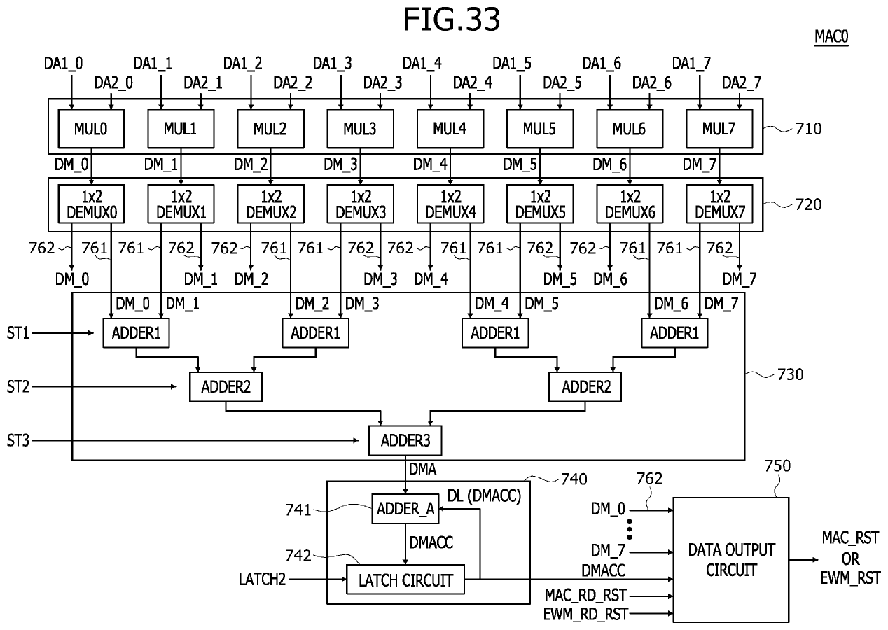

FIG. 32 is a diagram illustrating examples of configurations of the memory/arithmetic regions 610 and 630 and the peripheral region 620 of the PIM device 600 of FIG. 31. FIG. 33 is a block diagram illustrating an example of a configuration of the first MAC operator MAC0 of FIG. 32. First, referring to FIG. 32, the PIM device 600 may include the memory/arithmetic regions 610 and 630 and the peripheral region 620. Each of the memory/arithmetic regions 610 and 630 may include a plurality of memory banks BKs and a plurality of MAC operators MACs. The peripheral region 620 may include a global buffer GB, the first data I/O circuit DQ1, and the second data I/O circuit DQ2. In this example, it is assumed that the plurality of memory banks BKs include 16 memory banks, for example, first to sixteenth memory banks BK0-BK15. In addition, it is assumed that the plurality of MAC operators MACs include 16 MAC operators, for example, the first to sixteenth MAC operators MAC0-MAC15.

The first to sixteenth MAC operators MAC0-MAC15 may be allocated to the first to sixteenth memory banks BK0-BK15, respectively. For example, the first MAC operator MAC0 may be allocated to the first memory bank BK0. The second MAC operator MAC1 may be allocated to the second memory bank BK1. Similarly, the sixteenth MAC operator MAC15 may be allocated to the sixteenth memory bank BK15. Each of the first to sixteenth MAC operators MAC0-MAC15 may constitute a MAC unit together with the memory bank BK to which the MAC operator is allocated. For example, as illustrated in the drawing, the first memory bank BK0 and the first MAC operator MAC0 may constitute the first MAC unit MU0. The second memory bank BK1 and the second MAC operator MAC1 may constitute the second MAC unit MU1. The third memory bank BK2 and the third MAC operator MAC2 may constitute the third MAC unit MU2. The fourth memory bank BK3 and the fourth MAC operator MAC3 may constitute the fourth MAC unit MU3. Although omitted from the drawing, the remaining fifth to sixteenth MAC units may be configured in the same manner.

As shown in FIG. 33, the first MAC operator MAC0 may include a multiplication circuit 710, a data output selection circuit 720, an adder tree 730, an accumulator 740, and a data output circuit 750. The description of the first MAC operator MAC0 below may be equally applied to the second to sixteenth MAC operators MAC1-MAC15 of FIG. 32. Specifically, the multiplication circuit 710 may be configured by arranging a plurality of, for example, 8 multipliers, that is, the first to eighth multipliers MUL0-MUL7 in parallel with each other. Here, the parallel arrangement may mean an arrangement structure in which a data input/output operation and an arithmetic operation are performed simultaneously and independently and may be equally applied below. Each of the multipliers MUL0-MUL7 may receive one of first input data DA1_0-DA1_7 and one of second input data DA2_0-DA2_7. The multipliers MUL0-MUL7 may perform multiplication operations on the first input data DA1_0-DA1_7 and the second input data DA2_0-DA2_7 and may output multiplication data DM_0-DM_7, respectively. For example, the first multiplier MUL0 may perform a multiplication operation on the first input data DA1_0 and the second input data DA2_0 to generate and output first multiplication data DM_0. In the same manner, the eighth multiplier MUL7 may perform a multiplication operation on the first input data DA1_7 and the second input data DA2_7 to generate and output eighth multiplication data DM_7.

The data output selection circuit 720 may output the first to eighth multiplication data DM_0-DM_7 that are output from the multiplication circuit 710, through 8 first output lines 761 or 8 second output lines 762. The data output selection circuit 720 may be configured by arranging a plurality of 1:2 demultiplexers DEMUX0-DEMUX7 that are in parallel with each other. Each of the 1:2 demultiplexers DEMUX0-DEMUX7 may have one input terminal and two output terminals. The number of 1:2 demultiplexers DEMUX0-DEMUX7, constituting the data output selection circuit 720, may be the same as the number of multipliers MUL0-MUL7. The input terminals of the 1:2 demultiplexers DEMUX0-DEMUX7 may be respectively coupled to output terminals of the multipliers MUL0-MUL7. For example, the input terminal of the first 1:2 demultiplexer DEMUX0 may be coupled to the output terminal of the first multiplier MUL0. The input terminal of the second 1:2 demultiplexer DEMUX1 may be coupled to the output terminal of the second multiplier MUL1. In the same manner, the input terminal of the eighth 1:2 demultiplexer DEMUX7 may be coupled to the output terminal of the eighth multiplier MUL7. An output line, through which data is output from each of the 1:2 demultiplexers DEMUX0-DEMUX7, may be selected by a flag signal FLAG that is transmitted to the data output selection circuit 720. For example, when a flag signal FLAG at a logic “low” level is transmitted to the data output selection circuit 720, the 1:2 demultiplexers DEMUX0-DEMUX7 may output the multiplication data DM_0-DM_7 that is output from the multipliers MUL0-MUL7 through the first output lines 761. On the other hand, when a flag signal FLAG at a logic “high” level is transmitted to the data selection circuit 720, the 1:2 demultiplexers DEMUX0-DEMUX7 may output the multiplication data DM_0-DM_7 that are output from the multipliers MUL0-MUL7 through the second output lines 762. The first output lines 761 of the 1:2 demultiplexers DEMUX0-DEMUX7 may be coupled to the adder tree 730. Accordingly, the data that is output from the 1:2 demultiplexers DEMUX0-DEMUX7 through the first output lines 761 may be transmitted to the adder tree 730. The second output lines 762 of the 1:2 demultiplexers DEMUX0-DEMUX7 may be coupled to the data output circuit 750. In another example, the second output lines 762 of the 1:2 demultiplexers DEMUX0-DEMUX7 may be directly coupled to the GIO line, particularly, to the fourth GIO line (634 in FIG. 32).

The adder tree 730 may include a plurality of adders ADDER1, ADDR2, and ADDR3 that are arranged in a hierarchical structure, such as a tree structure. In this example, each of the plurality of adders ADDER1, ADDR2, and ADDR3, constituting the adder tree 730, may be configured as a half-adder. However, this is only an example, and each of the plurality of adders ADDER1, ADDR2, and ADDR3 may be configured as a full-adder. In an uppermost stage of the adder tree 730, that is, in the first stage ST1, 4 first adders ADDER1 may be arranged in parallel with each other. In the second stage ST2 that is disposed below the first stage ST1 in the adder tree 730, 2 second adders ADDER2 may be disposed in parallel with each other. In the lowest stage, that is, in the third stage ST3 that is disposed below the second stage ST2 in the adder tree 730, one third adder ADDER3 may be disposed. When each of the plurality of adders ADDER1, ADDR2, and ADDR3 is configured as a half-adder, the number of first adders ADDR1 may be half the number of multipliers MUL0-MUL7. The number of second adders ADDR2 may be half the number of first adders ADDR1. Similarly, the number of third adders ADDR3 may be half the number of second adders ADDER2.

The first and second input terminals of each of the first adders ADDER1 of the first stage ST1 may be coupled to the first output lines 761 of two demultiplexers, among the demultiplexers DEMUX0-DEMUX7 that constitute the data output selection circuit 720. Accordingly, each of the first adders ADDER1 may perform an addition operation on the output data DMs of the two multipliers MULs that are transmitted through the data output selection circuit 720 and may output result data. Each of the second adders ADDER2 of the second stage ST2 may perform an addition operation on the output data of the two first adders ADDER1 of the first stage ST1 and may output result data. The third adder ADDER3 of the third stage ST3 may perform an addition operation on the output data of the two second adders ADDER2 of the second stage ST2 and may output result data DMA.

The accumulator 740 may include an accumulative adder ADDER_A 741 and a latch circuit 742. The accumulative adder ADDER_A 741 may perform an accumulative addition operation on the multiplication addition data DMA that is transmitted from the third adder ADDER3 of the lowest stage of the adder tree 730, that is, the third stage ST3, based on latch data DL that is transmitted from the latch circuit 742 to output accumulation data DMACC. In an example, the accumulative adder ADDER_A 741 may be configured as a half-adder. The latch circuit 742 may receive the accumulation data DMACC that is output from the accumulative adder ADDER_A 741. The latch circuit 742 may latch the accumulation data DMACC. The latch circuit 742 may transmit the accumulation data DMACC to the data output circuit 750 in response to a latch signal LATCH2 and may feed back the accumulation data DMACC as the latch data DL to the accumulative adder ADDER_A 741. In an example, the latch circuit 742 may include a flip-flop.

The data output circuit 750 may receive the multiplication data DM_0-DM_7 through the second output lines 762 of the demultiplexers DEMUX0-DEMUX7. The data output circuit 750 may receive the accumulation data DMACC from the latch circuit 742. The data output circuit 750 may output the accumulation data DMACC as MAC result data MAC_RST in response to, for example, a MAC output control signal MAC_RD_RST at a logic “high” level. The data output circuit 750 may output the multiplication data DM_0-DM_7 as EWM result data EWM_RST in response to, for example, an EWM output control signal EWM_RD_RST at a logic “high” level. An output terminal of the data output circuit 750 may be coupled to the GIO line, particularly, to the fourth GIO line (634 of FIG. 32).

The first MAC operator MAC0 may perform both the MAC arithmetic operation and the EWM operation. When the first MAC operator MAC0 performs the MAC arithmetic operation, a flag signal FLAG at a logic “low” level may be transmitted to the data output selection circuit 720. Accordingly, the 1:2 demultiplexers DEMUX0-DEMUX7 of the data output selection circuit 720 may transmit the multiplication data DM_0-DM_7 to the adder tree 730 through the first output lines 761. The adder tree 730 may perform an addition operation on the multiplication data DM_0-DM_7 to generate the multiplication addition data DMA and may transmit the multiplication addition data DMA to the accumulator 740. The accumulator 740 may perform an accumulation operation on the multiplication addition data DMA to generate the accumulation data DMACC and may transmit the accumulation data DMACC to the data output circuit 750. The data output circuit 750 may output the accumulation data DMACC from the first MAC operator MAC0 as the MAC result data MAC_RST.

When the first MAC operator MAC0 performs the EWM operation, a flag signal FLAG at a logic “high” level may be transmitted to the data output selection circuit 720. Accordingly, the 1:2 demultiplexers DEMUX0-DEMUX7, constituting the data output selection circuit 720, may transmit the multiplication data DM_0-DM_7 to the data output circuit 750 through the second output lines 762. That is, when the first MAC operator MAC0 performs the EWM operation, the multiplication data DM_0-DM_7 might not be transmitted from the 1:2 demultiplexers DEMUX0-DEMUX7 to the adder tree 730. The data output circuit 750 may output the multiplication data DM_0-DM_7 from the first MAC operator MAC0 as EWM result data EWM_RST.

Referring back to FIG. 32, when the PIM device 600 performs the MAC arithmetic operation, weight data may be transmitted from the memory banks to the MAC operators within the MAC units. For example, the first MAC operator MAC0 of the first MAC unit MU0 may receive first weight data from the first memory bank BK0. The second MAC operator MAC1 of the second MAC unit MU1 may receive second weight data from the second memory bank BK1. The third MAC operator MAC2 of the third MAC unit MU2 may receive third weight data from the third memory bank BK2. The fourth MAC operator MAC3 of the fourth MAC unit MU3 may receive fourth weight data from the fourth memory bank BK3. The transmission of fifth to sixteenth weight data to the remaining fifth to sixteenth MAC operators MAC4-MAC15 may be performed in the same manner. Here, each of the first to sixteenth weight data may be composed of elements from a weight matrix that is used for matrix-vector multiplication.

Meanwhile, the first to sixteenth MAC operators MAC0-MAC15 may share the global buffer GB in the peripheral region 620. Accordingly, when the PIM device 600 performs the MAC arithmetic operation, the first to sixteenth MAC operators MAC0-MAC15 may commonly receive vector data from the global buffer GB. That is, in the process of performing the MAC arithmetic operation, the first to sixteenth MAC operators MAC0-MAC15 may receive the same vector data from the global buffer GB. Here, the vector data may be composed of elements from a vector matrix that is used for matrix-vector multiplication.

When the PIM device 600 performs the EWM operation, one MAC operator may receive the first input data and the second input data from two adjacent memory banks BKs and may provide EWM result data that is generated through the EWM operation to an adjacent memory bank BK. For example, the first MAC operator MAC0 may receive the first input data and the second input data from the first memory bank BK0 and the second memory bank BK1, respectively, to perform the EWM operation. In addition, the first MAC operator MAC0 may provide EWM result data that is generated as a result of the EWM operation to the third memory bank BK2 (or the fourth memory bank BK3). Here, the first input data and the second input data may be composed of elements from the first vector matrix and the second vector matrix having the same row dimension and the same column dimension.

The data transmission in the PIM device 600 may be performed through the GIO line (630 in FIG. 31). The GIO line 630 may include first to seventh GIO lines 631-637. The first GIO line 631 may be disposed to pass through the peripheral region 620 and to extend to the memory/arithmetic regions 610 and 630. The first GIO line 631 may provide a data transmission path between the memory/arithmetic regions 610 and 630 and the peripheral region 620. At least one or more repeater may be disposed on the first GIO line 631 that adjust the timing of data transmission by buffering the data. In this example, a case in which three repeaters, that is, the first repeater R1, the second repeater R2, and the third repeater R3 are disposed on the first GIO line 631 will be taken as an example. Although omitted from the drawing, each of the first repeater R1, the second repeater R2, and the third repeater R3 may include a read repeater that buffers read data during a read operation and a write repeater that buffers write data during a write operation. In an example, each of the read repeater and the write repeater may include an inverter. The first repeater R1 may be disposed in the peripheral region 620 while the second and third repeaters R2 and R3 may be disposed in the memory/arithmetic regions 610 and 630.

The second GIO line 632 may provide a data transmission path, in both directions, between the first repeater R1, the first data I/O circuit DQ1, and the global buffer GB in the peripheral region 620. The third GIO line 633 may provide a data transmission path, in both directions, between the first repeater R1 and the second data I/O circuit DQ2 in the peripheral region 620. The fourth GIO line 634 may provide a data transmission path, in both directions, between the second repeater R2, the first to fourth memory banks BK0-BK3, and the first to fourth MAC operators MAC0-MAC3 in the memory/arithmetic region 610. The fifth GIO line 635 may provide a data transmission path, in both directions, between the second repeater R2, the ninth to twelfth memory banks BK8-BK11, and the ninth to twelfth MAC operators MAC8-MAC11 in the memory/arithmetic region 610. The sixth GIO line 636 may provide a data transmission path, in both directions, between the third repeater R3 and the fifth to eighth memory banks BK4-BK7 and the fifth to eighth MAC operators MAC4-MAC7 in the memory/arithmetic region 630. The seventh GIO line 637 may provide a data transmission path, in both directions, between the third repeater R3 and the thirteenth to sixteenth memory banks BK12-BK15 and the thirteenth to sixteenth MAC operators MAC12-MAC15 in the memory/arithmetic region 630.

The first repeater R1 may buffer the data that is transmitted from the first GIO line 631 to the second GIO line 632 and the third GIO line 633 or may buffer the data that is transmitted from the second GIO line 632 and the third GIO line 633 to the first GIO line 631. The second repeater R2 may buffer the data that is transmitted from the first GIO line 631 to the fourth GIO line 634 and the fifth GIO line 635 or may buffer the data that is transmitted from the fourth GIO line 634 and the fifth GIO line 635 to the first GIO line 631. The third repeater R3 may buffer the data that is transmitted that are from the first GIO line 631 to the sixth GIO line 636 and the seventh GIO line 637 or may buffer the data that is transmitted from the sixth GIO line 636 and the seventh GIO line 637 to the first GIO line 631.

More specifically, the first repeater R1 may buffer the data (e.g., vector data, write data) that is transmitted from the global buffer GB or the first data I/O circuit DQ1 through the second GIO line 632 to transmit the data to the first GIO line 631 in the peripheral region 620. In addition, the first repeater R1 may buffer the data (e.g., write data) that is transmitted from the second data I/O circuit DQ2 through the third GIO line 622 to transmit the data to the first GIO line 631 in the peripheral region 620. In addition, the first repeater R1 may buffer the data (e.g., read data, MAC result data) that is transmitted from the memory/arithmetic regions 610 and 630 through the first GIO line 631 to transmit the data to the second GIO line 632 and the third GIO line 633.

The second repeater R2 may buffer the data (e.g., vector data, write data) that is transmitted from the first repeater R1 through the first GIO line 631 to transmit the data to the fourth GIO line 634 and the fifth GIO line 635. In addition, the second repeater R2 may buffer the data (e.g., read data, MAC result data) that are transmitted from the first to fourth memory banks BK0-BK3 and the first to fourth MAC operators MAC0-MAC3 of the memory/arithmetic region 610 through the fourth GIO line 634 to transmit the data to the first GIO line 631. In addition, the second repeater R2 may buffer the data (e.g., read data, MAC result data) that are transmitted from the ninth to twelfth memory banks BK8-BK11 and the ninth to twelfth MAC operators MAC8-MAC11 of the memory/arithmetic region 610 through the fifth GIO line 635 to transmit the data to the first GIO line 631.

The third repeater R3 may buffer the data (e.g., vector data, write data) that is transmitted from the first repeater R1 through the first GIO line 631 to transmit the data to the sixth GIO line 636 and the seventh GIO line 637. In addition, the third repeater R3 may buffer the data (e.g., read data, MAC result data) that are transmitted from the fifth to eighth memory banks BK4-BK7 and the fifth to eighth MAC operators MAC4-MAC7 of the memory/arithmetic region 630 through the sixth GIO line 636 to transmit the data to the first GIO line 631. In addition, the third repeater R3 may buffer the data (e.g., read data, MAC result data) that are transmitted from the thirteenth to sixteenth memory banks BK12-BK15 and the thirteenth to sixteenth MAC operators MAC12-MAC15 of the memory/arithmetic region 630 through the seventh GIO line 637 to transmit the data to the first GIO line 631.

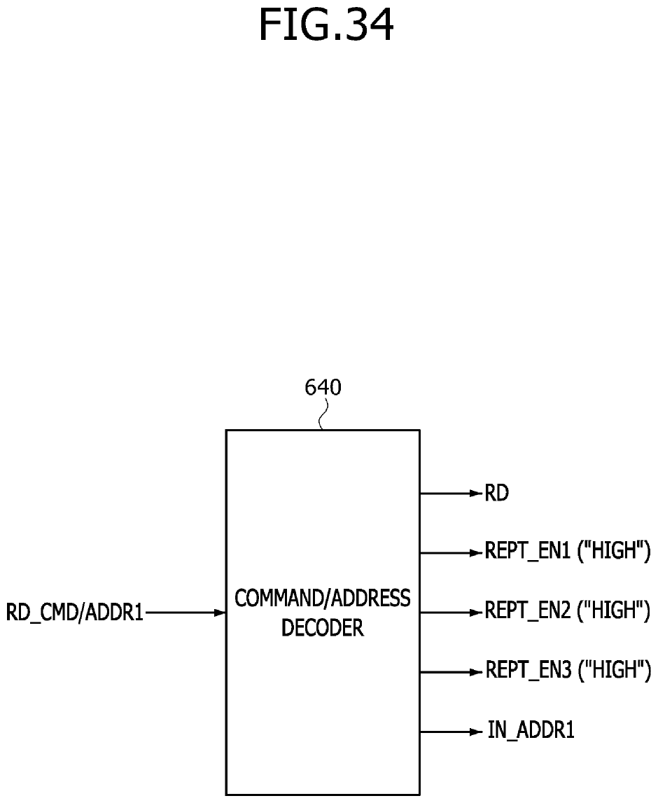

FIG. 34 is a diagram illustrating an example of an operation of the command/address decoder 640 when the PIM device 600 of FIG. 31 performs a memory read operation. In the following examples, an active operation and a pre-charge operation, generally performed for memory access, will be omitted. Referring to FIG. 34, together with FIGS. 31 and 32, when a read command RD_CMD and the first address signal ADDR1 are transmitted to the command/address decoder 640 of the PIM device 600, the command/address decoder 640 may generate and output a read control signal RD, first to third repeater enable signals REPT_EN1, REPT_EN2, and REPT_EN3 at logic “high” levels, and the first internal address signal IN_ADDR1. The read control signal RD and the first internal address signal IN_ADDR1 may be transmitted to the first to sixteenth memory banks BK0-BK15 of the memory/arithmetic regions 610 and 630. The first to third repeater enable signals REPT_EN1, REPT_EN2, and REPT_EN3 at logic “high” levels may be transmitted to the first to third repeaters R1-R3, respectively, to enable the first to third repeaters R1-R3.

The first to fourth memory banks BK0-BK3 and the ninth to twelfth memory banks BK8-BK11 may transmit read data to the second repeater R2 through the fourth GIO line 634 and the fifth GIO line 635, respectively, in response to the read control signal RD. Similarly, the fifth to eighth memory banks BK4-BK7 and the thirteenth to sixteenth memory banks BK12-BK15 may transmit read data to the third repeater R3 through the sixth GIO line 636 and the seventh GIO line 637, respectively, in response to the read control signal RD. The second repeater R2 and the third repeater R3 may transmit the read data to the first repeater R1 through the first GIO line 631. The first repeater R1 may transmit the read data to the first data I/O circuit DQ1 and the second data I/O circuit DQ2 through the second GIO line 632 and the third GIO line 633, respectively. In an example, the read data from the first to eighth memory banks BK0-BK7 may be transmitted to the first data I/O circuit DQ1, and the read data from the ninth to sixteenth memory banks BK8-BK15 may be transmitted to the second data I/O circuit DQ2.

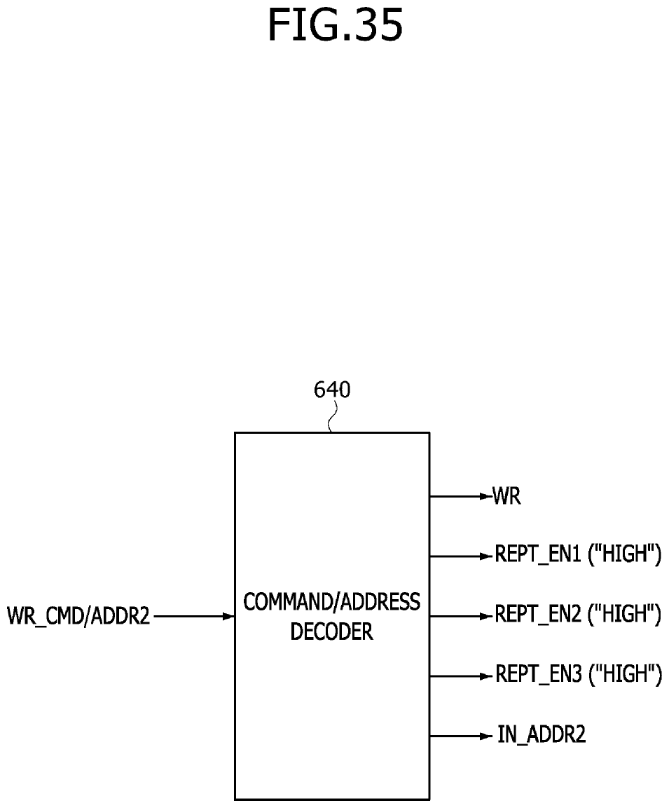

FIG. 35 is a diagram illustrating an example of an operation of the command/address decoder 640 while the PIM device 600 of FIG. 31 performs a memory write operation. Referring to FIG. 35, together with FIGS. 31 and 32, when a write command WR_CMD and the second address signal ADDR2 are transmitted to the command/address decoder 640 of the PIM device 600, the command/address decoder 640 may generate and output a write control signal WR, first to third repeater enable signals REPT_EN1, REPT_EN2, and REPT_EN3 of logic “high” levels, and the second internal address signal IN_ADDR2. The write control signal WR and the second internal address signal IN_ADDR2 may be transmitted to the first to sixteenth memory banks BK0-BK15 of the memory/arithmetic regions 610 and 630. The first to third repeater enable signals REPT_EN1, REPT_EN2, and REPT_EN3 at logic “high” levels may be transmitted to the first to third repeaters R1-R3 to enable the first to third repeaters R1-R3, respectively.

The first data I/O circuit DQ1 and the second data I/O circuit DQ2 may transmit write data that is transmitted from an outside source to the first repeater R1 through the second GIO line 632 and the third GIO line 633, respectively. The first repeater R1 may transmit the write data to the second repeater R2 or the third repeater R3 through the first GIO line 631. The second repeater R2 may transmit the write data to the first to fourth memory banks BK0-BK3, the ninth to twelfth memory banks BK8-BK11, the fifth to eighth memory banks BK4-BK7, and the thirteenth to sixteenth memory banks BK12-BK15 through the fourth GIO line 634, the fifth GIO line 635, the sixth GIO line 636, and the seventh GIO line 637, respectively. In an example, the write data that is transmitted through the first data I/O circuit DQ1 may be transmitted to the first to eighth memory banks BK0-BK7, and the write data that is transmitted through the second data I/O circuit DQ2 may be transmitted to the ninth to sixteenth memory banks BK8-BK15.

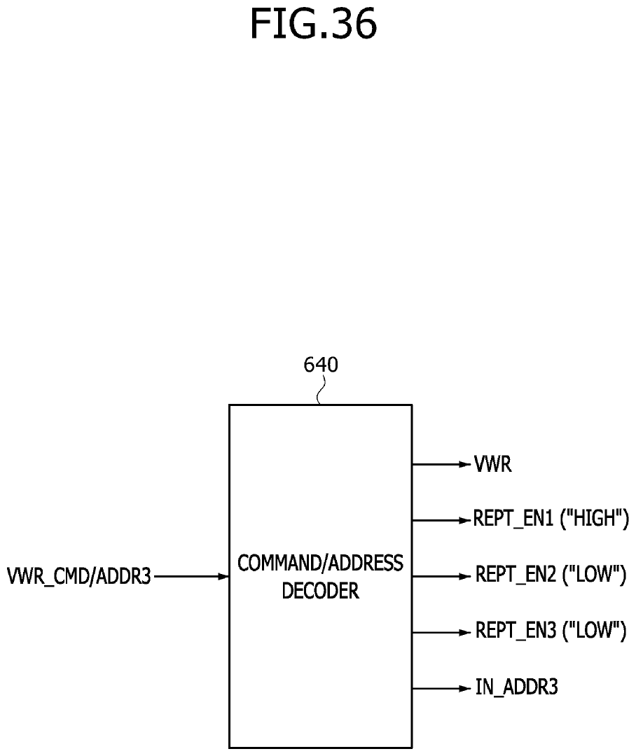

FIG. 36 is a diagram illustrating an example of an operation of the command/address decoder 640 while the PIM device 600 of FIG. 31 performs a vector data write operation. Referring to FIG. 36, together with FIGS. 31 and 32, when a vector data write command VWR_CMD and the third address signal ADDR3 are transmitted to the command/address decoder 640 of the PIM device 600, the command/address decoder 640 may generate and output a vector data write control signal VWR, the first repeater enable signal REPT_EN1 at a logic “high” level, second and third repeater enable signals REPT_EN2 and REPT_EN3 at logic “low” levels, and the third internal address signal IN_ADDR3. The vector data write control signal VWR and the third internal address signal IN_ADDR3 may be transmitted to the global buffer GB of the peripheral region 620. The first repeater enable signal REPT_EN1 at a logic “high” level may be transmitted to the first repeater R1, and accordingly, the first repeater R1 may be in an enabled state. The second and third repeater enable signals REPT_EN2 and REPT_EN3 at logic “low” levels may be transmitted to the second repeater R2 and the third repeater R3, respectively. Accordingly, each of the second repeater R2 and the third repeater R3 may be in a disabled state. The first data I/O circuit DQ1 may transmit the first set of vector data to the global buffer GB through the second GIO line 632. The second data I/O circuit DQ2 may transmit the second set of the vector data to the first repeater R1 through the third GIO line 633. The first repeater R1 may transmit the second set of the vector data to the global buffer GB through the second GIO line 632.

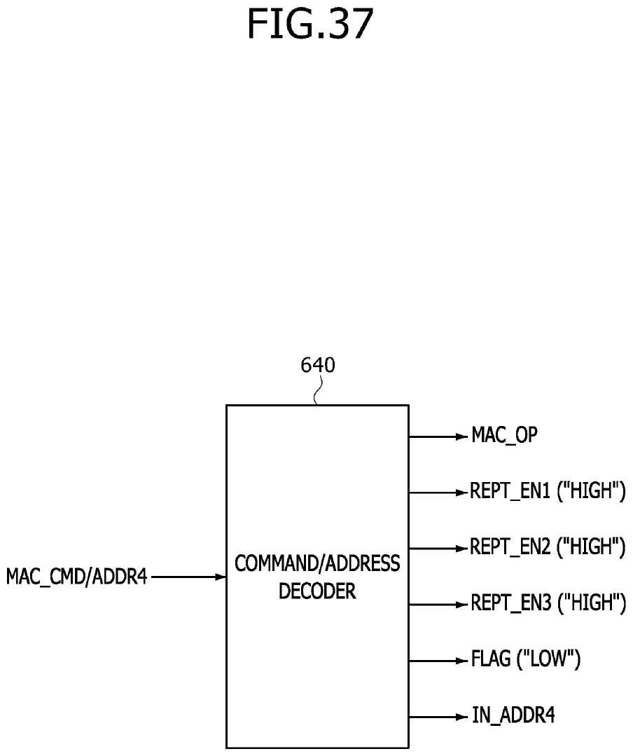

FIG. 37 is a diagram illustrating an example of an operation of the command/address decoder 640 while the PIM device 600 of FIG. 31 performs a MAC arithmetic operation. Referring to FIG. 37, together with FIGS. 31 and 32, when a MAC command MAC_CMD and the fourth address signal ADDR4 are transmitted to the command/address decoder 640 of the PIM device 600, the command/address decoder 640 may generate and output a MAC control signal MAC_OP, first to third repeater enable signals REPT_EN1, REPT_EN2, and REPT_EN3 at logic “high” levels, a flag signal FLAG at a logic “low” level, and the fourth internal address signal IN_ADDR4. The MAC control signal MAC_OP and the fourth internal address signal IN_ADDR4 may be transmitted to the first to sixteenth memory banks BK0-BK15 of the memory/arithmetic regions 610 and 630 and the global buffer GB of the peripheral region 620. The first to third repeater enable signals REPT_EN1, REPT_EN2, and REPT_EN3 at logic “high” levels may be transmitted to the first to third repeaters R1-R3, respectively. Accordingly, each of the first to third repeaters R1-R3 may be in an enabled state. The flag signal FLAG at a logic “low” level may be transmitted to the data output selection circuit (720 of FIG. 33) of each of the first to sixteenth MAC operators MAC0-MAC15.

The first to fourth memory banks BK0-BK3 may transmit first to fourth sets of the weight data to the first to fourth MAC operators MAC0-MAC3, respectively, through the fourth GIO line 634 in response to the MAC control signal MAC_OP. The fifth to eighth memory banks BK4-BK7 may transmit fifth to eighth sets of the weight data to the fifth to eighth MAC operators MAC4-MAC7, respectively, through the sixth GIO line 636 in response to the MAC control signal MAC_OP. The ninth to twelfth memory banks BK8-BK11 may transmit ninth to twelfth sets of the weight data to the ninth to twelfth MAC operators MAC8-MAC11, respectively, through the fifth GIO line 635 in response to the MAC control signal MAC_OP. The thirteenth to sixteenth memory banks BK12-BK15 may transmit thirteenth to sixteenth sets of the weight data to the thirteenth to sixteenth MAC operators MAC12-MAC15, respectively, through the seventh GIO line 637 in response to the MAC control signal MAC_OP. The global buffer GB may transmit the vector data to the first repeater R1 through the second GIO line 632. The first repeater R1 may transmit the vector data to the second repeater R2 and the third repeater R3 through the first GIO line 631. The second repeater R2 may transmit the vector data to the first to fourth MAC operators MAC0-MAC3 and the ninth to twelfth MAC operators MAC8-MAC11 through the fourth GIO line 634 and the fifth GIO line 635, respectively. The third repeater R3 may transmit the vector data to the fifth to eighth MAC operators MAC4-MAC7 and the thirteenth to sixteenth MAC operators MAC12-MAC15 through the sixth GIO line 636 and the seventh GIO line 637, respectively.

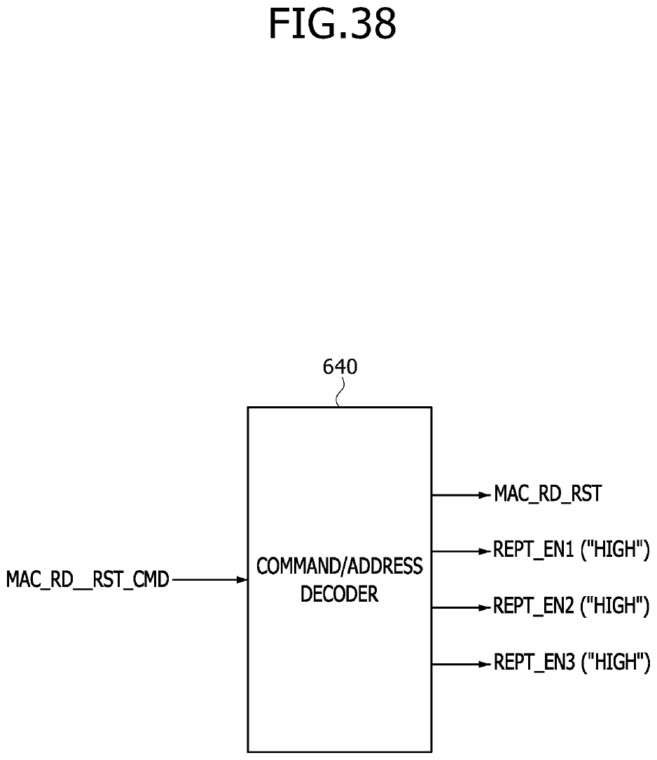

FIG. 38 is a diagram illustrating an example of an operation of the command/address decoder 640 while the PIM device 600 of FIG. 31 performs a MAC result data read operation. Referring to FIG. 38, together with FIGS. 31 and 32, when a MAC result data read command MAC_RD_RST_CMD is transmitted to the command/address decoder 640 of the PIM device 600, the command/address decoder 640 may generate and output a MAC result data read control signal MAC_RD_RST and first to third repeater enable signals REPT_EN1, REPT_EN2, and REPT_EN3 at logic “high” levels. The MAC result data read control signal MAC_RD_RST may be transmitted to the first to sixteenth MAC operators MAC0-MAC15 of the memory/arithmetic regions 610 and 630. The first to third repeater enable signals REPT_EN1, REPT_EN2, and REPT_EN3 at logic “high” levels may be transmitted to the first to third repeaters R1-R3, respectively. Accordingly, each of the first to third repeaters R1-R3 may be in an enabled state.

The first to fourth MAC operators MAC0-MAC3 may transmit first to fourth MAC result data to the second repeater R2 through the fourth GIO line 634 in response to the MAC result data read control signal MAC_RD_RST. The ninth to twelfth MAC operators MAC8-MAC11 may transmit ninth to twelfth MAC result data to the second repeater R2 through the fifth GIO line 635 in response to the MAC result data read control signal MAC_RD_RST. The fifth to eighth MAC operators MAC4-MAC7 may transmit fifth to eighth MAC result data to the third repeater R3 through the sixth GIO line 636 in response to the MAC result data read control signal MAC_RD_RST. The thirteenth to sixteenth MAC operators MAC12-MAC15 may transmit thirteenth to sixteenth MAC result data to the third repeater R3 through the seventh GIO line 637 in response to the MAC result data read control signal MAC_RD_RST. The second repeater R2 may transmit the first to fourth MAC result data and the ninth to twelfth MAC result data to the first repeater R1 through the first GIO line 631. The third repeater R3 may transmit the fifth to eighth MAC result data and the thirteenth to sixteenth MAC result data to the first repeater R1 through the first GIO line 631. The first repeater R1 may transmit the first to eighth MAC result data to the first data I/O circuit DQ1 through the second GIO line 632. In addition, the first repeater R1 may transmit the ninth to sixteenth MAC result data to the second data I/O circuit DQ2 through the third GIO line 633.

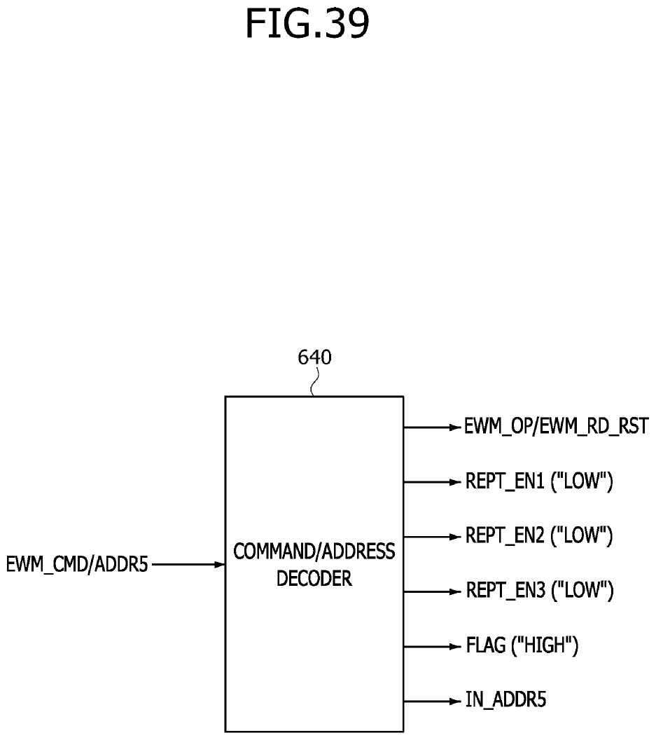

FIG. 39 is a diagram illustrating an example of an operation of the command/address decoder 640 while the PIM device 600 of FIG. 31 performs an EWM operation. Referring to FIG. 39, together with FIGS. 31 and 32, when an EWM command EWM_CMD and the fifth address signal ADDR5 are transmitted to the command/address decoder 640 of the PIM device 600, the command/address decoder 640 may generate and output an EWM control signal/EWM result data read control signal EWM_CMD/EWM_RD_RST, first to third repeater enable signals REPT_EN1, REPT_EN2, and REPT_EN3 at logic “low” levels, a flag signal FLAG at a logic “high” level, and the fifth internal address signal IN_ADDR5. The command/address decoder 640 may output the EWM result data read control signal EWM_RD_RST after the first time period elapses after outputting the EWM control signal EWM_OP. Here, the first time period may be defined as the time that is required for the MAC operator MAC to start performing the EWM operation and generate EWM result data. The EWM control signal EWM_OP and the fifth internal address signal IN_ADDR5 may be transmitted to the first to sixteenth memory banks BK0-BK15 of the memory/arithmetic regions 610 and 630. The EWM result data read control signal EWM_RD_RST and the flag signal FLAG at a logic “high” level may be transmitted to the first to sixteenth MAC operators MAC0-MAC15 of the memory/arithmetic regions 610 and 630. The first to third repeater enable signals REPT_EN1, REPT_EN2, and REPT_EN3 at logic “low” levels may be transmitted to the first to third repeaters R1-R3, respectively. Accordingly, each of the first to third repeaters R1-R3 may be in a disabled state.

In this example, it is assumed that the EWM operation is performed in the first, fifth, ninth, and thirteenth MAC operators MAC0, MAC4, MAC8, and MAC12, the input data is provided from the first, second, fifth, sixth, ninth, tenth, thirteenth, and fourteenth memory banks BK0, BK1, BK4, BK5, BK8, BK9, BK12, and BK13, and the EWM result data is stored in the third, seventh, eleventh, and fifteenth memory banks BK2, BK6, BK10, and BK14. The first and second memory banks BK0 and BK1 may transmit the first and second input data to the first MAC operator MAC0 through the fourth GIO line 634 in response to the EWM control signal EWM_OP. The fifth and sixth memory banks BK4 and BK5 may transmit the third and fourth input data to the fifth MAC operator MAC4 through the sixth GIO line 636 in response to the EWM control signal EWM_OP. The ninth and tenth memory banks BK8 and BK9 may transmit the fifth and sixth input data to the ninth MAC operator MAC8 through the fifth GIO line 635 in response to the EWM control signal EWM_OP. In addition, the thirteenth and fourteenth memory banks BK12 and BK13 may transmit the seventh and eighth input data to the thirteenth MAC operator MAC12 through the seventh GIO line 637 in response to the EWM control signal EWM_OP.

After the EWM operations in the first, fifth, ninth, and thirteenth MAC operators MAC0, MAC4, MAC8, and MAC12 are finished, the first MAC operator MAC0 may transmit first EWM result data to the third memory bank BK2 through the fourth GIO line 634 in response to the EWM result data read control signal EWM_RD_RST. The fifth MAC operator MAC4 may transmit second EWM result data to the seventh memory bank BK6 through the sixth GIO line 636 in response to the EWM result data read control signal EWM_RD_RST. The ninth MAC operator MAC8 may transmit third EWM result data to the eleventh memory bank BK10 through the fifth GIO line 635 in response to the EWM result data read control signal EWM_RD_RST. The thirteenth MAC operator MAC12 may transmit fourth EWM result data to the fifteenth memory bank BK14 through the seventh GIO line 637 in response to the EWM result data read control signal EWM_RD_RST.

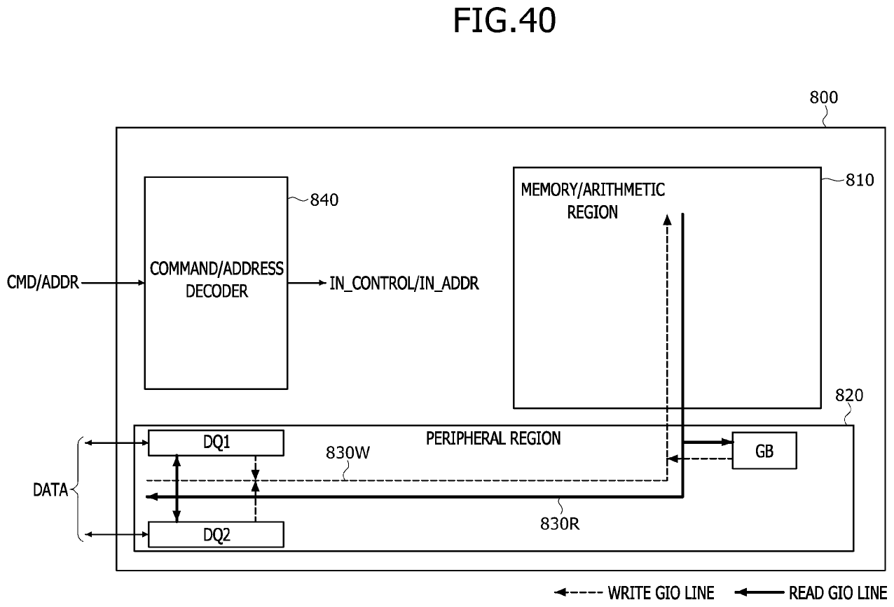

FIG. 40 is a block diagram illustrating a PIM device 800 according to another embodiment of the present disclosure. Referring to FIG. 40, the PIM device 800 may include a memory/arithmetic regions 810 and 830, a peripheral region 820, a write GIO line 830W, a read GIO line 830R, and a command/address decoder 840. The command/address decoder 840 may be disposed in the peripheral region 820. The PIM device 800 may be different from the PIM device 600, described with reference to FIG. 31, in that the GIO line 630 of FIG. 31 has been separated into the write GIO line 830W and the read GIO line 830R in FIG. 40. Except for the elements related to the GIO line, the configurations of the memory/arithmetic regions 810 and 830, the peripheral region 820, and the command/address decoder 840 of the PIM device 800 may be similar to the configurations of the memory/arithmetic regions 610 and 630, the peripheral region 620, and the command/address decoder 640 of the PIM device 600 of FIG. 31. The write GIO line 830W and the read GIO line 830R may provide data transmission paths inside of the PIM device 800. The write GIO line 830W may be used for data DATA (e.g., write data) transmission from the peripheral region 820 to the memory/arithmetic regions 810 and 830. The read GIO line 830R may be used for data DATA (e.g., read data) transmission from the memory/arithmetic regions 810 and 830 to the peripheral region 820. The command/address decoder 840 may receive a command CMD and an address ADDR from a host or a controller. The command/address decoder 840 may decode the command CMD and the address ADDR to output an internal control signal IN_CONTROL and an internal address signal IN_ADDR. The memory/arithmetic regions 810 and 830 and the peripheral region 820 may perform various operations, for example, a memory read operation, a memory write operation, a MAC arithmetic operation, an EWM operation, and the like according to the internal control signal IN_CONTROL and the internal address signal IN_ADDR that are output from the command/address decoder 840.

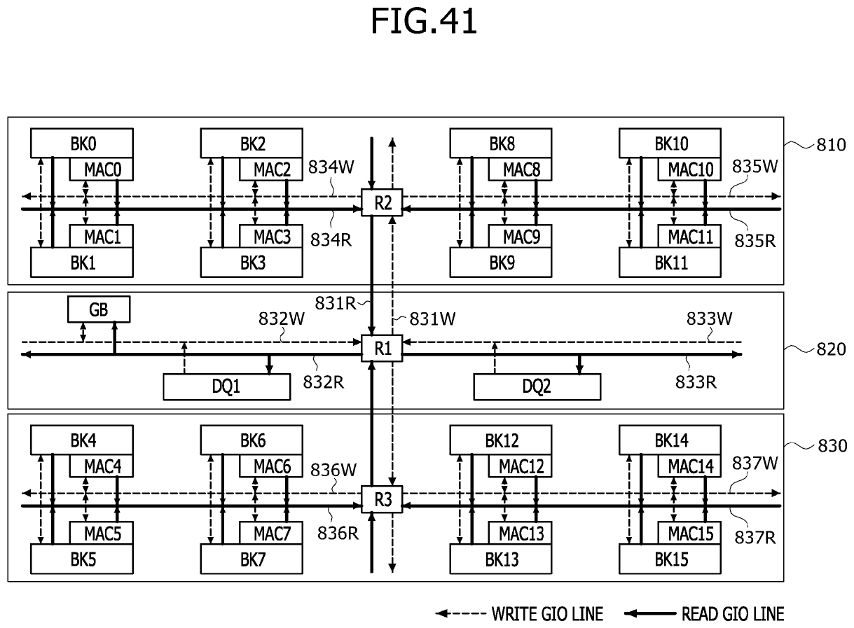

FIG. 41 is a diagram illustrating another example of the configurations of the memory/arithmetic regions 810 and 830 and the peripheral region 820 of the PIM device 800 of FIG. 40. In FIG. 41, except for the configurations of the GIO lines in the memory/arithmetic regions 810 and 830 and the peripheral region 820, the configurations of the memory/arithmetic regions 610 and 630 and the peripheral region 620, described with reference to FIG. 32, may be equally applied. Accordingly, in FIG. 41, the same reference numerals and reference labels as in FIG. 32 indicate the same components, and the overlapping description will be omitted below.

Referring to FIG. 41, the first write GIO line 831W and the first read GIO line 831R may be disposed to pass through the peripheral region 820 and to extend to the memory/arithmetic regions 810 and 830. The first write GIO line 831W may provide a data transmission path from the peripheral region 820 to the memory/arithmetic regions 810 and 830. The first read GIO line 831R may provide a data transmission path from the memory/arithmetic regions 810 and 830 to the peripheral region 820. The first repeater R1 may be disposed between the first write GIO line 831W and the first read GIO line 831R in the peripheral region 820. The second repeater R2 and the third repeater R3 may be disposed between first write GIO line 831W and the first read GIO line 831R in the memory/arithmetic regions 810 and 830, respectively. Accordingly, the first write GIO line 831W may provide a data transmission path from the first repeater R1 of the peripheral region 820 to the second repeater R2 and the third repeater R3 of the memory/arithmetic regions 810 and 830. In addition, the first read GIO line 831R may provide a data transmission path from the second repeater R2 and the third repeater R3 of the memory/arithmetic regions 810 and 830 to the first repeater R1 of the peripheral region 820.

The second write GIO line 832W may provide a data transmission path from the first data I/O circuit DQ1 and a global buffer GB to the first repeater R1 in the peripheral region 820. In addition, the second write GIO line 832W may provide a data transmission path between the first data I/O circuit DQ1 and the global buffer GB in the peripheral region 820. The second read GIO line 832R may provide a data transmission path from the first repeater R1 to the first data I/O circuit DQ1 and the global buffer GB in the peripheral region 820. The third write GIO line 833W may provide a data transmission path from the second data I/O circuit DQ2 to the first repeater R1 in the peripheral region 820. The third read GIO line 833R may provide a data transmission path from the first repeater R1 to the second data I/O circuit DQ2 in the peripheral region 820.

The fourth write GIO line 834W may provide a data transmission path from the second repeater R2 to the first to fourth memory banks BK0-BK3 and the first to fourth MAC operators MAC0-MAC3 in the memory/arithmetic region 810. In addition, the fourth write GIO line 834W may provide a data transmission path between the first to fourth MAC operators MAC0-MAC3 and the first to fourth memory banks BK0-BK3 in the memory/arithmetic region 810. That is, the first to fourth MAC operators MAC0-MAC3 may transmit or receive data through the fourth write GIO line 834W. The fourth read GIO line 834R may provide a data transmission path from the first to fourth memory banks BK0-BK3 and the first to fourth MAC operators MAC0-MAC3 to the second repeater R2 in the memory/arithmetic region 810. The fifth write GIO line 835W may provide a data transmission path from the second repeater R2 to the ninth to twelfth memory banks BK8-BK11 and the ninth to twelfth MAC operators MAC8-MAC11 in the memory/arithmetic region 810. In addition, the fifth write GIO line 835W may provide a data transmission path between the ninth to twelfth MAC operators MAC8-MAC11 and the ninth to twelfth memory banks BK8-BK11 in the memory/arithmetic region 810. That is, the ninth to twelfth MAC operators MAC8-MAC11 may transmit or receive the data through the fifth write GIO line 835W. The fifth read GIO line 835R may provide a data transmission path from the ninth to twelfth memory banks BK8-BK11 and the ninth to twelfth MAC operators MAC8-MAC11 to the second repeater R2 in the memory/arithmetic region 810.

The sixth write GIO line 836W may provide a data transmission path from the third repeater R3 to the fifth to eighth memory banks BK4-BK7 and the fifth to eighth MAC operators MAC4-MAC7 in the memory/arithmetic region 830. In addition, the sixth write GIO line 836W may provide a data transmission path between the fifth to eighth MAC operators MAC4-MAC7 and the fifth to eighth memory banks BK4-BK7 in the memory/arithmetic region 830. That is, the fifth to eighth MAC operators MAC4-MAC7 may transmit or receive the data through the sixth write GIO line 836W. The sixth read GIO line 836R may provide a data transmission path from the fifth to eighth memory banks BK4-BK7 and the fifth to eighth MAC operators MAC4-MAC7 to the third repeater R3 in the memory/arithmetic region 830. The seventh write GIO line 837W may provide a data transmission path from the third repeater R3 to the thirteenth to sixteenth memory banks BK12-BK15 and the thirteenth to sixteenth MAC operators MAC12-MAC15 in the memory/arithmetic region 830. In addition, the seventh write GIO line 837W may provide a data transmission path between the thirteenth to sixteenth MAC operators MAC12-MAC15 and the thirteenth to sixteenth memory banks BK12-BK15 in the memory/arithmetic region 830. That is, the thirteenth to sixteenth MAC operators MAC12-MAC15 may transmit or receive the data through the seventh write GIO line 837W. The seventh read GIO line 837R may provide a data transmission path from the thirteenth to sixteenth memory banks BK12-BK15 and the thirteenth to sixteenth MAC operators MAC12-MAC15 to the third repeater R3 in the memory/arithmetic region 830.

The operation of the command/address decoder 840, while the PIM device 800 is performing a memory read operation, may be similar to the operation of the command/address decoder 640, described above with reference to FIG. 34. The operation of the command/address decoder 840, while the PIM device 800 is performing a memory write operation, may be similar to the operation of the command/address decoder 640, described above with reference to FIG. 35. The operation of the command/address decoder 840, while the PIM device 800 is performing a vector data write operation, may be similar to the operation of the command/address decoder 640, described above with reference to FIG. 36. The operation of the command/address decoder 840, while the PIM device 800 is performing a MAC arithmetic operation, may be similar to the operation of the command/address decoder 640, described above with reference to FIG. 37. In addition, the operation of the command/address decoder 840, while the PIM device 800 is performing a MAC result data read operation, may be similar to the operation of the command/address decoder 640, described above with reference to FIG. 38.

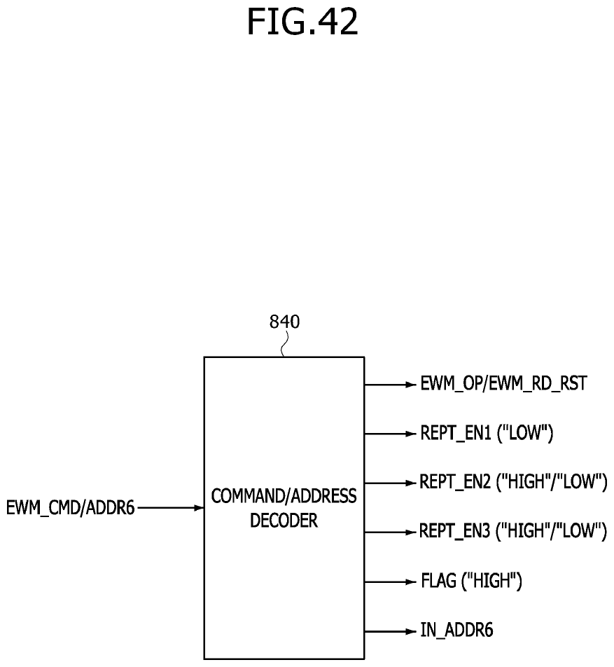

FIG. 42 is a diagram illustrating an example of an operation of the command/address decoder 840 while the PIM device 800 of FIG. 40 is performing an EWM operation. Referring to FIG. 42, together with FIGS. 40 and 41, when an EWM command EWM_CMD and the sixth address signal ADDR6 are transmitted to the command/address decoder 840 of the PIM device 800, the command/address decoder 840 may generate and output an EWM control signal/EWM result data read control signal EWM_OP/EWM_RD_RST, the first repeater enable signal REPT_EN1 at a logic “low” level, the second repeater enable signal REPT_EN2 at a logic “high” level, the third repeater enable signal REPT_EN3 at a logic “high” level, a flag signal FLAG at a logic “high” level, and the sixth internal address signal IN_ADDR6.

After outputting the EWM control signal EWM_OP, the command/address decoder 840 may output the EWM result data read control signal EWM_RD_RST when the first time period elapses. Here, the first time period may be defined as the time that is required for the MAC operator MAC to start performing the EWM operation and generating EWM result data. The logic level of the second repeater enable signal REPT_EN2 may be changed to a logic “low” level when the first time period elapses, after being generated at a logic “high” level. Similarly, the logic level of the third repeater enable signal REPT_EN3 may be changed to a logic “low” level when the first time period elapses, after being generated at a logic “high” level. The EWM control signal EWM_OP and the sixth internal address signal IN_ADDR6 may be transmitted to the first to sixteenth memory banks BK0-BK15 of the memory/arithmetic regions 810 and 830. The EWM result data read control signal EWM_RD_RST and the flag signal FLAG at a logic “high” level may be transmitted to the first to sixteenth MAC operators MAC0-MAC15 in the memory/arithmetic regions 810 and 830. The first repeater enable signal REPT_EN1 at a logic “low” level may be transmitted to the first repeater R1. The second repeater enable signal REPT_EN2 at a logic “high” level and the second repeater enable signal REPT_EN2 at a logic “low” level may be transmitted to the second repeater R2. The third repeater enable signal REPT_EN3 at a logic “high” level and the third repeater enable signal REPT_EN3 at a logic “low” level may be transmitted to the third repeater R3. While the EWM operation is being performed, the first repeater R1 may be in a disabled state, and each of the second repeater R2 and the third repeater R3 may be in a disabled state after maintaining the enabled state for the first time period.

In this example, it is assumed that the EWM operations are performed in the first, fifth, ninth, and thirteenth MAC operators MAC0, MAC4, MACE, and MAC12, input data is provided from the first, second fifth, sixth, ninth, tenth, thirteenth, and fourteenth memory banks BK0, BK1, BK4, BK5, BK8, BK9, BK12, and BK13, and EWM result data is stored in the third, seventh, eleventh, and fifteenth memory banks BK2, BK6, BK10, and BK14. The first and second memory banks BK0 and BK1 may transmit first and second input data to the second repeater R2 through the fourth read GIO line 634R in response to the EWM control signal EWM_OP. The second repeater R2 may transmit the first and second input data to the first MAC operator MAC0 through the fourth write GIO line 634W. The fifth and sixth memory banks BK4 and BK5 may transmit third and fourth input data to the third repeater R3 through the sixth read GIO line 636R in response to the EWM control signal EWM_OP. The third repeater R3 may transmit the third and fourth input data to the fifth MAC operator MAC4 through the sixth write GIO line 636W. The ninth and tenth memory banks BK8 and BK9 may transmit fifth and sixth input data to the second repeater R2 through the fifth read GIO line 635R in response to the EWM control signal EWM_OP. The second repeater R2 may transmit the fifth and sixth input data to the ninth MAC operator MAC8 through the fifth write GIO line 635W. In addition, the thirteenth and fourteenth memory banks BK12 and BK13 may transmit seventh and eighth input data to the third repeater R3 through the seventh read GIO line 637R in response to the EWM control signal EWM_OP. The third repeater R3 may transmit the seventh and eighth input data to the thirteenth MAC operator MAC12 through the seventh write GIO line 637W.

When the EWM operations in the first, fifth, ninth, and thirteenth MAC operators MAC0, MAC4, MAC8, and MAC12 are finished, the first repeater R1 may maintain the disabled state, and the states of the second repeater R2 and the third repeater R3 may be changed from the enabled state to the disabled state. The first MAC operator MAC0 may transmit first EWM result data to the third memory bank BK2 through the fourth write GIO line 634W in response to the EWM result data read control signal EWM_RD_RST. The fifth MAC operator MAC4 may transmit second EWM result data to the seventh memory bank BK6 through the sixth write GIO line 636W in response to the EWM result data read control signal EWM_RD_RST. The ninth MAC operator MAC8 may transmit third EWM result data to the eleventh memory bank BK10 through the fifth write GIO line 635W in response to the EWM result data read control signal EWM_RD_RST. The thirteenth MAC operator MAC12 may transmit fourth EWM result data to the fifteenth memory bank BK14 through the seventh write GIO line 637W in response to the EWM result data read control signal EWM_RD_RST.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A processing-in-memory (PIM) device comprising:
a memory/arithmetic region including a plurality of memory banks and a plurality of multiplication-and-accumulation (MAC) operators, the plurality of MAC operators including a first MAC operator;
a peripheral region including a data input/output (I/O) circuit; and
a global data input/output (GIO) line capable of providing a data transmission path between the peripheral region and the memory/arithmetic region,
wherein the first MAC operator is configured to perform an element-wise multiplication (EWM) operation by performing a multiplication operation on first input data and second input data that are transmitted from first and second memory banks of the plurality of memory banks, respectively, to generate multiplication result data and transmitting the multiplication result data to a third memory bank of the plurality of memory banks, and
wherein, while the EWM operation is being performed, data transmission through the GIO line between the peripheral region and the memory/arithmetic region is blocked.

2. The PIM device of claim 1, wherein the first MAC operator includes:
a multiplication circuit including a plurality of multipliers that are disposed to be parallel with each other;
a data output selection circuit configured to output multiplication data that has been output from the multiplication circuit through output lines, selected among first output lines and second output lines;
an adder tree including a plurality of adders that are arranged in a tree structure; and
an accumulator configured to perform an accumulative addition operation on data that is output from the adder tree.

3. The PIM device of claim 2, wherein the first output lines of the data output selection circuit are coupled to the adder tree.

4. The PIM device of claim 3,
wherein the first MAC operator further includes a data output circuit including first input lines, a second input line, and an output line,
wherein the first input lines of the data output circuit are coupled to the second output lines of the data output selection circuit, and
wherein the output line of the data output circuit is coupled to the GIO line.

5. The PIM device of claim 4, wherein the second input line of the data output circuit is coupled to an output terminal of the accumulator.

6. The PIM device of claim 2,
wherein the data output selection circuit includes a plurality of demultiplexers respectively coupled to the plurality of multipliers, and
wherein the plurality of demultiplexers are configured to respectively receive output data from the plurality of multipliers and configured to output the output data through the first output lines or the second output lines.

7. The PIM device of claim 6, wherein the plurality of demultiplexers are configured to:
output the multiplication data from the plurality of multipliers to the adder tree through the first output lines when the first MAC operator performs a MAC arithmetic operation, and
output the multiplication data from the plurality of multipliers to the data output circuit through the second output lines when the first MAC operator performs the EWM operation.

8. The PIM device of claim 7, further comprising a global buffer disposed in the peripheral region,
wherein the first MAC operator is configured to receive weight data and vector data from the first memory bank and the global buffer to perform the MAC arithmetic operation.

9. The PIM device of claim 8, wherein the GIO line includes:
a first GIO line disposed to pass through the peripheral region and to extend to the memory/arithmetic region and capable of providing a data transmission path between the memory/arithmetic region and the peripheral region;
a second GIO line capable of providing a data transmission path between the first GIO line and the data I/O circuit and the global buffer in both directions in the peripheral region; and
a third GIO line capable of providing a data transmission path, in both directions, between the first GIO line and the plurality of memory banks and the plurality of MAC operators in the memory/arithmetic region.

10. The PIM device of claim 9, further comprising:
a first repeater capable of buffering data that is transmitted between the first GIO line and the second GIO line in the peripheral region; and
a second repeater capable of buffering data that is transmitted between the first GIO line and the third GIO line in the memory/arithmetic region.

11. The PIM device of claim 10, further comprising a command/address decoder configured to generate control signals for controlling operations of the plurality of memory banks and operations of the plurality of MAC operators,
wherein the command/address decoder is configured to:
generate a read control signal that controls read operations of the plurality of memory banks and generate a first repeater enable signal and a second repeater enable signal that enable the first repeater and the second repeater, respectively, in response to a read command, and
generate a write control signal that controls write operations of the plurality of memory banks and generate a first repeater enable signal and a second repeater enable signal that enable the first repeater and the second repeater, respectively, in response to a write command.

12. The PIM device of claim 11, wherein the command/address decoder is configured to generate a vector data write control signal that controls an operation of the global buffer to store the vector data in response to a vector data write command, a first repeater enable signal that enables the first repeater, and a second repeater enable signal that disables the second repeater.

13. The PIM device of claim 11, wherein the command/address decoder is configured to generate a MAC arithmetic control signal that controls an operation of the first MAC operator to perform the MAC operation in response to a MAC arithmetic command, a first repeater enable signal and a second repeater enable signal that enable the first repeater and the second repeater, respectively.

14. The PIM device of claim 11, wherein the command/address decoder is configured to generate a MAC result data read control signal that controls an operation of the first MAC operator to output MAC result data to the data I/O circuit in response to a MAC result data read command and to generate a first repeater enable signal and a second repeater enable signal that enable the first repeater and the second repeater, respectively.

15. The PIM device of claim 14, wherein the command/address decoder is configured to generate a flag signal that allows the multiplication data to be output from the plurality of multipliers to the first output lines and to transmit the flag signal to the data output selection circuit in response to the MAC arithmetic command.

16. The PIM device of claim 11, wherein the command/address decoder is configured to generate an EWM operation control signal that controls an operation of the first MAC operator to perform the EWM operation and to generate a first repeater enable signal and a second repeater enable signal that disable the first repeater and the second repeater, respectively, in response to an EWM operation command.

17. The PIM device of claim 16, wherein the command/address decoder is configured to generate a flag signal that allows the multiplication data to be output from the plurality of multipliers to the second output lines and to transmit the flag signal to the data output selection circuit in response to an EWM operation command.

18. A processing-in-memory (PIM) device comprising:
a memory/arithmetic region including a plurality of memory banks and a plurality of multiplication-and-accumulation (MAC) operators, the plurality of MAC operators including a first MAC operator;
a peripheral region including a data input/output (I/O) circuit;
a write global data input/output (GIO) line capable of providing a data transmission path from the data input/output (I/O) circuit to the plurality of memory banks and the plurality of MAC operators; and
a read GIO line capable of providing a data transmission path from the plurality of memory banks and the plurality of MAC operators to the data input/output (I/O) circuit,
wherein the first MAC operator is configured to perform an element-wise multiplication (EWM) operation by performing a multiplication operation on first input data and second input data that are transmitted from first and second memory banks of the plurality of memory banks, respectively, to generate multiplication result data, and transmitting the multiplication result data to a third memory bank of the plurality of memory banks, and
wherein while the EWM operation is being performed, data transmission through the read and write GIO lines between the peripheral region and the memory/arithmetic region is blocked.

19. The PIM device of claim 18, wherein the first MAC operator includes:
a multiplication circuit including a plurality of multipliers that are disposed to be parallel with each other;
a data output selection circuit configured to output multiplication data that has been output from the multiplication circuit to output lines, selected among first output lines and second output lines;
an adder tree including a plurality of adders that are arranged in a tree structure; and
an accumulator configured to perform an accumulative addition operation on data that is output from the adder tree.

20. The PIM device of claim 19, wherein the first output lines of the data output selection circuit are coupled to the adder tree.

21. The PIM device of claim 20,
wherein the first MAC operator further includes a data output circuit including first input lines, a second input line, and an output line,
wherein the first input lines of the data output circuit are coupled to the second output lines of the data output selection circuit, and
wherein the output line of the data output circuit is coupled to the GIO line.

22. The PIM device of claim 21, wherein the second input line of the data output circuit is coupled to an output terminal of the accumulator.

23. The PIM device of claim 19,
wherein the data output selection circuit includes a plurality of demultiplexers respectively coupled to the plurality of multipliers, and
wherein the plurality of demultiplexers are configured to respectively receive output data from the plurality of multipliers and to output the output data through the first output lines or the second output lines.

24. The PIM device of claim 23, wherein the plurality of demultiplexers are configured to:
output the multiplication data from the plurality of multipliers to the adder tree through the first output lines when the first MAC operator performs a MAC arithmetic operation, and
output the multiplication data from the plurality of multipliers to the data output circuit through the second output lines when the first MAC operator performs the EWM operation.

25. The PIM device of claim 24, further comprising a global buffer disposed in the peripheral region,
wherein the first MAC operator is configured to receive weight data and vector data from the first memory bank and the global buffer to perform the MAC arithmetic operation.

26. The PIM device of claim 25, wherein the write GIO line includes:
a first write GIO line disposed to pass through the peripheral region and to extend to the memory/arithmetic region, and capable of providing a data transmission path from the peripheral region to the memory/arithmetic region;
a second write GIO lines capable of providing a data transmission path from the data I/O circuit to the global buffer, and a data transmission paths from the data I/O circuit and the global buffer to the first write GIO line in the peripheral region; and
a third write GIO line capable of providing data transmission paths from the first write GIO line to the plurality of memory banks and the plurality of MAC operators and providing data transmission paths between the plurality of memory banks and the plurality of MAC operators in the memory/arithmetic region.

27. The PIM device of claim 26, wherein the read GIO line includes:
a first read GIO line disposed to pass through the peripheral region and to extend to the memory/arithmetic region, and capable of providing a data transmission path from the memory/arithmetic region to the peripheral region;
a second read GIO line capable of providing a data transmission path from the global buffer to the data I/O circuit, and a data transmission path from the first read GIO line to the data I/O circuit and the global buffer in the peripheral region; and
a third read GIO line capable of providing data transmission paths from the plurality of memory banks and the plurality of MAC operators to the first read GIO line and providing data transmission paths between the plurality of memory banks and the plurality of MAC operators in the memory/arithmetic region.

28. The PIM device of claim 27, further comprising:
a first repeater capable of buffering data that is transmitted between the first write GIO line and the second write GIO line and between the first read GIO line and the second read GIO line, in the peripheral region; and
a second repeater capable of buffering data that is transmitted between the first write GIO line and the third write GIO line and between the first read GIO line and the third read GIO line, in the memory/arithmetic region.

29. The PIM device of claim 28, further comprising a command/address decoder configured to generate control signals for controlling operations of the plurality of memory banks and the plurality of MAC operators,
wherein the command/address decoder is configured to generate an EWM operation control signal that controls an operation of the first MAC operator to perform the EWM operation, a first repeater enable signal that disables the first repeater, and a second repeater enable signal that disables the second repeater when a first time period elapses after enabling the second repeater, in response to the EWM operation command.

30. The PIM device of claim 29, wherein the first time period is a time period that is required for the first MAC operator to generate the EWM result data after performing the EWM operation.

31. The PIM device of claim 29, wherein the command/address decoder is configured to generate a flag signal that allows the multiplication data to be output from the plurality of multipliers to the first output lines and configured to transmit the flag signal to the data output selection circuit in response to the EWM operation command.
